(19) United States
(12) Patent Application Publication
(10) Pub. No.: US 2015/0039388 A1
(43) Pub. Date: Feb. 5, 2015

(54) SYSTEM AND METHOD FOR DETERMINING CONSUMER PROFILES FOR TARGETED MARKETPLACE ACTIVITIES

(71) Applicant: Arun Rajaraman, Reno, NV (US)

(72) Inventor: Arun Rajaraman, Reno, NV (US)

(21) Appl. No.: 14/447,428

(22) Filed: Jul. 30, 2014

Related U.S. Application Data
(60) Provisional application No. 61/860,156, filed on Jul. 30, 2013.

(51) Int. Cl. G06Q 30/06; G06Q 30/02

(52) U.S. Cl. CPC G06Q 30/0613; G06Q 30/0201; G06Q 30/0222
USPC 705/7.29

(57) ABSTRACT

A system and method implemented by a computing system is provided for determining consumer economic profiles to form selected virtual marketplace communities. The created communities provide benefits to consumers, such as leveraging purchasing power for increased return on goods and services desired by the consumers. The system and method comprise three primary components or aspects, namely (1) a data gathering component in which consumer spending data is obtained, validated, analyzed, and categorized; (2) profiles created for each consumer regarding their spending history taking into account calculated spend scores and spend categories corresponding to each of the consumers; and (3) virtual marketplace communities created from the profiles for matched consumers and vendors enabling consumers to conduct commerce with the vendors in an e-commerce environment. An exchange pod can be created to provide an object in which consumers offer to purchase pre-designated amounts and categories of goods/services over pre-defined time periods. Vendors bid to obtain the right to offer the goods/services for sale. The bids are made with discount offers and consumers are able to select the most favorable bid.

### CROSS-REFERENCE TO RELATED APPLICATIONS

This application claims priority under 35 U.S.C. §119(e) to U.S. Provisional Patent Application Ser. No. 61/680,156 filed Jul. 30, 2013, which is incorporated herein in its entirety by reference.

### FIELD OF THE INVENTION

The present invention relates to the field of electronic commerce, and more particularly, to a system and method implemented by a computing system for determining consumer home economic profiles to form selected virtual marketplace communities. The virtual marketplace communities are used to conduct commerce between similarly identified consumers and vendors.

### BACKGROUND OF THE INVENTION

Nearly all financial management systems are presently incorporated within various computing systems. Particularly for banks, credit card providers, or other financial institutions, financial management is achieved primarily by complex computing systems that are operated in accordance with various industry standards, to include standard protocols for reviewing and transferring information.

Computer implemented financial management systems clearly dominate large and small businesses, as well as government organizations. More recently, there has also been an expansion of financial management tools made available to individuals in order to manage personal finances. There are numerous commercially available software packages that may help the ordinary consumer manage personal finances.

There are also a number of patent references that disclose various financial management systems adapted for differing businesses and personal finance needs. Some computing systems have also been developed for targeted marketing purposes. In order to increase sales for an organization, it is known to gather data regarding consumers, and then to categorize consumers who then may be the object of targeted marketing based upon the consumers spending habits.

One example of a method and system for managing financial transactions includes the U.S. Pat. No. 8,346,664. More specifically, this reference discloses a system and method for modifying financial transaction categorization lists based on input from multiple users. When a user of a computing system implemented financial management system modifies the user's own list of possible categorizations for a given financial transaction, data indicating the given user's modification of the given user's own list of possible categorizations for a given financial transaction is obtained by the system. The obtained data indicating the given user's modification of their own list of possible categorizations for a given financial transaction is then used by the system to create and/or modify a shared list of possible categorizations for a given financial transaction. The shared list of possible categorizations for a given financial transaction is then made available to, and/or used by, a community of users of the computing system implemented financial management system.

One example of a system and method for analyzing consumer spending behavior includes the U.S. Pat. No. 8,255,268. This refrence more specifically discloses a method for creating consumer profiles. Data accessible to a financial processor, such as spend level data, is leveraged using sophisticated data clustering and/or data appending techniques. Associations are established among entities (e.g., consumers), among merchants, and between entities and merchants. In one embodiment, a system and method is provided for passively collecting spend level data for a transaction of a first entity, aggregating the collected spend level data for a plurality of entities; and clustering the first entity with a subset of the plurality of entities, based on aggregated spend level data of the first entity.

One example of a system and method of targeted marketing to consumers includes the U.S. Pat. No. 6,925,441. Specifically, this reference discloses a system and method taking into account the financial characteristics of the consumer, the type of offer being made, and the channel of communication for delivery of the offer. The consumer is characterized according to financial, behavioral, and socioeconomic factors. The offer is characterized by the type of consumer and the potential for the consumer accepting the offer. The channel of communication for delivery of the offer is also characterized and combined with the consumer and consumer-offer characteristics to arrive at a net present value of the offer to be made. If the net present value is sufficient, the offer is processed and presented to the consumer. If the net present value is not sufficient, the offer is revised to present a better value to the consumer (or discarded if the required offer value cannot be created) thereby enhancing the chances that the consumer will accept the offer in question.

Another reference in the field of consumer finances and marketing includes the U.S. Pat. No. 5,974,396. This reference more specifically discloses a method and system for gathering and analyzing customer and purchasing information enabling a retailer or retail chain to process transactional information involving large numbers of consumers and consumer products. Product information is gathered that uniquely identifies a specific product by type and manufacturer and grouped into generic product clusters. Consumers are similarly grouped into consumer clusters based on common consumer demographics and other characteristics. Consumer retail transactions are analyzed by product and/or consumer clusters to determine relationships between the consumers and the products. Product, consumer, and transactional data are maintained in a relational database. Targeting of specific consumers with marketing and other promotional literature is based on consumer buying habits, needs, demographics, etc. A retailer queries the database using selected criteria, accumulates data from the database in response to that query, and makes prudent business and marketing decisions based on that response.

While there may be numerous references which disclose detailed aspects of financial transactions, targeted marketing, and related topics, there is still a need for a method and system that can be more effective in leveraging the consumer's spending power. There is also a need for creating new forms of electronic commerce in which “virtual” marketplace communities can be created for consumers and vendors to expedite and simplify purchases of goods and services, and thereby eliminating or at least simplifying existing complex sales or consumer infrastructure normally associated with both “brick and mortar” businesses as well as traditional electronic business models. There is yet further a need to establish an electronic commerce capability which a consumer may selectively participate within new virtual marketplace environments created for the consumer based upon the consumer's unique spending characteristics.

### SUMMARY OF THE INVENTION

In accordance with the present invention, a system and method implemented by a computing system is provided for determining consumer home economic profiles to form selected virtual marketplace communities. The virtual marketplace communities enable consumers to leverage purchasing power for increased return on goods and services desired by the consumers.

The system and method comprise three primary components or aspects, namely, (1) a data gathering component in which consumer spending data is obtained, validated, analyzed, and categorized, (2) creating a profile for each consumer regarding the consumer's spending history, referred to herein as a “spend profile” that is determined by taking into account calculated “spend scores” and “spend categories” corresponding to each of the consumers, and (3) creating virtual marketplace communities with similarly situated consumers and matching vendors that enable consumers to conduct commerce in a manner that leverages their buying power, and provides a number of other benefits as more fully described herein. These communities are also enable consumers to communicate with other consumers, as well as to cross communicate with vendors and consumers of other virtual communities as also explained in further detail below.

The term “consumer” as used herein is intended to mean any individual, or a defined group including a family, that is engaged in commerce for the purpose of purchasing goods and/or services.

The term “vendor” as used herein is intended to mean any individual or group of individuals that is engaged in commerce for purposes of selling goods and/or providing services. The selling of goods and/or services may also be referred to as commercial trade, including e-commerce. Vendors may alternatively be referred to as marketers. Vendors may include natural persons or legal entities such as corporations, and others.

The term “spend category” as used herein is intended to mean a pre-established category for one or more goods or services. The spend category is used to characterize a consumer's spending past and future spending needs.

The term “spend score” as used herein is intended to mean a score calculated from a formula that takes into account the purchase history of a particular spend category including the cost of the goods/services purchased, the projected cost of the goods/services to be purchased within a defined time period, the frequency of purchase within the defined time period, and the percentage of the amounts spent and to be spent as a function of the total amount spent by the consumer. The spend score characterizes the predicted future behavior of a consumer in terms of the likelihood that the consumer will purchase goods within a specified spend category.

The term “spend profile” as used herein is intended to mean a designating conclusion made regarding a consumer's spending history that is based on selected spend scores. As an example, a spend profile for a consumer could include the top three spend scores in which the highest spend score could be designated as the primary spend profile and the next two highest spend scores could be designated as secondary profiles.

The term “economic metadata” or “spend metadata” as used herein is intended to mean data relating to goods or services that were purchased or used in the past by a consumer, and that may predictably indicate how the consumer may be engaged in commerce in the future. The data may include any identifying information regarding the purchase of goods and services to include price, taxes, locations of purchase, identity of the vendor, date of sale, type of good/service, and others.

The terms “virtual marketplace community” or “virtual community” as used herein is intended to mean a group or collection of consumers and vendors that are brought together based upon similarities in spend profiles and/or spend scores for purposes of conducting e-commerce. The community is formed in a virtual sense in that the group or collection is achieved in a computer implemented system or method in which targeted goods or services are made available for purchase or use by the consumers from the vendors.

The term “electronic commerce” or “e-commerce” refers to the method of conducting financial or commercial transactions between consumers and vendors in which goods and services are purchased through electronic means, such as over a communication network including the Internet or private networks, and as facilitated by computer equipment used by the consumers and vendors. The e-commerce may be further facilitated by an administrator tasked with monitoring and completing financial and commercial transactions electronically.

With respect to the data gathering aspect of the invention, a comprehensive method is provided for obtaining sources of information regarding consumer spending history. Manual data entry of economic metadata is coupled with an automated process to retrieve and analyze the economic metadata to ensure that a consumer's total spending history is obtained. The sources of the economic metadata include financial transaction information, defined herein as including credit card, debit card, direct deposit, and withdrawal transactions, and derivatives of these financial transactions. The economic metadata further includes commercial transaction information defined herein as including merchant invoices, purchase orders, shipping details, coupons, applied discounts, tax information, and derivatives of these transactions. Yet another source of the economic metadata includes cash and cash equivalent information, defined herein as including money orders, cashier's checks, traveler's checks, and derivatives of these cash type transactions. Yet another source of economic metadata includes non-commercial transaction information, defined herein as including gifts, compliments, promotions, and derivatives of these types of cash related transactions.

In accordance with the gathering of economic metadata, the consumer initiates and reports the economic metadata, in which the consumer has the option of allowing the consumer's e-mail accounts, bank accounts, and other electronic accounts to be monitored by a data-gathering engine for reporting the economic metadata.

Once the economic metadata has been retrieved, it is validated, formatted, analyzed, categorized and classified so that ultimately a spend profile can be created for each consumer. Each consumer's spend profile is determined by the consumer's corresponding spend scores. The spend scores as mentioned are a function of categories of purchase/use of goods and services, in which the value of the goods/services are considered, along with the frequency in which the goods/services are purchased/used over a period of time.

One way in which to classify a consumers spend profile is to review the consumers spend scores, and identify the top or highest numerical group of spend scores. The highest spend score could therefore be used to identify the consumer according to a first spend profile classification. The next highest spend score could be used to identify the consumer according to a second spend profile classification, and the next highest spend score(s) could be used to yet further identify a spend profile classifications for each consumer. In a preferred embodiment of the invention, the top three spend scores are used to classify a consumer's spend profile, and these spend profile classifications are used to enable the consumer to selectively join virtual marketplace communities which offer goods/services to the consumer under optimal conditions. These optimal conditions may include discounted prices, discounted bundles of goods and services, consumer reward programs, and other incentives for the consumer to purchase/use goods and services within the respective virtual communities.

In one aspect of the invention, the virtual communities can be organized within the same general spend categories established for evaluating the spend profile of the consumer. With respect to various consumer goods, example categories could include household goods, entertainment, consumer electronics, and apparel. If a consumer was identified as belonging to any one of these classifications based upon the consumer's spend profile, then the consumer is given the opportunity to join a virtual community in which the specific goods or services within the category are offered to members of the virtual community. The virtual community provides optimal conditions for the consumer's purchase or use of the offered goods/services. Further for example, if the consumer was classified within an apparel category, the consumer is given the option to join an apparel virtual community in which consumers of similar profiles within the community are given the opportunity to have direct contact with vendors who might offer apparel at discounted prices, or may provide other benefits to the group of consumers.

In yet another aspect of the invention, it is contemplated that virtual communities can be organized for commerce between not only consumers and vendors, but also between consumers who may have goods or services to sell. In this aspect of the invention, a consumer may also be categorized as a vendor, and can be referred to herein as a consumer-vendor. A virtual community between matched consumers conducts commerce in which consumer spend profiles are matched with consumer-vendors offering goods and services, such as used or second hand items owned by the consumer-vendors.

With respect to generating a spend score for the consumers according to a preferred embodiment of the invention, a formula is used to generate a spend score for each spend category of goods/services. Each spend score can be calculated within this formula by considering three components, namely, (1) the sum of the total amount spent and the projected amount to be spent for the categorized item within a period of time, (2) the percentage that the particular category comprises in terms of the total amount spent by the consumer within the period of time, and (3) a weighted spend frequency variable that is calculated by the number of times that the consumer spends funds toward the categorized item. These three components are then multiplied by one another to obtain a spend score for the particular category.

In another aspect of the invention, the spend score can be further refined to take into account significant life events that take place for a consumer, and which change the consumer's spending habits. Accordingly, a revised calculation for the spend score includes a numeric multiplier that represents a value associated with a life event experienced by the consumer. Examples of life events that may trigger the use of the numeric multiplier include birth of a child, purchase of a new home, a change in employment, and other circumstances in which the consumer may experience a substantial gain or loss in income over a period of time. For the example of the birth of the child, the spend score for a particular category could be multiplied by a numerical factor of 2 if it were observed that a consumer suddenly began to spend a significant amount on a particular category of products or services that could be attributed to a birth the child, such as the purchase of baby supplies.

As part of the data-gathering process to generate and validate economic metadata for a consumer, questions could be posed to the consumer regarding life events, and whether the consumer has experienced or will soon experience a categorized life event that would be then tied to corresponding spend categories. If the consumer was concerned about privacy issues, then this aspect of the data-gathering could still be analyzed and validated if the consumer did not wish to participate in providing the information by evaluating the spending history of the consumer for various spend categories, and observing sharp changes that would signify a significant life event. Therefore, it is contemplated that logic within the system may be able to detect and react to spending habit changes which would presumably correspond to a significant life event, which in turn would trigger the use of the numeric multiplier within the spend score formula. It is also contemplated that the numeric multiplier triggered by a life event could be applied to subcategories or smaller groups of products within a general product category or service. Therefore, this additional factor in determining a spend score can be selectively used not only for a previously existing product or service category, but also new, more narrowly defined categories.

One way in which to determine the spend profile for the consumer is to then review the corresponding spend score for each categorized item. As mentioned, the spend profile can be determined by choosing the highest spend scores from the group of categorized items analyzed. The top three spend scores could be used for establishing the spend profile, in which the highest or top spend score value would be considered the primary consumer profile indicator, while the next highest two values to be considered as secondary consumer profile indicators.

When reviewing the top or highest spend scores, it is also contemplated that the top or highest scores could be validated to confirm that they satisfied a predetermined threshold variance. More specifically, a mathematical variance between the top selected spend scores could be determined, and if the calculated variance was within a predetermined threshold, then the consumer data could be reevaluated by reviewing the consumer's spend categories and economic metadata to revise as necessary. If the calculated variance is not within the predetermined threshold, then the evaluated spend scores would be deemed as adequate for purposes of then determining the final consumer spend profile.

The term “variance” corresponds to its standard mathematical definition, that is, the variance can be defined as the average of the squared differences from the mean. The mean in this case may correspond to the mean or average of the top scores chosen to represent the consumer profile. According to one preferred embodiment as mentioned, the top three scores could be selected to represent the consumer's profile; however fewer or more than three scores can be chosen for profiling purposes.

With respect to creation of a virtual community marketplace, selected consumers are joined with selected vendors to create the virtual marketplaces so that purchases or commitments can be made electronically. In one aspect of the virtual marketplaces, databases store information regarding consumer profiles that match vendors who may fulfill expected desires from the consumer profiles. The databases include detailed information about each of the consumers' spend profiles as well as detailed information regarding the types of goods and services that are available from the vendors. Consumers of a designated virtual community may initiate a marketplace activity, such as a request for desire for purchase of a good or service. The databases are then searched for consumer initiated marketplace activities such as these. Simultaneous with the search for consumer initiated activities, the databases can also be searched for goods or services that are expiring or are expected to be fully consumed, and these expected expiration dates may trigger or constitute another request for a marketplace activity. In yet a third aspect of creating a virtual community marketplace, the databases can be searched for vendor triggered marketplace activities, such as promotions or offers for purchase of various goods/services which may be of interest to the selected consumers within the virtual marketplace. If a particular item is found, then the databases are further searched for a direct match for the item(s) being requested for purchase and the item(s) that is made available for sale. Inherent with this search for a match is to consider the consumers spend profiles, and matching profiles for the vendors. In another aspect of the invention, vendors participate in the virtual marketplaces can be evaluated and classified in the same manner as consumers to determine whether a particular vendor qualifies to provide the goods and services desired by the consumers within the designated virtual marketplaces. The terms “spend category”, “spend score”, and “spend profile” can be applied to vendors. Specifically, a “vendor category” can be defined to mean a pre-established category for one or more goods or services corresponding to the “spend category” in which goods or services are evaluated in terms of selling or vending as opposed to purchasing. A “vend score” means a score calculated from a formula that takes into account the vending or selling history of a vendor within a particular vend category including the cost of the goods/services offered, the projected cost of the goods/services to be sold within a defined time period, the frequency of sale within the defined time period, and the percentage of the amounts sold and to be sold as a function of the total amount sold by the vendor. The vendor score, like the spend score, characterizes the predicted future behavior of a vendor in terms of the likelihood that the vendor will be capable of selling goods within a specified vend category.

In accordance with categorizing vendors, a vendor score may be calculated in the same manner as a spend score, but from the viewpoint of selling goods or services. Therefore, one way in which to determine a vendor score in this manner is to apply a formula considering three components, namely, (1) the sum of the total amount sold and the projected amount to be sold for a categorized item within a period of time, (2) the percentage that the particular category comprises in terms of the total amount sold by the vendor within the period of time, and (3) a weighted vendor frequency variable that is calculated by the number of times that the vendor sells items for a categorized item. These three components are then multiplied by one another to obtain a vendor score for the particular category.

Accordingly, one manner in which to determine the profile for the vendor is to then review the corresponding vendor score for each categorized item. The vendor profile can be determined by choosing the highest vend scores from the group of categorized items analyzed. The top three vendor scores could be used for establishing the vendor profile, in which the highest or top vendor score value would be considered the primary vendor profile indicator, while the next highest two values to be considered as secondary vendor profile indicators. Also like reviewing the highest spend scores, the top or highest vendor scores, could be validated to confirm that they satisfied a predetermined threshold variance. More specifically, a mathematical variance between the top selected spend scores could be calculated.

Establishing vendor scores also enhances the likelihood of creating and maintaining commerce between consumers and vendors. A vendor score or rank provides incentive for vendors to increase sales in the designated virtual communities, and also provides incentive for competition with other vendors to provide better prices, better services, and higher quality goods/services. Ultimately, the consumer benefits because the vendors are placed within a competitive environment in which it can be assumed that optimal pricing and quality are available.

Additional criteria could also be used to categorize and identify qualified vendors including a separate quality certification could be granted to those vendors who have proven over a period of time that they provide optimal pricing and quality. These vendors could receive readily identifiable indications of the quality certification, such as badges/stars that indicate their level of quality and/or competency in selling goods/services. Consumers could choose to therefore participate in virtual communities that only involve vendors with a certain number of badges/stars indicating a certain level of quality and/or competency within the virtual marketplace. The determination of the certification could also be a combined function of the vendor score with other criteria, such as customer satisfaction, or other customer generated information that commented on a purchasing experience with a vendor. The certification could also be used as an additional way in which to filter or separate vendors for ultimately placing the vendors into the appropriate virtual marketplaces. One particular method by which a vendor could earn badges/stars is to evaluate their vendor score, and to account for feedback provided by consumers at the conclusion of a specific commercial activity. A predetermined number of positive or negative feedbacks may be used to determine the number of badges/stars earned considering also the vendor score strength or weakness within the selected virtual marketplace community.

In another aspect of the invention, the consumer to consumer activities could involve a trade in which goods or services were exchanged between consumers. For these type of trade transactions, consumers could be grouped within the virtual marketplaces with corresponding spend/vendor scores indicating the capability to trade goods/services. Therefore, consumers would be connected to one another with like profiles for purposes of conducting trades as opposed to a traditional commercial sale.

In yet another aspect of the invention, traditional commercial sales taking place within the virtual communities could include not only new goods, but also used goods. Particularly for used goods, this may increase activity level within designated virtual marketplaces in which there is targeted consumer to consumer activities. Accordingly, another way in which a virtual community could be organized would be to connect alike consumers who may want to have the option of purchasing goods from not only traditional vendors offering new goods, but also from other consumers who may have competing used goods for sale. This composite type of virtual marketplace introduces some other dynamic factors in terms of providing further incentives to traditional vendors to provide high-quality goods and services at reasonable prices. For example, consumers who have relatively undamaged secondary or used goods may provide additional competition to the traditional vendors, therefore driving down the price of new goods offered within that virtual marketplace.

Assuming that a match can be made between the goods/services desired and the goods/services offered, then the virtual marketplace can be created at that time in which a message can be sent to both the consumers and vendors indicating that the virtual marketplace has been created for one or more specified goods/services, along with other parameters, such as how long the marketplace will be kept open, the conditions under which consumers and vendors may participate (such as requirements requiring a minimum number of purchases, etc.). Logic formulas can be applied to match vendor profiles and consumer profiles to determine the optimal virtual marketplaces for achieving specific goals. Virtual marketplaces themselves could be categorized to optimize commerce between particular characteristics of the selected vendors and consumers. For example, one virtual marketplace could be created for longer, sustained commerce in which consumers and vendors have a long term relationship for repeated and continued sales of common staple goods, such as groceries. In another example, another virtual marketplace could be created for more short-term goals in which the marketplace is intended for less frequent sales, and perhaps at higher costs for non-staple goods such as recreational items (boats, ski equipment, camping gear, etc.).

In yet another aspect of the invention, the identification of a particular consumer could comprise not just a single individual, but a group of people with like characteristics or interest. For example, a “consumer” could include a group of family or friends to derive a community spend score, which may enable a higher volume of goods to be purchased at lower prices. The collective power of a purchasing group may provide vendors with yet further incentives to provide even better prices than a vendor dealing with separate individuals for each purchase. In this aspect of the invention, a virtual marketplace acts not only as a retail market, but also as a wholesale market in which groups of people come together to purchase goods/services. The structure of the virtual marketplace remains the same, thereby taking advantage of the marketplace infrastructure in terms of having the capability to connect consumers and vendors for optimal commercial transactions.

For use in establishing commerce for groups of consumers as opposed to individual consumers who act completely independent of others, selected members of the larger purchasing community may be combined with one another to form sub-communities, or cohorts. More specifically, a cohort can be defined as a more defined sub-community within a larger, previously formed community, in which the cohort facilitates a more accurate prediction of a projected spend for a relatively fewer number of goods/services to be purchased. In this respect, the cohort includes defining parameters or elements, including; (i) members of a previously formed community (such as those consumers with matching primary or secondary profiles); (ii) selected categories of goods/services for which the members of the cohorts are interested in purchasing; and (iii) qualifying spend scores and/or qualifying projected spends. These qualifications may be parameters such as minimum spend scores or minimum projected spends for each member. Another defining parameter for establishing a cohort may include like demographics associated with selected members. These demographics may include identification of gender, age, ethnic background, and other factors. One premise associated for consumers with similar demographics is that they may be more likely to have similar spending habits, which in turn, may provide more predictable projected spends. For example, within a spend category of health products, it may be preferable to create a cohort in which members of a community are separated according to gender since many health products are gender specific.

A cohort can therefore be conceptually considered as a group of individuals with like characteristics who are grouped together to leverage increased purchasing power by virtue of their combined spend scores and/or projected spends in one or more spend categories. The cohorts may typically be established for relatively shorter term purchasing “missions” in which the members of a cohort are identified with defining parameters that indicate a high likelihood that a particular amount and classification of goods/services will be purchased within a known timeframe. These spending “missions” are therefore spending activities that are predicted to occur with a much higher likelihood in a shorter timeframe than other spending activities that might occur over much longer periods of time. In yet another aspect of the invention, a derivative of tracking spend metadata is a function provided to a consumer to recall various spending activities. This recall function can be defined as a “spend intelligence” component in which historical data can be provided to a consumer regarding the consumer's activity within each virtual marketplace in which the consumer participated. This data, along with other financial information of the consumer can be provided to create the spend intelligence. The elements within this spend intelligence may include the net worth of the consumer, the associated liabilities for goods/services purchased (warranties, insurance, etc.), calculated depreciation, recorded spending data regarding each item purchased, the prices and dates of purchase, tracking of duplicate items purchased, tax saving opportunities, and reminders of future activities/actions (renewals due, warranties expiring, etc.). This spend intelligence can be used by the consumer to evaluate the consumer's own performance and activities within the virtual marketplaces, and using this spend intelligence to modify behavior for participation in future marketplaces.

The virtual marketplace itself is in electronic form, and all communications take place electronically. Each virtual marketplace created has information available for review by the consumers and vendors of the particular community, such as a listing of goods/services being offered, corresponding prices, and details as to how and where the goods/services may be purchased. Each virtual marketplace could, in one form, be displayed on a user display of a computer in which the virtual marketplace could be identified by a code or name, along with a listing of the consumers and vendors. However, it is also contemplated that either the vendors and/or consumers could be kept confidential, depending upon the rules established for creation of the virtual marketplace. Other functionality provided within the virtual marketplace would include prioritization of vendors based upon price, quality, discount/rebates, or other criteria which would further enable consumers to choose between one or more vendors which have been made part of the virtual marketplace. As previously mentioned, the virtual marketplace communities can be established based upon categories of goods and services, and therefore, there could be numerous virtual marketplace communities available to a consumer, depending upon how broad or narrow the definition of a particular product/service was defined. For example, there could be one broad category for consumer electronics, which may include televisions, computers, personal digital assistants, etc. In another example there could be a much narrower definition of the consumer electronic category that would only include flat screen televisions. In this more narrow classification of goods, the virtual marketplace community only offers flat screen televisions, and therefore, the corresponding consumers within the more narrowly defined virtual marketplace may be fewer in number as compared to the broader classification for consumer electronics.

The next phase of operation of the virtual marketplace community might include a series of offers made by vendors and/or purchase requests made by consumers. The series of offers and requests could be used to further define the best time and circumstances in which the virtual marketplace community should handle an ongoing series of commercial transactions. For example, logic could be used to collect consumer and vendor responses for buy and sell interest levels, and then an algorithm or formula could analyze and sort potential trades/transactions based upon criteria which would make a series of transactions most profitable for the vendors and most discounted for the consumers. This phase is also conducted electronically, in which various user interfaces are provided to both the consumer and vendor for facilitating analysis of proposed transactions, as well as actual transactions as they are conducted and completed.

In connection with user interfaces or portals made available to vendors and consumers, these include groups or sets of user interfaces that assist with simplified administration of offers and purchase transactions. For example, with respect to the vendor user interfaces or portals, a vendor is provided information regarding the relevant group of consumers which are identified as having qualifying spend scores and spend profiles which are conducive for the vendors to make offers to such consumers. One vendor interface includes a graphical representation of a user/consumer classification based on a projected spend range. This interface details the number of consumers within the selected group or cohort, and their projected spending ranges. The vendor is provided the option to filter the graphical representation in order to obtain more detailed information about the percentage or actual number of consumers who may belong to the projected spend range. For example, within the selected group of consumers or cohort, the vendor may wish to filter the graphical representation in order to determine the number of consumers based upon an age filter or a duration filter. The age filter corresponds to offers to be made to those consumers who are primarily within targeted ages. The duration filter corresponds to the length of time in which an offer is to be made available, it being understood that the duration of the offer may affect the response by qualifying consumers within the selected group/cohort. Another example of a user interface provided for the vendor is a detailed listing of the offers that the vendor has generated, along with statistical information regarding the percent of consumers who have taken advantage of the offers. This information allows the vendor to adjust selling and marketing strategies within the system so that the vendor may maximize the percentage of consumers who take advantage of offers created. With respect to user interfaces made available to consumers, one example of a user interface includes detailed information regarding each consumers' projected spend and spend score. The projected spend may be graphically represented for ease of quick understanding by the consumer. The spend score can also be graphically represented to the consumer in order for the consumer to quickly view and grasp the various categories of goods/services upon which the spend score is based. The projected spend information may be further detailed in a user interface to include a listing of the categories of goods/services making up the projected spend, and the amount of funds that are anticipated to be spent within those categories in order to satisfy the projected spend. The consumer interfaces also include an electronic mail inbox in which the consumer may review and study the various offers made available to the consumer as generated by a system administrator function that processes offers from vendors to the consumers. In this regard, the electronic inbox may be similar to an e-mail inbox that can be reviewed and studied for communications received. These vendor and consumer user interfaces are explained in more detail below with respect to preferred embodiments of the invention. Depending upon the number of consumer and vendor participants, there can be a number of virtual marketplace communities that operate simultaneously for different classifications of goods and services. Further, the specific definitions for each of the virtual marketplace communities may continue to be adjusted over time, such that original definitions for the virtual marketplace communities may shift or change based upon consumer demand and/or vendor availability.

According to other aspects of administering virtual marketplaces, it is also contemplated that an individual consumer may wish to have greater input or control on potentially committing to future purchases based upon their projected spend. In this regard, a consumer may wish to present an offer regarding a projected spend for one or more categories. For example, assume a consumer has a projected spend within an upcoming six-month period of $1000 for a category, such as electronics. The consumer may wish to further leverage their buying power by offering to commit to this projected spend in the form of an exchange pod that represents the value of this projected $1000 amount, and in which vendors participating within the virtual marketplace and in that category have the opportunity to “bid” on the exchange pod. The bidding process can take place by the owner of the exchange pod (the consumer) initiating the auction bidding process by requesting $950 for the exchange pod, that is, a $50 discount on sale of products within the category with the assumption that the consumer will spend $1000 within a time frame associated with that spend score. Each exchange pod can be viewed as a unique future promise or commitment to purchase corresponding goods/services within a known category. However, a consumer who wishes to create an exchange pod also has the capability to withdraw the offer without penalty, assuming a vendor has not already bid on the exchange pod and the consumer has not yet accepted the bid.

In the event a consumer creates an exchange pod and a vendor submits an acceptable bid that is confirmed by the consumer, but the consumer later is not able to execute the amount of purchases designated within the exchange pod within the agreed upon time period, the consumer is still capable of withdrawing participation within the bid, but may be prohibited from obtaining further discounts for that category within the same predetermined timeframe, or simply may not be eligible to participate within a pod exchange activity within the virtual marketplace for a period of time. In this regard, the intent is to provide some predictability in the virtual marketplace for consumers who may wish to create an exchange pod, yet not overly punish the consumer in the event the consumer is not able to fulfill the commitments associated with the exchange pod.

Each exchange pod could be identified by a unique identifier or transaction number which confirms the particular product/service category, the value of the pod, the term of the pod, i.e., the duration of the pod when the consumer must spend the value of the pod within a designated time frame, and whether the exchange pod is transferable to another consumer. Therefore, the exchange pod can be conceptually viewed as a future commodity to be executed within the virtual marketplace. The exchange pod preferably requires execution or validation within the designated term so that vendors who may have bid on the exchange pod are not required to keep their discount offers open indefinitely.

The process involved for competitive bidding on an exchange pod can be conducted in a private bidding context in which consumers can privately advertise their exchange pod and a value for the exchange pod. Vendor participators within the virtual marketplace could jointly view the offered exchange pod and view bids made by other vendors in an open competitive bidding process, but the vendors preferably would not have the ability to identify the personal identity of the consumer. Further, other consumers would preferably not have the capability to view an exchange pod offered by another consumer. In this way, an exchange pod transaction can be conducted in the same way as purchase activities within the virtual marketplace community.

Further in accordance with this exchange pod concept, it can be viewed as a method by which a consumer can “name their own price” for designated goods/services offered within a virtual community. In another aspect of the exchange pod concept, it can also be viewed as a reverse bidding process in which the purchasing consumer is able to query the marketplace in order to obtain further discounted products and services beyond the routine virtual marketplace activities. The exchange pod concept allows a consumer to voluntarily leverage a favorable spend score or projected spend so that the consumer may be able to obtain even better discounts then what may be afforded to other consumers within a designated virtual marketplace. A favorable spend score can be one generally defined as a spend score that is attractive to vendors in the virtual marketplace who are looking for threshold numerical scores to trigger potentially even greater discounts to those consumers who have these threshold scores. The higher the spend score in a particular category, the greater opportunity a consumer may have in terms of leveraging their spend score to obtain greater discounts for goods and/or services to be purchased. Similarly, a favorable projected spend can be generally defined as a projected spend that is attractive to vendors in the virtual marketplace who are looking for threshold numerical projected spends to trigger potentially even greater discounts to those consumers who have these threshold projected spends. In yet another aspect of the invention, execution of an exchange pod within the virtual marketplace can be conducted by the combination of a spend score associated with a cohort as opposed to a spend score associated with an individual consumer. A cohort can be created automatically by the system in which communications can be sent to selected individuals suggesting that they combine into a new group or cohort for purposes of negotiating an exchange pod that can be shared among the members of the cohort. If the offer is accepted, the individual makes a commitment to join the cohort by acknowledging their intent to be a member of the cohort for the particular exchange pod or for future exchange pods in the same spend category or group of spend categories. The offer to join the cohort and the acceptance can be electronic communications. In the prior example, a spend score of $1000 for a six-month period for an individual consumer may be comparable to, for example, a $100,000 spend score for a six-month period when evaluating combined spend scores of individuals within a particular cohort. Therefore, if the cohort having a combined spend score is offered as an exchange pod, it has a much greater value on the virtual marketplace when viewed by the vendors, which in turn may induce vendors to provide even greater discounts than exchange pods offered by individual consumers. Alternatively, the cohort could be introduced in an exchange pod in which the vendors are aware of the number of members along with an average spend score among all of the members. This average is calculated by simply adding the spend scores for each member and dividing by the number of members—therefore a true “average” of the spend scores. The perception by vendors in this case may be that a relatively powerful group of consumers have combined for a spending mission as evidenced by their relatively high average spend score, and again, this may induce vendors to provide even greater discounts than exchange pods offered by individual consumers.

Therefore, it should be understood that the concept of creating and bidding on exchange pods can be conducted not only for individual consumers, but also for a cohort which can be viewed as a single entity for purposes of obtaining commitments from vendors for the value of the exchange pod being offered. The bidding process would be similar with an exchange pod owned by a cohort, that is, the exchange pod would be offered to vendors with a starting bid suggested by a person(s) designated to represent the cohort, and the vendors would bid on the exchange pod until an agreement was made for commitment to the proposed exchange pod by both the cohort representative and vendor(s).

In general, bidding can be conducted with constraints associated with beginning and ending of bidding on designated exchange pods by time deadlines to finish the bidding process, or a desired value of the pod being offered and accepted. For example, the virtual marketplace could be presented with an exchange pod to be evaluated in which the bidding process was limited to a 24 hour period. Alternatively, the bidding process could be kept open until a first bid was made for the posted discount associated with the exchange pod—for example, a spend score of $1000 is set forth in an offered exchange pod, and the posted discount for the $1000 spend score is $920. The first vendor to commit to the $80 discount would therefore win the bid on the exchange pod.

Another way in which exchange pods can be adopted within a virtual marketplace is for a virtual marketplace system administrator or system authority to establish predetermined prices or values for exchange pods, and particularly for cohort exchange pods. In this way, the vendors participating within the virtual marketplace may be able to establish more consistent and long-term relationships with exchange pods owned by proven cohort, that is, that group of purchasers forming cohort who have a track record for validating their cohort spend score by executing continuing purchases within the designated categories of goods/services. For example, a cohort could be established within a virtual marketplace, and the virtual marketplace could offer an exchange pod associated with the cohort at a set price. One or more of the vendors who have had success in dealing with that particular cohort may be more willing to accept the value of the exchange pod based upon favorable prior sales to the cohort which are accurately reflected in the spend score of the cohort. As previously mentioned, developing exchange pods based upon a group of individuals within a cohort may provide greater incentive to a vendor as opposed to a vendor having to deal with individual consumers.

In any exchange pod transaction, the consumer or cohort who owns the exchange pod is not required to accept any bid from any particular vendor. Therefore, it is the owner of the exchange pod who ultimately controls not only the offered value of the exchange pod, (the discount that the owner is seeking for the exchange pod as compared to a corresponding pre-established spend score), but also the vendor who can accept the offer of the exchange pod. For example, a consumer or cohort may be looking for acceptance of an offered exchange pod from one particular vendor, but may wish to reject any other vendor who bids upon the exchange pod. In this regard, the owner of the exchange pod can determine whether to execute the exchange pod transaction, allow it to lapse, or withdraw it from within the activities of the present virtual marketplace.

What these virtual marketplaces achieve is a very focused and direct way of purchasing goods and services, in which value can be maximized for both the consumer and vendor. This focused, incremental approach to electronic commerce differs greatly from traditional electronic commerce in which a user simply browses for items to be purchased from one or more vendors, such as through an Internet search. According to the present invention, a distinct or separate virtual marketplace community can be established for the purpose of combining the purchasing powers of many consumers, and in order to provide vendors with the best opportunity for selling larger quantities of goods at one time thereby limiting the vendors' expenses in normally offering the goods for sale. To illustrate this beneficial arrangement, assume a virtual marketplace community was to be developed for consumers who wished to purchase cellular phones or accessories. Further, assume spend profiles were obtained for a large number of consumers who desired to purchase certain types of phones or accessories, and who would not normally be congregated together within any known geographical area. Under these circumstances, assuming a vendor could be found to satisfy the unmet needs of this unique group of consumers, a vendor or numerous vendors could be assured increased volumes of sales for the accessory items as compared to existing volumes in which sales were more a function of chance. Even applying known targeted marketing techniques, the vendors would not be able to reach out and contact such a focused group of consumers who each had a relatively high interest in purchasing known goods. Further according to this example, assuming the virtual marketplace community was successfully created and one or more vendors were made available, the result should be a series of transactions between the consumers and vendors in which a high volume of goods are sold, with minimum overhead expense to the vendors since the vendors could immediately fulfill the orders, and the vendors would not have to retain stock or other capital accounts which would normally have to be present for purchase of the number of goods within a traditional purchasing community.

With respect to the computer implemented environment in which the method and system operate, it is contemplated that each of the consumers participating in the system have access to a personal computer or a mobile computing device enabling them to connect to one or more communication networks. The system is administered by a system administrator in which consumer accounts are established for gathering consumer economic metadata. A software program is made available to the administrator to provide functionality for each of the separate aspects of the invention, to include data-gathering, determination of consumer spending categories, spend scores, and profiles, and the creation of virtual marketplace communities. Accordingly, in one preferred embodiment, the software could include three separate modules, one for each of the three aspects ((1) data gathering, (2) creation of spend categories, spend scores and spend profiles, and (3) creation of and administering/monitoring of virtual marketplace communities). The system of the invention also includes the necessary databases for storing information regarding consumer spending metadata, as well as information regarding vendor participants, and the various virtual marketplace communities that were established and conducting commerce.

For consumer interaction, the system could be a web based solution, and therefore hosted on a website. In another method of facilitating the invention, the system could include downloadable programs in which the users would communicate to one another through a local private network, or intranet. However, it should be understood that the system and method of the present invention is not limited to any particular electronic communication system or software/hardware configuration.

According to another aspect of the invention, the data-gathering process may include the automated analysis of the consumer spend data or metadata. As electronic commerce progresses, a significant number of consumer transactions are recorded in electronic purchase receipts or confirmations. For example, if a party purchases a product online, or through a traditional “brick and mortar” store, the consumer most times has the option of receiving a receipt by e-mail. According to the automated analysis, all electronic forms of consumer transactions can be analyzed to parse and separate information from the receipts for purposes of determining consumer spending categories, and ultimately the spend scores for each spend categories. Within this analysis, each electronic transaction is evaluated by separating the electronic receipt in rows and columns, which may correspond to specific types of data within the receipt. For example, the upper portion of the e-mail receipt will typically have an e-mail origin, and that can be read and recorded for determining the origin of the electronic receipt. Within the next lower designated area of the receipt, the receipt may provide a header section that identifies basic information, such as the ship to or bill to address, the order total, and the identification of the vendor. In yet another designated portion of the receipt, details may be provided regarding the name or designation of the item/service purchased, the cost, taxes, and other detailed information. The receipt is mapped by a row and column analysis, and the characters/symbols within each of the mapped portions can be analyzed to determine what information has been conveyed through the electronic receipt. Accordingly, the present invention provides logic that can analyze each of the electronic transactions, and is able to parse the receipts to extract relevant information for purposes of determining spend categories and spend scores associated with the classified goods/services that were purchased.

According to the invention, it is therefore one general object to provide a comprehensive method and system that analyzes spend categories, spend scores, and spend profiles using consumer metadata. According to another object, the consumer profiles are established from the analyzed metadata that are ultimately used to connect alike consumers and vendors for forming a virtual marketplace communities for targeted electronic commerce activities. The ability to identify and connect the consumers with vendors in this manner, allows for highly focused, targeted marketing and sales opportunities in which participating vendors can be nearly assured that purchases will be made based upon reliable consumer data. Also, the tracking of consumer spending data and the availability of potential vendors allows for continual creation of future virtual marketplace communities in which the iterative process of analyzing consumes spending habits results in new virtual marketplace opportunities. Consumers and vendors can be joined to one another within the virtual marketplace communities with minimal effort required by the consumers and vendors, yet taking advantage of highly reliable data which likely result in multiple and repeated sales of targeted goods/services. Another advantage of the invention is the ability to connect consumers with other consumer for vendors, and either directly or anonymously within the confines of a virtual community. Accordingly, for those consumers or vendors that may wish to remain anonymous, the system of the invention provides an opportunity for discrete purchasing of goods/services that eliminates follow on marketing activities that may inundate a consumer after an initial purchase. As well known, once the identity of a purchaser is revealed, the purchaser may be later saturated with future marketing materials that may be unwanted by the consumer.

The virtual community marketplace is established in the present invention based upon like needs of both consumers and vendors. Accordingly, the additional expense and time associated with normal commercial activities can be greatly reduced or eliminated, since the marketplace is defined based upon current need of consumers, and availability of products/services of vendors to fit within the same matching profiles of the consumers. Therefore, the invention provides a much focused offering of goods and services based upon known consumer needs that will further expedite, enhance, and increase commercial activities between consumers and vendors.

Other advantages and benefits of the invention will become apparent from a review of the following detailed description, taken in conjunction with the drawings.

### BRIEF DESCRIPTION OF THE DRAWINGS

FIG. 1 is an example communications/data processing network system that may be used in conjunction with embodiments of the present invention;

FIG. 2 is an example computer system that may be used in conjunction with embodiments of the present invention;

FIG. 3 is a schematic flow diagram illustrating some of the basic functions of the system and method of the present invention;

FIG. 4 is a schematic flow diagram illustrating functionality associated with a validating spend or economic metadata obtained from consumers for purposes of determining applicable spend categories for the consumers;

FIG. 5 is a schematic flow diagram illustrating functionality associated with determining spend scores using the predetermined spend categories;

FIG. 6 is a schematic view of a sample electronic receipt, and the manner in which the receipt may be parsed and subsequently used as supporting data used for determining spend categories;

FIG. 7 is a table of information corresponding to economic metadata retrieved for a consumer, detailing pertinent information regarding the consumers spend history;

FIG. 8 is a table of information illustrating a consumer's spend data, including pertinent information for determining the consumer's spend score;

FIG. 9 is a schematic flow diagram illustrating functionality associated with determining and creating virtual community marketplaces;

FIG. 10 is a table of information illustrating an example group of consumers and vendors, and how the example group may be combined with one another to form virtual marketplace communities;

FIG. 11 is a schematic diagram illustrating two example virtual marketplace communities formed including groups of consumers and vendors;

FIG. 12 is another schematic diagram illustrating one of the virtual marketplace communities of FIG. 11, in which notifications are sent by vendors to the consumers regarding offers to sell goods for a particular spend category;

FIG. 13 is another schematic diagram illustrating consumers selecting vendors to purchase goods within the virtual marketplace community of FIG. 12;

FIG. 14 is another schematic diagram illustrating a particular transaction that takes place between a consumer and vendor within the virtual marketplace community of FIG. 12;

FIG. 15 is a schematic diagram illustrating one of the virtual marketplace communities of FIG. 12, including consumers also acting as vendors with respect to offering used goods, and the use of a combined electronic inventory sell list that includes products available through traditional vendors, and consumer-vendors;

FIG. 16 is a schematic diagram illustrating the virtual marketplace community of FIG. 15 in which the consumer chooses to purchase goods from another consumer-vendor; and

FIG. 17 is another schematic diagram illustrating a particular transaction that takes place between a consumer and the consumer-vendor within the virtual marketplace community of FIG. 15;

FIG. 18 is a schematic flow diagram illustrating functionality in a second embodiment associated with determining spend scores using the predetermined spend categories;

FIG. 19 is a table of information illustrating an example group of consumers and vendors, and how the example group may be combined with one another to form virtual marketplace communities according to second embodiment of FIG. 18;

FIG. 20 is a schematic diagram illustrating two example virtual marketplace communities formed including groups of consumers and vendors similar to FIG. 11, but some of the consumer groups are formed as cohorts;

FIG. 21 is another schematic diagram illustrating one of the virtual marketplace communities of FIG. 20, in which the groups of consumers arranged in cohorts have created and offered exchange pods for vendors to bid on within the community;

FIG. 22 is another schematic diagram illustrating one of the exchange pods of FIG. 21 offered by the corresponding cohort, and bids being placed on the exchange pod by vendors who are interested in accepting the offered the exchange pod;

FIG. 23 is another schematic diagram illustrating an exchange pod within a virtual marketplace community; however, the exchange pod is created by a pre-existing contract with one or more vendors in which qualifying consumers are selected to participate within a contract cohort established to enable commerce to be conducted in accordance with the terms of the exchange pod created;

FIG. 24 is another schematic diagram illustrating a virtual marketplace community similar to FIG. 21; however instead of cohorts, individual consumers have created and offered their own respective exchange pods for vendors to bid on within the community;

FIG. 25 is another schematic diagram illustrating one of the exchange pods of FIG. 24 offered by the corresponding consumer, and bids being placed on the exchange pod by vendors who are interested in accepting the offered exchange pod;

FIG. 26 is a sample vendor user interface detailing information on consumer/user classifications based on projected spend ranges, and filters that may be applied by the vendor to view how the number of consumers may differ between filtered inputs;

FIG. 27 is another sample vendor user interface detailing information for assigning offers;

FIG. 28 is another sample vendor user interface detailing information on offers made by the vendor that have been used or not used;

FIG. 29 is another sample vendor user interface detailing information on offers made by the vendor;

FIG. 30 is another sample vendor user interface providing information on how a vendor may establish settings within the system;

FIG. 31 is another sample vendor user interface detailing information on how a vendor may establish an account within the system;

FIG. 32 is another sample vendor user interface detailing information on how a vendor may wish to present offers within the system, to include graphic/visual details;

FIG. 33 is another sample vendor user interface detailing information on how a vendor may wish to categorize its goods/services for offer within the system;

FIG. 34 is a sample consumer user interface detailing information regarding the consumer's projected spend and spend score;

FIG. 35 is another sample consumer user interface detailing additional information regarding the consumer's projected spend, to include categories of goods/services within the projected spend for a designated time period;

FIG. 36 is another sample consumer user interface detailing additional information regarding offers currently available, or historically available, to the consumer, to include detailed information on each offer;

FIG. 37 is another sample consumer user interface detailing additional information regarding a consumer's electronic mail or email inbox that receives communications from a system administrator as to the status of offers made to the consumer;

FIG. 38 is another sample consumer user interface detailing additional information regarding the consumer's spend score and the goods/services purchased by the consumer within specified categories;

FIG. 39 is another sample consumer user interface detailing additional information on a particular good/service purchased by the consumer;

FIG. 40 is another sample consumer user interface showing a geographic map indicating locations where purchases have been made, along with a value purchases made at those locations;

FIG. 41 is another sample consumer user interface showing a general status screen, indicating particular goods/services that may be available to the consumer for purchase;

FIG. 42 is another sample consumer user interface showing another general status screen, indicating the presence of an electronic inbox, alerts, discounts available, gift coupons available, among other information; and

FIG. 43 is yet another sample consumer user interface showing a sign-up screen enabling the consumer to register with the system as a recognized user/consumer.

### DETAILED DESCRIPTION

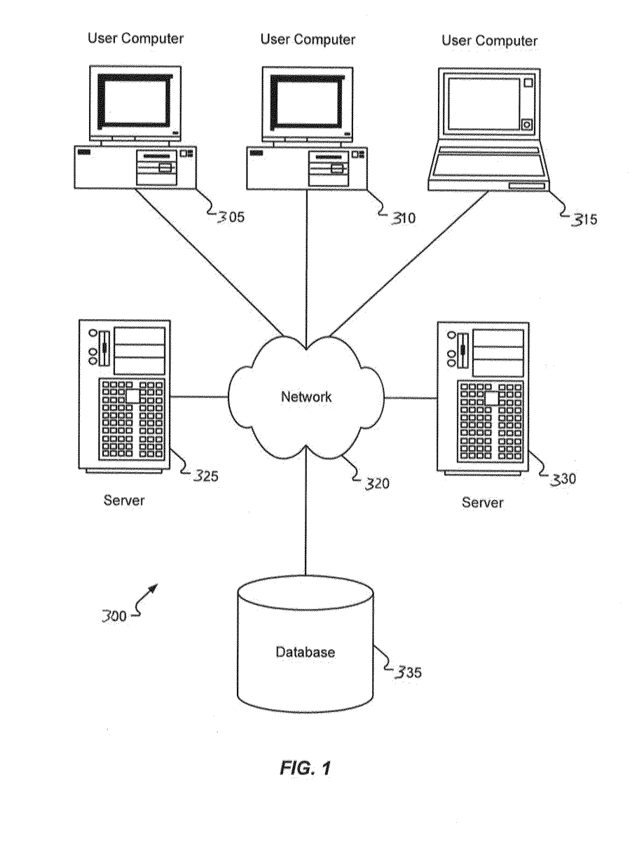

Referring to FIG. 1, an example network system is provided that may be used in connection with the system and method disclosed herein. More specifically, FIG. 1 illustrates a block diagram of a system 300 that may use a web service connector to integrate an application with a web service. The system 300 includes one or more user computers 305, 310, and 315. The user computers 305, 310, and 315 may be general purpose personal computers (including, merely by way of example, personal computers and/or laptop computers running various versions of Microsoft Corp.'s Windows™ and/or Apple Corporation's Macintosh™ operating systems) and/or workstation computers running any of a variety of commercially-available UNIX™ or UNIX-like operating systems. These user computers 305, 310, 315 may also have any of a variety of applications, including for example, database client and/or server applications, and web browser applications. Alternatively, the user computers 305, 310, and 315 may be any other electronic device, such as a thin-client computer, Internet-enabled mobile telephone, and/or personal digital assistant, capable of communicating via a network (e.g., the network 320 described below) and/or displaying and navigating web pages or other types of electronic documents. Although the exemplary system 300 is shown with three user computers, any number of user computers may be supported. The user computers may be operated by the consumers, vendors, and any other parties that may be participating in the virtual marketplace community.

System 300 further includes a network 320. The network 320 may be any type of network familiar to those skilled in the art that can support data communications using any of a variety of commercially-available protocols, including without limitation TCP/IP, SNA, IPX, AppleTalk, and the like. Merely by way of example, the network 320 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system 300 may also include one or more server computers 325, 330. One server may be a web server 325, which may be used to process requests for web pages or other electronic documents from user computers 305, 310, and 315. The web server can be running an operating system including any of those discussed above, as well as any commercially-available server operating systems. The web server 325 can also run a variety of server applications, including HTTP servers, FTP servers, CGI servers, database servers, Java servers, and the like. In some instances, the web server 325 may publish operations available as one or more web services.

The system 300 may also include one or more file and/or application servers 330, which can, in addition to an operating system, include one or more applications accessible by a client running on one or more of the user computers 305, 310, 315. The server(s) 330 may be one or more general purpose computers capable of executing programs or scripts in response to the user computers 305, 310 and 315. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 330 may also include database servers, including without limitation those commercially available from Oracle, Microsoft, Sybase™, IBM™ and the like, which can process requests from database clients running on a user computer 305.

In some embodiments, an application server 330 may create web pages dynamically for displaying the development system. The web pages created by the web application server 330 may be forwarded to a user computer 305 via a web server 325. Similarly, the web server 325 may be able to receive web page requests, web services invocations, and/or input data from a user computer 305 and can forward the web page requests and/or input data to the web application server 330.

In further embodiments, the server 330 may function as a file server. Although for ease of description, FIG. 1 illustrates a separate web server 325 and file/application server 330, those skilled in the art will recognize that the functions described with respect to servers 325, 330 may be performed by a single server and/or a plurality of specialized servers, depending on implementation-specific needs and parameters. The administrator(s) of the system and method may operate and control the servers and server computers.

The system 300 may also include a database 335, or additional databases as necessary to handle data storage requirements for the system. The database 335 may reside in a variety of locations. By way of example, database 335 may reside on a storage medium local to (and/or resident in) one or more of the computers 305, 310, 315, 325, 330. Alternatively, it may be remote from any or all of the computers 305, 310, 315, 325, 330, and in communication (e.g., via the network 320) with one or more of these. In a particular set of embodiments, the database 335 may reside in a storage-area network (“SAN”) familiar to those skilled in the art. Similarly, any necessary files for performing the functions attributed to the computers 305, 310, 315, 325, 330 may be stored locally on the respective computer and/or remotely, as appropriate. In one set of embodiments, the database 335 may be a relational database, such as Oracle 10i™, that is adapted to store, update, and retrieve data in response to SQL-formatted commands.

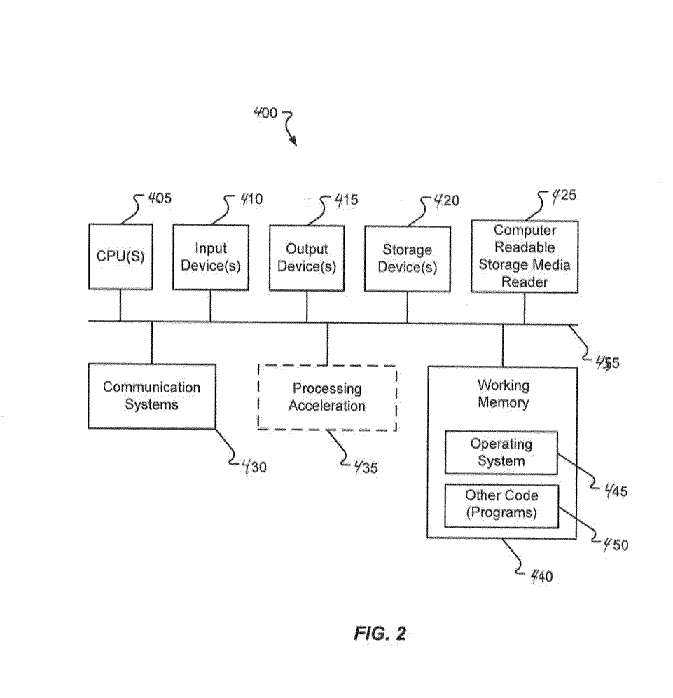

Referring to FIG. 2, an example computer system is provided that may be used in connection with the classification systems and methods disclosed herein. More specifically, FIG. 2 illustrates one embodiment of a computer system 400 upon which a web service connector or components of a web service connector may be deployed or executed. The computer system 400 is shown comprising hardware elements that may be electrically coupled via a bus 455. The hardware elements may include one or more central processing units (CPUs) 405; one or more input devices 410 (e.g., a mouse, a keyboard, etc.); and one or more output devices 415 (e.g., a display device, a printer, etc.). The computer system 400 may also include one or more storage device 420. By way of example, storage device(s) 420 may be disk drives, optical storage devices, solid-state storage device such as a random access memory (“RAM”) and/or a read-only memory (“ROM”), which can be programmable, flash-updateable and/or the like.

The computer system 400 may additionally include a computer-readable storage media reader 425; a communications system 430 (e.g., a modem, a network card (wireless or wired), an infra-red communication device, etc.); and working memory 440, which may include RAM and ROM devices as described above. In some embodiments, the computer system 400 may also include a processing acceleration unit 435, which can include a DSP, a special-purpose processor and/or the like.

The computer-readable storage media reader 425 can further be connected to a computer-readable storage medium, together (and, optionally, in combination with storage device(s) 420) comprehensively representing remote, local, fixed, and/or removable storage devices plus storage media for temporarily and/or more permanently containing computer-readable information. The communications system 430 may permit data to be exchanged with the network 320 and/or any other computer described above with respect to the system 400.

The computer system 400 may also comprise software elements, shown as being currently located within a working memory 440, including an operating system 445 and/or other code 450, such as program code implementing a web service connector or components of a web service connector. It should be appreciated that alternate embodiments of a computer system 400 may have numerous variations from that described above. For example, customized hardware might also be used and/or particular elements might be implemented in hardware, software (including portable software, such as applets), or both. Further, connection to other computing devices such as network input/output devices may be employed. As mentioned, the functionality of the system and method of the present invention may be incorporated within one or more software programs, including one or more software modules which provide functionality for the various aspects of the invention.

It should be appreciated that the methods described herein may also be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

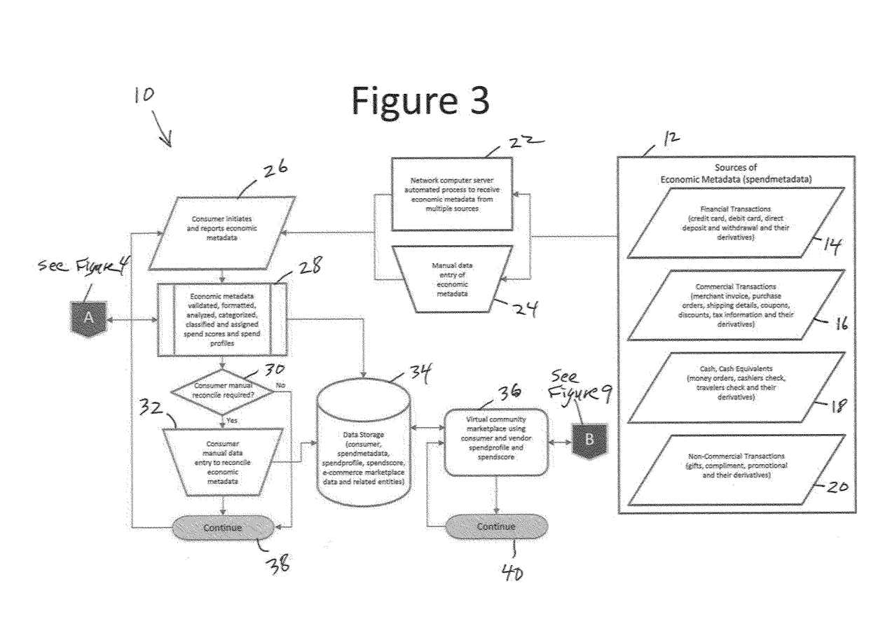

Referring to FIG. 3, a flowchart 10 is illustrated showing basic features of the system and method of the present invention. Block 12 lists sources of economic metadata or spend metadata that is used to generate spend categories, which are then used to determine a consumer's spend scores, and ultimately, the consumer's profile. The sources of metadata are separated into four categories, namely, financial transactions 14, commercial transactions 16, cash and cash equivalents 18, and noncommercial transactions 20. The financial transactions 14 include purchases of goods or services by credit card, debit card, and bank transactions, such as direct deposits and withdrawals from applicable bank accounts. These financial transactions are all typically capable of being viewed by the consumer with an online account. For commercial transactions 16, these include all types of normal commercial transactions that may be recorded or memorialized through various means to include merchant invoices, purchase orders, shipping details, coupons, discount receipts, tax information, and their derivatives. Like financial transactions 14, the commercial transactions 16 are typically capable of being viewed by the consumer, either through an online receipt, or through a printed receipt. For cash and cash equivalents 18, these include transactions that are made by money orders, cashier's checks, traveler's checks, and their derivatives. This category also includes “pocket” cash. With the exception of pocket cash, the other types of cash and their equivalents are also recordable by providing the consumer with a receipt or transaction notice. For noncommercial transactions 20, these include gifts, compliments provided to the consumer, often referred to as “comps”, promotional items/discounts, and their derivatives. For these transactions 20, some of them may be recordable and provided to the consumer in some tangible form, such as a receipt or notice, while others may not have been recorded.

Referring to block 22, it represents the automated process for receiving economic metadata from the multiple sources 12. In this step, the administrator of the system can set up some type of agreement with the consumer in which the consumer may allow access to one or all of the sources of economic metadata, such that the metadata may be analyzed to determine the consumers spend categories and spend score. In one aspect of the invention, the consumer's selected sources of economic metadata would be transferred to and stored in a database for further analysis, as discussed below. At block 24, it is also contemplated that there could be a manual data entry of selected economic metadata, such as noncommercial transactions 20 or cash transactions 18 in which there may not have been recordation of the consumer's purchase, and therefore, the consumer may have to manually enter the data. Further, for those transactions in which only a printed receipt is obtained, the user could also have the option of manually entering information.

At block 26, the consumer initiates and reports the economic data. This reporting step could include the consumer's authorization for the administrator of the system to upload the economic metadata from the designated database for the automated process 22, as well as the data which was manually entered at block 24.

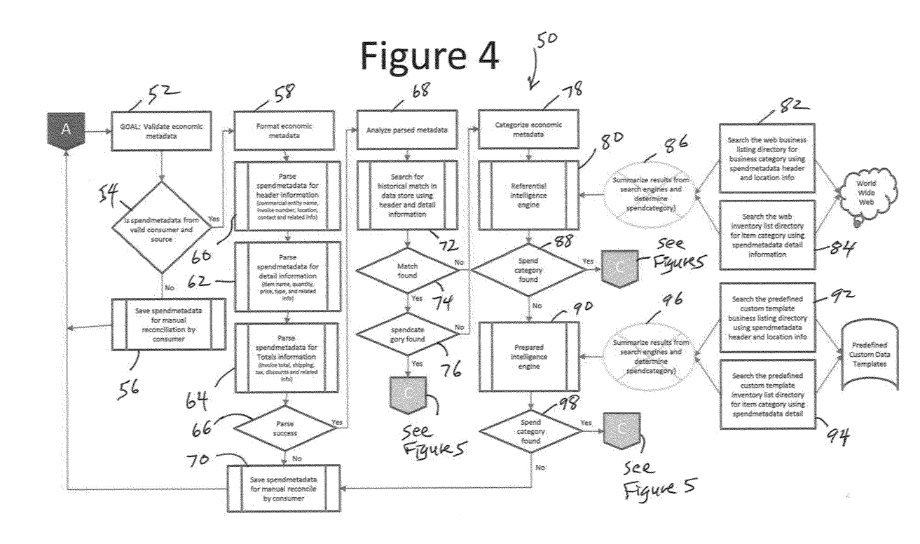

At block 28, the economic metadata is validated, formatted, analyzed, categorized, classified, and ultimately results in the creation of the consumers spend scores and spend profiles. This part of the method of the invention is more fully described with respect to FIG. 4.

At block 30, the consumer reviews the analyzed metadata, and as necessary, makes manual adjustments or corrections to the analyzed metadata, shown in block 30 as the consumer's manual reconciliation. This reconciliation can occur at all steps in the analyzing of the metadata to include the consumer's opinion or correction regarding the consumer's spend categories, spend scores, and spend profile. For example, the consumer could make manual corrections to the inputted metadata to correct any discrepancies regarding how the data was recorded and analyzed, as well as to supplement the metadata with any missing information. Despite the consumer's best attempts, the consumer is likely to have various transactions that are not recorded and reported. Further, even if the consumer's metadata was accurate resulting in accurate spend categories and spend scores, consumer may still wish to be considered eligible for one or more of the virtual marketplace communities for the purpose of being able to participate in a selected community. To prevent fraud and to preserve the sanctity of the spend score and spend profile schemes, the options provided to consumers for correction of data is controlled and limited in scope. For example, the limited options provided to a consumer may include the ability to determine the spend category of an item for which the system is unable to categorize, or to add data regarding a purchase if the consumer is able to produce evidence of a financial transaction (such as credit/debit/cash transaction) that was not previously captured within the data-gathering effort. For example, there could have been a time period in which the consumer was not capable of purchasing, or did not choose to purchase a particular category of goods/services, but the consumer realizes that in the near future, the consumer will have a heightened need for a particular class of goods or services. In this case, the consumer could request to participate in a selected virtual community, which otherwise might not be available to the consumer based upon the consumer's recent purchase history. In most cases, a purchase activity is considered important in developing a consumer's spend score and spend profile. Although the rules for developing spend scores and spend profiles may be very flexible, it is generally advantageous to maintain accurate spend scores and spend profiles. However, a first time consumer to the system of the invention could be provided the ability to join a virtual community with no prior purchase history. This new consumer could be identified as such and distinguished from established consumers who have existing spend categories and spend scores. Over time, the new consumer would develop a spending history, and corresponding spend scores and categories.

At block 32, it is shown that the consumer can conduct a manual data entry or correction to reconcile economic metadata. As explained at block 34, the consumer's economic metadata, spend profile, spend scores are stored in yet another database, and this stored data serves the basis for providing to the consumer the virtual marketplace communities to be created.

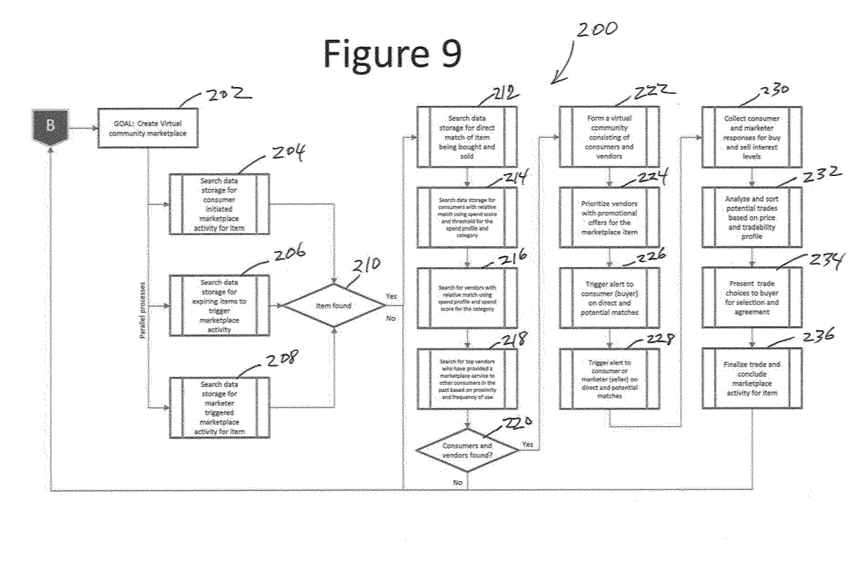

At block 36, the virtual community marketplaces are created, and the consumers and vendors are able to conduct electronic commerce for the purchase/exchange of goods and services. The creation of the virtual community marketplaces is explained in more detail below with respect to FIG. 9.

FIG. 3 also illustrates that there is a continual process in terms of the updating and reconciliation of the consumer's economic metadata, as well as the consumer's comments and adjustments to the metadata, as represented in block 38.

In terms of the creation of virtual community marketplaces, this is also a continually updated, process, as indicated by block 40. The virtual community marketplaces can be designated for a selected period of time, and may expire once a series of transactions take place which satisfy the consumer and vendor needs. Alternately, selected marketplaces may continue indefinitely based upon vendor and consumer needs. New marketplaces are created from time to time, and therefore the process of creating virtual community marketplaces is continuous and changing.

Referring to FIG. 4, another flow diagram 50 is illustrated that explains a process for gathering economic metadata, as well as validating the economic metadata to confirm that it accurately represents a consumer's spending activities. Referring to block 52, a first general step is to validate the economic metadata. At block 54, the metadata is reviewed to confirm that the metadata corresponds to a valid participating consumer, as well as a source of the spending item. For example, with respect to a valid participating consumer, the system of the invention could be based upon a membership requirement in which consumers would be identified by their unique username and ID. The membership requirement could be one which is either free, or could be based on a paid subscription. Accordingly, gathered economic metadata for the consumer would be linked to a consumer who had a valid membership. The source of the economic metadata is also confirmed that it corresponds to commercial activities of the identified consumer, and not some other unidentified consumer. At block 56, if there was not a valid match of the consumer or economic metadata source, then this circumstance may require a manual reconciliation by the consumer.

If the economic metadata source and consumer were validated, then a next step is to format the economic metadata, shown at block 58. Blocks 60, 62, and 64 provide examples of how the metadata might be separated or parsed in order to obtain the applicable and necessary information. For example, at block 60, the metadata for a particular transaction could be initially parsed to obtain information from the header portion of the electronic receipt. At block 62, the electronic receipt could be further parsed to obtain detailed information regarding the ticket item, price, etc. At block 64, the electronic receipt could be further parsed to obtain information regarding the total or sum of the transaction, such as the invoice total, tax information, etc. At block 66, assuming the parsing actions were successful, the next step is block 68 which is to analyze the parsed metadata. As also indicated at block 66, if the parsing efforts were not successful, then as shown at block 70, the metadata could undergo a further manual reconciliation by the consumer.

At block 72, the parsed metadata could then be matched for historical data of the consumer which would indicate confirming information regarding the electronic receipt. For example, assume that the consumer had made a number of previous purchases from a particular online retailer, and the format of the parsed metadata matched the same format from the previous purchases. Accordingly, assumptions could be made that the currently parsed metadata originated from the same retailer and therefore, this match enables immediate confirmation and recordation of the metadata. The matching of historical purchases is best accomplished in most cases with a comparision between header and detail information parsed from the merchant invoices. It is important to match the spend category using the item purchased noted in the detail information rather than rely on the header information since the header information will unlikely provide the details regarding the item actually purchased.

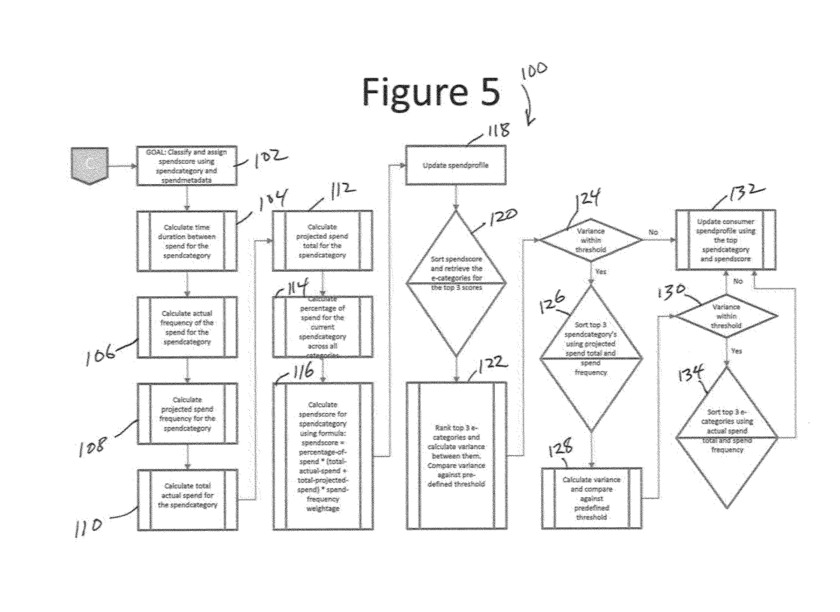

As shown at block 74, if the match was found, then the next step may be to determine whether the match corresponds to a previously created spend category, shown at block 76. If there is also a match between the previously generated spend category, then the parsed information could be used directly for one of the pre-established spend categories. Spend categories are more specifically explained below with respect to FIG. 5.

Referring again to block 74, if there was no match found, then an effort must be made to categorize the economic metadata, shown at block 78. There are two general methods for determining a category for the economic metadata. The first method is shown as a referential intelligence engine, shown at block 80. The referential intelligence engine refers to a search protocol and analyzing the searched material to find a match for the economic metadata. More specifically, as shown at block 82, a search can be made from the World Wide Web for business listing directories to categorize the metadata header and location information. Additionally, as shown at block 84, a search can be conducted of the World Wide Web for inventory lists for categorizing the detailed information from the economic metadata. As shown at block 86, the search results are summarized, and assuming that the search results find the information searched, a spend category can be assigned, shown at block 88. If there is no match found from the search, then as shown at block 90, the second method for determining a category for the economic metadata can be used, namely, use of a prepared intelligence engine. The prepared intelligence engine refers to a predefined business category or item inventory template which best matches the economic metadata in terms of assigning the spend category. For example, as shown at block 92, a search can be made of a predefined custom template business listing directory using the applicable economic metadata to find a match. Alternatively, as shown at block 94, a search can be conducted of a predefined custom template inventory list directory for individual items or individual services that best match the predefined list of categories. As shown at block 96, the results are summarized from the searches from the predefined templates. Assuming this effort of the search for a matching predefined custom template exists, then the spend category can be considered found and can be assigned, shown at block 98. If there is still no match of the metadata with the search conducted within predefined templates, then the metadata can be further reconciled/reviewed by the consumer, as shown in block 70.

Referring to FIG. 5, a flowchart 100 is illustrated that explains a method of determining a consumer's spend scores using the assigned spend categories determined from FIG. 4. Accordingly, at block 102, the goal is to classify and assign spend scores using the spend categories.

At block 104 as a first step, a calculation is made for the time duration between spending activities for a particular spend category. More specifically, each categorized item or service is reviewed to determine the time duration between purchases by the consumer. At block 106, a confirmatory calculation can be made to confirm the actual frequency of the spend activity for the categorized item. At block 108, a projection can be made regarding the projected frequency of the spending activity for the item. The starting point of a projected spend duration is the date the item category was purchased for the first time, and the spend duration does not have to be within a current calendar year. The projected spend duration can be determined by the difference in duration between when the last date the item in the category was purchased as compared to the first purchase date. Depending upon available data, the calculated spend duration can be used to set all of the categories. At block 110, a calculation is made for the total actual amount spent for the particular item. The actual amount spent is the true value paid for the item, meaning the list price minus any discounts and offers. As one can appreciate, consumers may only be willing to purchase items at discounted prices as compared to list prices and it is desireable to capture the true value paid and not some other inflated or perhaps defleated value.

At block 112, a calculation is made for the projected amount to be spent for the spend category based upon the designated period of time. At block 114, a calculation is made to determine the amount of funds spent for the spend category as compared to all of the categories for the consumer. For each consumer, there will be a finite number of spend categories that are identified. The percentage spent for each category is simply calculated by dividing the amount spent in the category by the total amount spent by the consumer across all categories.

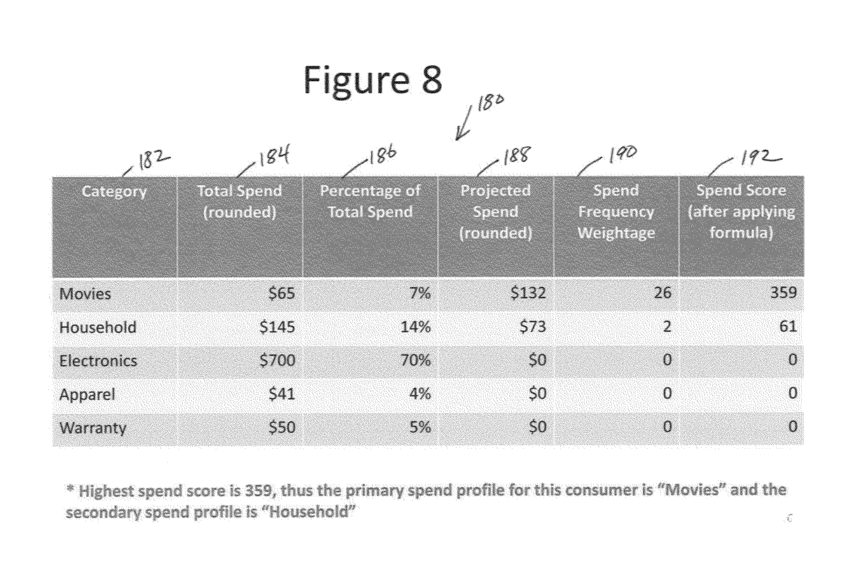

At block 116, a calculation is made to determine the spend scores for each corresponding spend category. The spend score is calculated by multiplying the percentage of the total spend (block 114) by the sum of the total actual spend and the total projected spend for the spend category, and then multiplied by the spend frequency, also referred to as the spend weight or weightage. Examples of calculating the spend scores is also discussed further below with respect to FIG. 8.

At block 118, an initial determination is made as to the spend profiles of the consumer based upon the actual spend totals and spend frequencies.

Referring to block 120, the individual spend scores are sorted to identify the top three scores. In one example, the top spend score could therefore be defined as the primary spend profile for the consumer, while the next highest two spend scores could be defined as secondary spend profiles for the consumer. Referring to block 122, a calculation can be made to confirm that the three selected spend scores fall within a predefined threshold variance. The purpose of determining the variance is to differentiate between the primary spend profile and the secondary profiles. Especially when the spend scores are the same or very close to one another, a variance calculation is a method to further separate the categories and to isolate to a specific primary category. Calculated variance values that are within a pre-designated range generally means the spend scores are not easily differentiated and further data gathering could be done to revise the spend scores in an effort to determine in fact if the spend scores were so coincidentally close to one another. A variance calculation with separation between values outside of the pre-designated range provides a conclusion that the scores may be valid and therefore can be evaluated on their face.

At block 124, the variances are reviewed. At block 126, if the calculated variance is within a predefined threshold, then the top three spend categories are sorted using the projected spend total and spend frequency for each corresponding category. Another calculation is made to determine the variance, and this is again compared against the predefined threshold, shown at block 128.

At block 130, the calculated variances are reviewed again. If the variance falls within the predefined threshold, then as shown at block 132, the consumer's spend profile is finally determined. If the calculated variance is not within the pre-designated threshold, then as shown at block 134, the top three categories from the actual spend total and spend frequency are used as the consumer's actual spend profile.

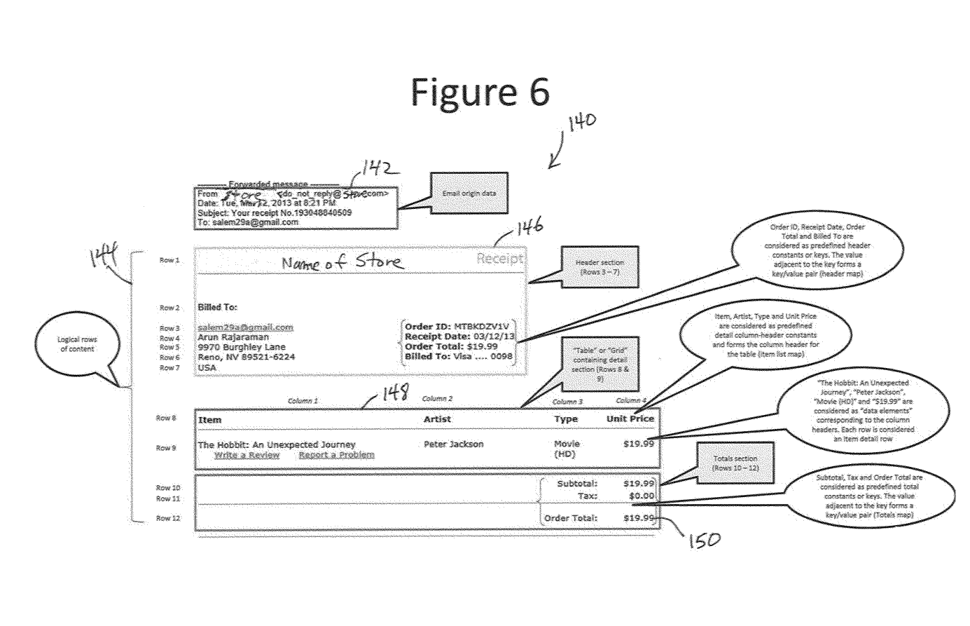

Referring to FIG. 6, a schematic view of a sample electronic receipt 140 is shown, and the manner in which the receipt may be parsed and subsequently used as supporting data used for determining spend categories. FIG. 6 could also represent a scanned paper receipt, mechanical invoice, or any other tangible communication regarding a purchase transaction. In the example of FIG. 6, the sample electronic receipt has been sent as an e-mail message. The top portion of the e-mail includes the e-mail origin data 142. The remaining portion of the e-mail can be separated into rows and columns to be mapped for purposes of retrieving relevant economic metadata for the receipt, which in turn is used as data to determine the corresponding spend categories. The remaining portion of the e-mail is shown as being separated into logical rows 144. Each of the rows may contain information regarding the nature of the purchase, price, etc. The rows may be further divided into subjects or categories relevant to the consumer's purchase. In the in the example of FIG. 6, the e-mail receipt further includes a header section 146, a table or a grid 148 with detailed information regarding the nature and price of the purchased good/service, and a total section 150 that provides information regarding the total purchase amount and tax information. As shown, the header section 146 is found within rows 1-7, the grid section 148 is found within rows 8-9, and the totals section 150 includes rows 10-12. Through an automated process, character recognition can be made for the data within these three sections, and this data can then be stored as corresponding to relevant data for recording the relevant information for the purchase to be used in determining the corresponding spend category. Therefore, in accordance with another aspect of the invention, an automated process is provided for analyzing documents to parse and then record relevant information regarding the document as it should be used for determining values for consumer spend categories. The consumer could be urged to provide the administrator spend metadata in the electronic form, such as found in FIG. 6, which may facilitate automatic processing of the economic metadata, thereby minimizing the consumer's personal efforts in having to record and forward relevant economic metadata. Therefore, the automatic process of recording the economic metadata makes the system easier to use for both the administrator and consumer/vendors.

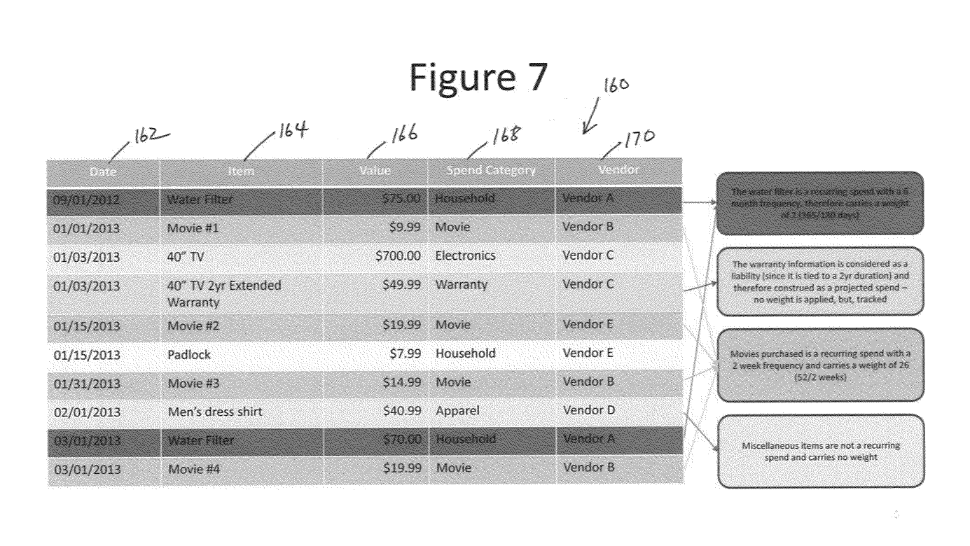

Referring to FIG. 7, an example table 160 is provides information corresponding to economic metadata retrieved from a consumer detailing pertinent information regarding the consumer's spending history. This table more specifically provides spend categories for a particular consumer that can then be used to determine the spend scores. Information shown in the table includes the date of purchase 162, the item 164, the value of the purchase 166, the designated spend category 168, and the identity of the vendor 170. It should be understood that this figure is intended to represent sample data for particular consumer to illustrate how the consumer's spending history can be tabulated and categorized according to spend categories. Therefore, it should be understood that FIG. 7 does not illustrate each and every purchase made by the consumer, but only those that have been categorized for purposes of ultimately allowing the consumer to be a participant in a virtual marketplace community. With respect to the two purchases within the household category, the purchased item is a water filter purchased at a six-month frequency. Therefore, a weight or weightage for this purchased item is assigned a numerical value of 2 (the designated period of time being one year in which two purchases were made). With respect to the purchased warranty, no weight is applied since this purchase is a nonrecurring item for at least two years. Purchases that do not occur more than one time per year have no weight assigned. However, it shall be understood that the time period or time frame can be modified for each category depending upon how the consumer wishes to be considered eligible for marketplace activities. With respect to the purchased movies, the data in the table indicates that the frequency of purchase for the movies is approximately every two weeks. Therefore, a weight of 26 is assigned to the movie category. With respect to the other miscellaneous items, namely, the 40 inch television and the men's dress shirt, these items are not recurring spend items within the year and, therefore are not assigned a weight value.

Referring to FIG. 8, this table 180 illustrates the consumer's spend data including pertinent information for determining the consumer's spend score based upon the spend categories from FIG. 7. More specifically, the table 180 provides information regarding the spend category 182, the total amount spent 184, the percentage of the total amount spent for the particular category 186, the projected amount to be spent within the designated time 188, the spend frequency weight 190 as applied to the particular category, and the calculated spend score 192 for each of the items listed. For the bottom three items, namely, the electronics, apparel, and warranty, the spend score is assigned a zero value because there is no frequency weightage applied. However, for the top two items, namely, the movies and household categories, spend scores are calculated because some weightage is assigned to each of the categories. The calculation of the spend score for Movies categories is (0.07)×(65+132)×26=359. The calculation of the spend score for the Household categories is (0.14)×(145+73)×2=61. Therefore, according to FIG. 8, the highest spend score is 359, and the corresponding primary spend profile is Movies. The secondary spend profile is Household. It should be understood that the actual spend categories for a consumer might include a greater number of categories with corresponding spend scores. Therefore, FIG. 8 represents a simplified example.

Referring to FIG. 9, this shows a schematic flow diagram 200 illustrating functionality associated with determining and creating virtual community marketplaces. Accordingly, at block 202, the goal is to create virtual community marketplaces that are comprised of various consumers and vendors, each of which who are matched to one another based upon a goal of selling goods and services to those consumers who have like interests, and those vendors who have the capability and desire to provide the goods/services sought by the consumers.

Referring to block 204, a first step in creating a virtual marketplace is to search the data storage for an item/service that is desired to be purchased. Block 204 represents a search for consumer initiated marketplace activity, that is, items that show up on the consumers spend profiles as either primary or secondary spend profiles. At block 206, another source for finding an item that can be used for sale within the virtual marketplace includes search of the data for items that may not have showed up on a consumer's profile, but might be considered trigger items. That is, trigger items are those items that could be expiring and require replacement, or items that are to be replaced due to required service intervals. At block 208, yet another source is available for an item that could be placed within the e-commerce environment, namely a search of the data for those items made available by vendors that may have some special benefit associated with the offer thus creating a triggering event, such as limited time discounts, sales, etc. At block 210, if an item is found that can be used within the virtual marketplace to be created, then at block 212, a search is made for the particular item to be bought and sold. This step can be further divided as two separate steps as shown in boxes 214 and 216. More specifically, block 214 is a search for consumers with a relative match using spend profiles, and block 216 is a search for vendors having a relative match using vendor profiles based upon vendor scores for the corresponding category. At block 218, a vendor verification check can be made to confirm that the vendors to be placed within the virtual community have provided similar goods or services in the recent past, also taking into consideration the proximity of the vendors and the frequency of use of the vendors. Therefore, in another aspect of the invention, once actual commercial transactions are conducted in each virtual marketplace community, information is stored regarding the vendor, and the number of goods/services delivered, the price, location, etc. As can be appreciated, even within electronic commerce, it makes more sense for geographically close vendors to provide some types of goods and services. For goods, the cost of shipment to the consumer will ultimately affect price, which makes it more attractive for the consumer to have available within the virtual community vendors that are located close to the consumer. With respect to services, it is obvious that some services can only be provided if the vendor is actually located in the same general geographical area. For example, if the services to be traded within the virtual community include carpet cleaning services, then the only qualified vendors could be those that are within the same geographical area. Vendors located hundreds of miles away could not be considered as qualified to participate in a virtual community being formed for carpet cleaning services.

At block 220, assuming consumers and vendors are found with matching goods/services to be bought and sold, then the virtual marketplace community can be formed, shown at block 222. In tangible form, the virtual marketplace community would simply exist in electronic form in which the participating consumers and vendors could be provided, for example, a designated webpage to view the goods/services offered, and also allowing the purchase transactions to take place over related links. Therefore, in one sense, a virtual marketplace community could resemble an online auction in which various goods and services were offered; however, it likely being that there is no bidding process involved, and the vendors prices are set. However, in yet another aspect of the invention, it is also contemplated that vendors could selectively offer various promotions, to include bidding options for purchase of goods and services. Accordingly, as shown at block 224, one way in which to commence the virtual marketplace would be to prioritize vendors with promotional offers related to the item/service to be sold. At block 226, some triggering event could occur which would advise the consumer that the virtual marketplace had been formed for the particular categorized item, and that the consumer is invited to attend and purchase goods/services within the newly formed community. Referring to block 228, the vendors and consumers could be advised as to direct and potential matches regarding exact goods and services to be bought and sold. Within this step, what could occur is a detailed listing of goods/services that are desired to be purchased by the participating consumers, and then a corresponding listing of goods/services available to be purchased from the vendors, along with an indication of direct matches between the two listings. For example, assume one or more consumers wish to have a specific model and type of television within a designated price range. For those vendors participating in the same virtual community, the vendors could make available listings of items in which some of them might be a direct match to those listed by the consumers. An automatic comparison could be made between the list of goods/services desired and those made available by the vendors, resulting in triggering yet another alert to the consumers and vendors that there are exact matches available within the marketplace. Referring to block 230, consumers and vendors could further indicate that they are prepared for executing the purchase transactions. The indications at block 230 could also include levels of interests exhibited by the consumer and for vendors for consummating the purchase transactions. For example, there may be one or more consumers who have a very high need for a particular type of item at that time, but a very low interest for a different type of item at that time. Accordingly, consumers could be also profiled to show their interest levels for particular goods and services. A vendor may then adjust their offer of goods and services corresponding to the interest levels of the consumers at that time. For example, for group of consumers showing a high-interest for one particular type of good, the participating vendors might be willing to offer yet further discounted prices or benefits associated with the item that is shown as being of high interest to the group of consumers.

At block 232, some optional analysis could take place regarding potential trades/purchases based on price and tradability comparisons. More specifically, consumers could be given the option to review price lists for the item/services being sought, and to also review the capability that the vendors can provide the goods/services in a timely and quality oriented manner.

Referring to block 234, trade or purchase options are finally officially made available between the consumers and vendors. At this step, the consumer then makes a choice as to whether any goods or services offered within the virtual community are to be purchased. Therefore, at block 236, trades or purchases are conducted for the selected goods/services made available within the virtual community. In one feature of the invention, the trade or purchase is conducted in a consumer initiated action in which the consumer identifies goods/services to be purchased, and then executes the appropriate actions on the consumer's input device to signify that a purchase is being made. In another feature of the invention, it is contemplated that once a consumer has joined a virtual marketplace community, the consumer could be provided triggering options for purchase of goods or services offered within the community. For example, the consumer could provide authorization for automatic purchase of goods or services made available within the community if the goods/services were within a predetermined price range. Accordingly, if a vendor made available the desired goods/services within the community, the purchase would automatically be made in which the consumer's payment information is made available to an administrator for executing the purchase. The consumer would be notified of the automatic purchase.

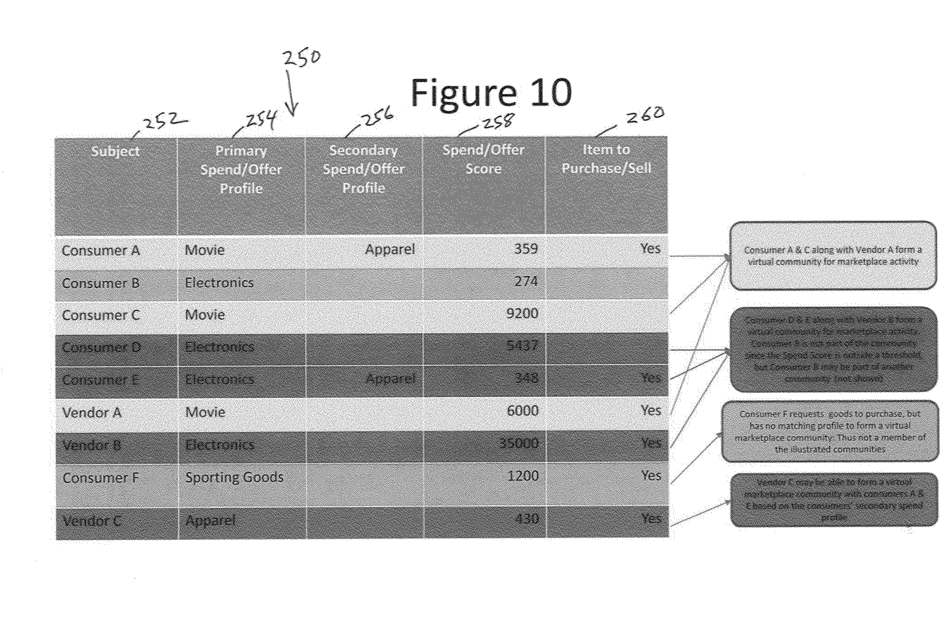

Referring to FIG. 10, a table 250 is illustrated showing an example group of consumers and vendors, and how the example group may be combined with one another to form one or more virtual marketplace communities. The information listed in the table includes the identity of the subject 252, either a consumer or vendor, the primary spend and vendor profiles 254, the secondary spend or vendor profiles 256, the spend or vendor scores 258, and whether the party has an item or service to sell 260. In the example of FIG. 10, consumers A and C, along with vendor A can be invited to form a virtual community for marketplace activity for the purchase and sale of movies. Each of the consumers have primary profiles indicating a desire for movie purchases, along with corresponding spend scores of a sufficient magnitude warranting the consumers being capable of participating within the community. Vendor A has a sufficiently high vendor profile such that is likely the vendor can adequately meet the needs of the consumer seeking purchase of movies. Another virtual community that could be formed with the data shown in FIG. 10 is an electronics community, formed by consumers D and E, and vendor B. However, it is noted that consumer B is not part of the community since the spend score for consumer B is presumably not within the designated threshold. For example, the designated threshold for matches between the consumers and vendors to participate in the electronics community could require that the consumers have a minimum spend/vendor score of 300. Accordingly, consumer B would not qualify; however, consumer B could be part of another community to be formed that would allow joining with a lower spend score. For consumer F, this person has a profile for purchase of sporting goods; however, there are no available vendors for this spend category. Therefore, consumer F is not made part of any virtual marketplace community. Vendor C may be able to form a virtual marketplace community with consumers A and B based upon these consumers' secondary spend profiles for apparel.

From a review of FIG. 10, it is apparent that the spend profiles and spend scores facilitate natural connections between consumers and vendors, and therefore may enhance and accelerate commerce activities for purchases of goods and services. Therefore, it is apparent that the designation of spend profiles based upon spend scores and underlying spend categories can be very valuable in creating virtual marketplace communities and to enhance overall commerce between consumers and vendors.

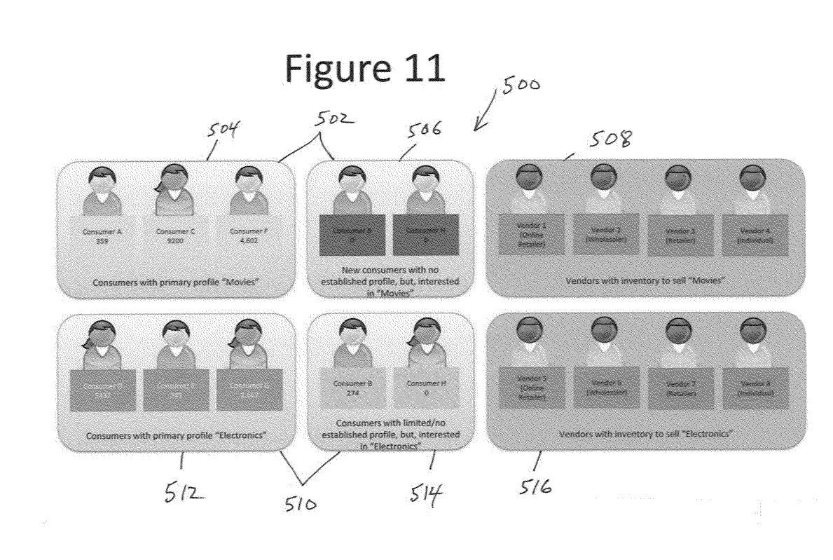

FIG. 11 is a schematic diagram illustrating two example virtual marketplace communities formed including groups of consumers and vendors. More specifically, FIG. 11 shows a schematic diagram 500 and two groups of consumers within respective virtual marketplaces. The first group 502 comprises existing consumers 504 having a primary spend profile under a “movie” category. The first group 502 also includes a group of new consumers 506 with no established profile, but are identified as wishing to participate in the group 502 for purposes of exploring commerce in the movie category. A corresponding group of vendors 508 are available to the consumers for purposes of providing goods within the movie category. The vendors 508 comprise different types of vendors to include wholesalers, retailers, and individuals who could be consumers from other groups or consumers within the group 502.

FIG. 11 also illustrates another group of consumers 510 under a different spend profile, namely, an “electronics” category. Like group 502, group 510 includes both existing consumers 512 and new consumers 514. A group of corresponding vendors 516 for the electronics category is provided, and these vendors also comprise different types of vendors to include wholesalers, retailers, and individuals who could be consumers from other groups or consumers within the group 510. Each of the virtual marketplace communities may have their own webpage available to the consumers and vendors to conduct commerce. The web pages are organized to show the identity of the vendors in terms of the particular products or services that are to be made available to the consumers. Preferably, the identities of the consumers are kept confidential, as well as the consumers who may also act as consumer-vendors for sale of used or second hand goods. The web pages can be organized in a particular matter that best enables secure yet simple electronic communications between the vendors and consumers. In this respect, the particular web pages may be similar to web pages for existing online vendors who routinely sell goods/services.

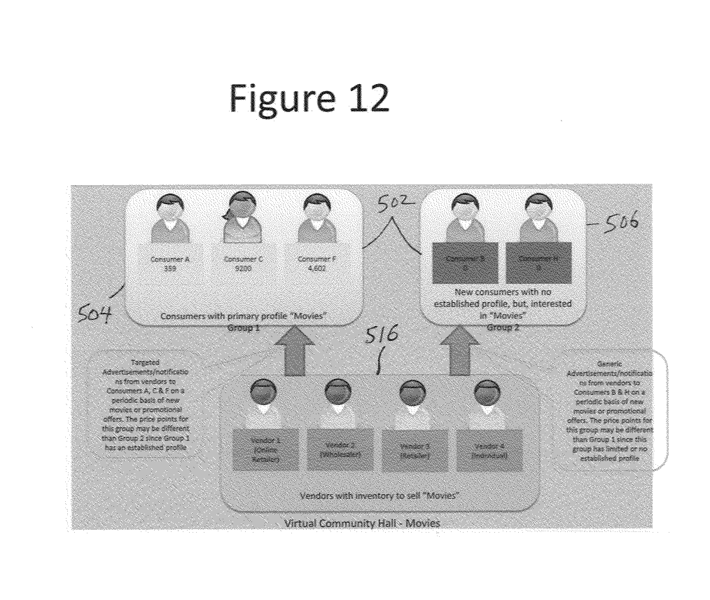

FIG. 12 is another schematic diagram illustrating one of the virtual marketplace communities of FIG. 11, in which notifications are sent by vendors to the consumers regarding offers to sell goods for a particular spend category. More specifically, FIG. 12 illustrates the example movie virtual community in which the vendors provide advertisements and/or notifications to the consumers for purposes of marketing products within the movie category. One example of an advertisement or notification that could be sent from the vendors includes periodic notifications sent to the consumers regarding new movies or promotional offers. For the group 504, since this is an existing group of consumers within the movie category, the price points for goods offered to these consumers may be different from the new consumers of group 506. One presumption that could be made is that, since group 504 are consumers with spend profiles that are specifically within the movie category, vendors may be more willing to have higher price points in terms of the types and quantities of goods offered to this group in order to maximize sales. On the other hand, for advertisements or notification sent to the new group of consumers 506, the vendors may wish to take a more conservative approach to build trust and interest in the new group of consumers by offering less expensive goods or goods with higher promotional values in order to spurn the interest of these consumers into developing spend profiles that fit within the movie category. Therefore, FIG. 12 is intended to represent the flexibility of the virtual community transactions that may take place in terms of specifically tailoring goods/services offered to different types of consumers that may exist within the virtual community.

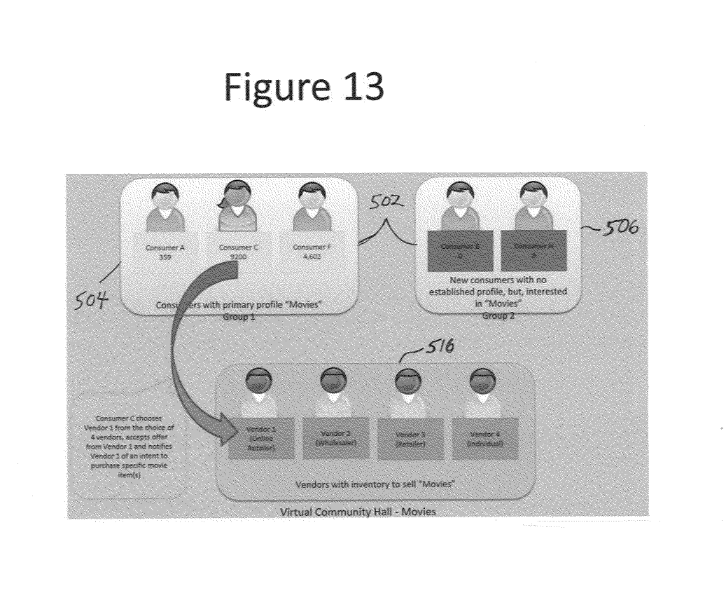

FIG. 13 is another schematic diagram illustrating consumers selecting vendors to purchase goods within the virtual marketplace community of FIG. 12. As shown in this figure, Consumer C chooses Vendor 1 from the choice of four vendors, accepts the offer from the Vendor 1 and notifies Vendor 1 of the intent to purchase specific movie item(s). The means of communication for the selection of Vendor 1 and the intent to purchase can be done electronically in which the consumer clicks on a selection within the menu of choices provided by the vendor. Alternatively, the consumer may wish to obtain additional information regarding the purchase; therefore, there could be more personal dialogue between the consumer and vendor, such as by exchanging e-mails, telephone conversations, or combinations thereof. Because Consumer C is already prequalified in terms of having a validated spend profile, the vendor can be assured that the consumer has the capability and credentials to purchase the specific goods from the vendor.

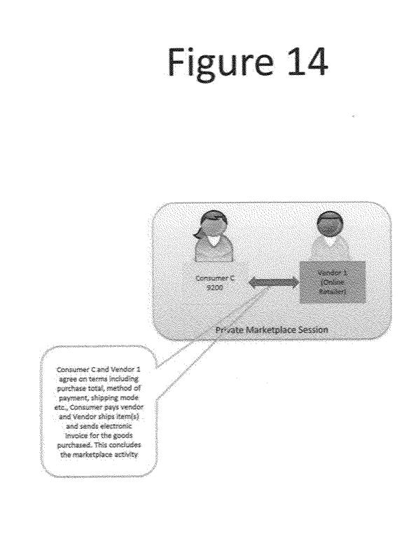

FIG. 14 is another schematic diagram illustrating a particular transaction that takes place between a consumer and vendor within the virtual marketplace community of FIG. 12. More specifically, FIG. 14 illustrates the commercial transaction between Consumer C and Vendor 1 in which the actual transaction that takes place between the consumer and vendor can be within a private, secure commercial transaction to conclude the marketplace community. In this action between the consumer and vendor, they agree upon terms, including a purchase total, method of payment, mode of shipping the goods, etc. The consumer ultimately tenders payment to the vendor, such as by an electronic credit card transaction, and the vendor then ships the item(s) to the consumer, and also provides an invoice for the goods purchased. Preferably, an electronic invoice is provided to the consumer nearly instantaneous with the online transaction. The payment may take place over a secure server of the vendor, or a third-party payment service could be used such as Paypal®.

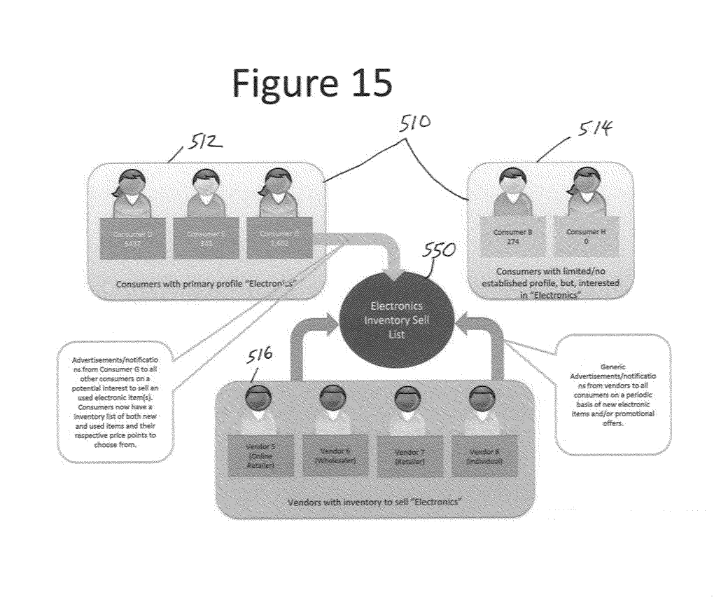

FIG. 15 is a schematic diagram illustrating the electronics virtual marketplace community, including consumers also acting as consumer-vendors with respect to offering used goods, and the use of a combined electronic inventory sell list 550 that includes products available through traditional vendors, and consumer-vendors. In this figure, the electronics virtual community is illustrated with respect to use of the combined electronics inventory sell list 550, in which Consumer G also acts as a vendor to offer used electronic goods. Consumer G and the vendors provide information to generate the list 550, which includes a combined list of items that are offered for sale within the electronics community. It can be assumed that with the addition of the Consumer G as a vendor, an expanded list of goods are offered for both new and used items that provide a wider range of price points for the consumers to choose from. The combined functionality provided in this example may further enhance not only the buying experience for the consumers, but may also provide a greater incentive for the vendors 516 to provide even better prices, or promotional offers. For example, if Consumer G is providing high-quality used goods at reasonable prices, this may provide pressure against the vendors 516 to lower their prices in order to compete with the Consumer G. The vendors are likely to provide perhaps better pricing, knowing that the very targeted group of consumers within the community 510 still provide a better rate of return as compared to a random group of consumers, or even other known groups of consumers who could be potential purchasers, but have no true supporting background data as compared to the validated spend profiles of each of the members 512.

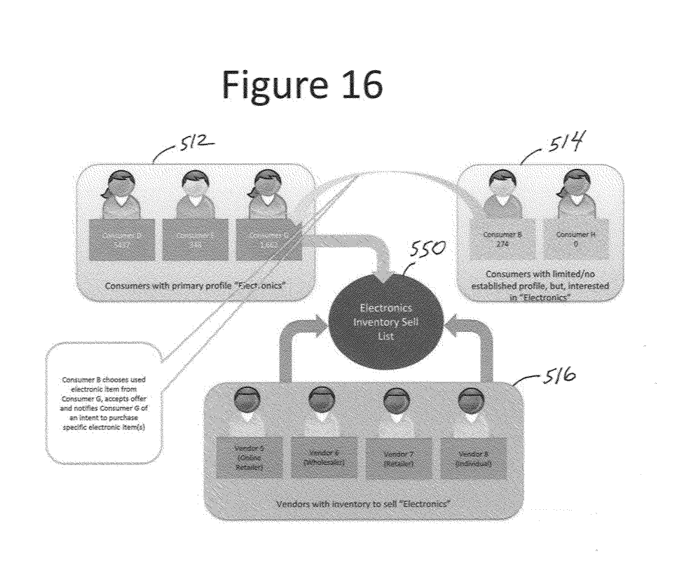

FIG. 16 is a schematic diagram illustrating the virtual marketplace community of FIG. 15 in which a consumer chooses to purchase goods from another consumer-vendor. More specifically, as shown, Consumer B from group 514 makes a choice to purchase an electronics item from the Consumer G, and accept the offer from Consumer G, along with confirmation that there is an intent to purchase the specific electronic item.

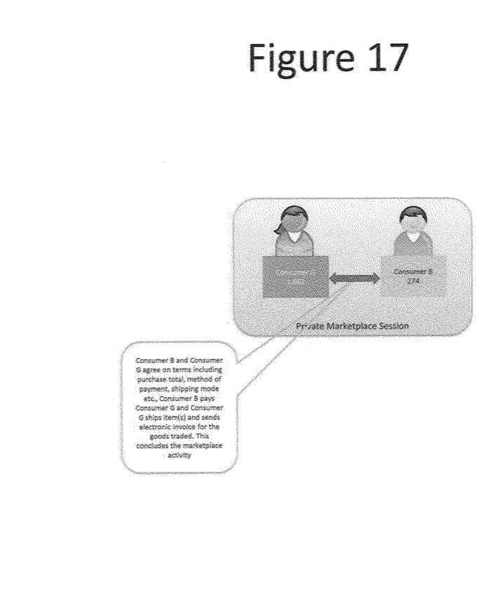

FIG. 17 is another schematic diagram illustrating the particular transaction that takes place between the Consumer B and the consumer-vendor, Consumer G, within the virtual marketplace community of FIG. 15. More specifically, FIG. 17 illustrates the private commercial transaction that takes place to conclude the marketplace activity between Consumer G and Consumer B. These consumers agree on terms including the purchase total, method of payment, shipping mode, etc. Consumer B tenders payment to Consumer G and consumer G then ships the item(s) and provides an electronic receipt/invoice for the item(s) traded. Therefore, FIG. 17 is similar to what is illustrated in FIG. 14 in terms of concluding a marketplace activity, the only difference being that the Consumer G acts as a consumer-vendor for sale of goods.

From a review of the examples provided in FIGS. 11-17, one can appreciate the capability of virtual communities or groups to provide goods and services to targeted groups of consumers with a high likelihood that vendors participating within the community/groups will be rewarded with a high rate of return in terms of the sales concluded. The ability to easily sell goods/services online to a fluid group of consumers enhances the chances that an increased intensity of commerce can be conducted. That is, because of the continually evaluated characteristics of consumers to be placed within spend categories corresponding to their spend profiles, each virtual marketplace community is up to date and current in terms of active consumers seeking goods/services within the particular community. Contrast this virtual community to what could be termed traditional stale purchasing environments in which vendors are not provided accurate, current information regarding the true purchasing status or state of a group of consumers, yet the vendors continue to send targeted marketing efforts towards unlikely purchasing consumers. One example of a stale purchasing environment could include a group of consumers who, for whatever specific economic reason that may exist at the time, the group of consumers simply do not continue to purchase a high enough volume of goods within a particular category that makes marketing efforts profitable to vendors. Without the continued evaluation of consumer spend profiles, a vendor has no true means of discerning whether a group of consumers are actually viable candidates for future purchases, understanding that all consumers change spending habits over time. Therefore, one significant advantage of the present invention is that the virtual communities formed are active groups of consumers, and not stale groups of consumers who have may have shifted their spending habits without knowledge made available to the vendors.

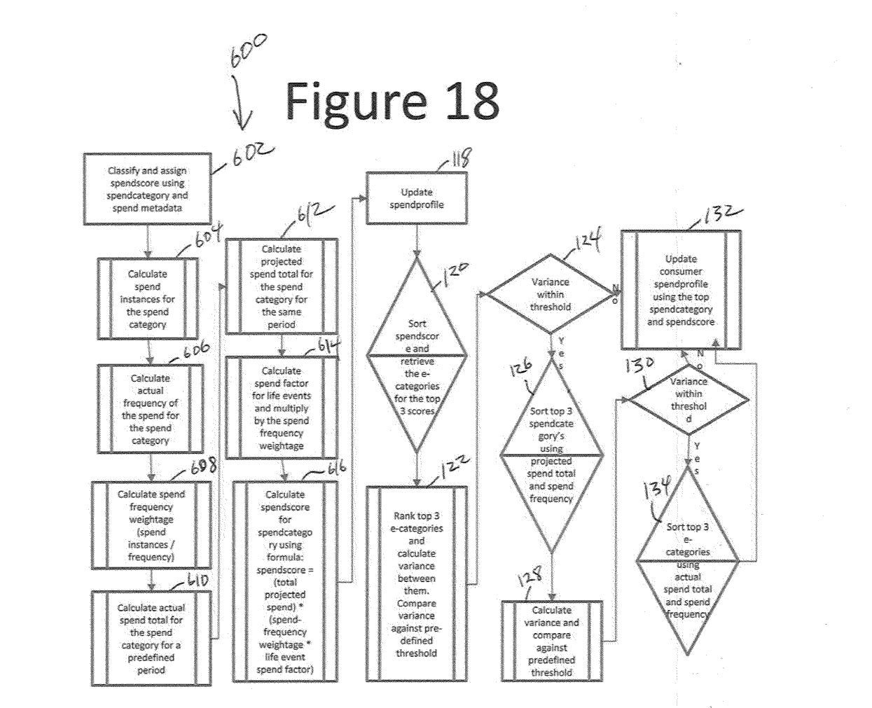

FIG. 18 is a schematic flow diagram illustrating functionality in a second embodiment associated with determining spend scores using the predetermined spend categories. Flow chart 600 includes block 602 reciting the purpose for the embodiment of FIG. 18 that is to classify and assign spend scores using predefined spend categories and spend metadata, similar to block 102 of FIG. 5, but with changes as set forth in the flowchart 600.

At block 604, a first step is to calculate or determine the number of spend instances for a spend category. A spend instance is the occurrence of a discrete spending transaction by the consumer within a particular spend category. A spend instance can be determined by the evaluating spend metadata or by other data that is gathered that indicates the consumer executed a spend transaction in the defined category. Therefore, a spend instance is not determined by the value of a particular spending occurrence, but simply the number of different spending transactions conducted by the consumer within the evaluated spend category.

At block 606, a calculation is made for the actual frequency of the spend occurrences or instances for the designated spend category. The frequency is therefore defined in terms of a timeframe being evaluated, such as a three or six month period. For example, if a particular consumer executed nine spending transactions within a six-month period, the frequency could be expressed as 1.5 spending actions per month. One important consideration in determining the actual frequency of the spend occurrences is to evaluate an appropriate time in which actual frequency should be determined. For example, some staple goods such as household cleaning articles or toiletries are purchased on a fairly consistent, monthly basis. Therefore, actual frequency of spend occurrences might be evaluated over a three month period. However, for items such as sporting equipment, a consumer may purchase these type of goods on a more infrequent basis and therefore, the timeframe to be evaluated should be extended such that the actual frequency takes into account a full spending cycle for the consumer. A spending cycle can be defined as a recurring group of purchasing events that occur over a particular timeframe that may be unique to each individual consumer, and that may be estimated by evaluating a purchasing history of the consumer over a relatively long period of time in which recurring spending activities can be identified and therefore, a spending cycle can be determined. In the example of the sporting equipment, consumer may purchase these goods on more of an annual basis as opposed to a monthly basis; therefore, the term used for the spend occurrences may be an entire year as opposed to a one-month basis.

At block 608, a spend frequency weightage is calculated which equals the number of spend instances divided by the actual frequency of the spending activities per period evaluated.

At block 610, the actual value of the spend total for the spend category is calculated for the predefined period. In other words, the numeric value of the total amount of purchases or spends is calculated by adding the value of each of the purchases for the predefined period.

At block 612, a projected spend total is estimated for the spend category for a predefined period. More specifically, the projected spend total is an independent estimate for each consumer as to the amount of spending that will occur within a particular time frame for purposes of determining the value of an exchange pod with a defined duration, and in which the consumer will be a member of the cohort. The defined the duration of the exchange pod may differ from the time period evaluated for determining the spend frequency. For example, the time period evaluated for determining the spend frequency for sporting equipment for a particular consumer as mentioned may be a one-year period, while the proposed exchange pod may be a 90 day period. The projected spend total for the 90 day period must therefore be evaluated in terms of the amount of spending that the consumer has already conducted within the year to determine the likelihood and amount of spending that the consumer may conduct in the 90 day period used to define the term of the exchange pod. If the consumer has already made all of the purchases for the year, that is, all of the spend instances have occurred and there is still three months remaining within the time period used for determining the actual frequency of the spend, then it may be anticipated that this particular consumer will not spend any additional funds within the next three months and therefore, the projected spend could be $0. On the other hand, if the consumer has only conducted a few purchases and a great number of purchases remain to be made within the time period used for determining the actual frequency of the spend, then the projected spend for the remaining three months of the year may be a numerical value that is relatively high as compared to the total amount of purchases that could be expected to be made within the year period. Therefore, the projected spend is a an estimate of the value of purchases that may be conducted by the consumer within the time period or term to be offered within an exchange pod with a consideration of the amount of purchases the consumer has already made considering the number of purchases made within the consumer's predefined spending cycle.

At block 614, a life event spend factor determined and is multiplied by the spend frequency weightage. This product can be referred to as a life factored spend frequency weightage. The life event spend factor is a consideration of events that may be occurring in a consumer's life that will affect the consumer's spending habits. The data or information to support a determination of the life event spend factor can be obtained from a number of sources, to include voluntary information provided by each consumer. One form of data that can be developed for each consumer is to evaluate the type of purchases that are made, the brands of purchases, the frequency of purchases, and changes between different classifications of goods and services. A life event such as a person losing a job could be deduced from a drastic drop in the amount of funds spent on leisure activities and/or nonessential goods. A life event such as the birth of a child could be deduced from a sudden increase in the sustained the purchase of infant products. To the extent some identifiable change in a consumers spending habits can be identified, this could be associated with a particular life event, and therefore, a spend factor can be attributed to this life event and added to the spend frequency weightage in order to provide a more accurate spend frequency weightage. An evaluation of life factors is preferably an ongoing process in which historical data for a consumer is continually evaluated to determine adapting and changing spending habits which inherently occur over the lifetime of a consumer. The numerical value for the spend factor can be a value greater than 1 for a spend factor indicating a life event that may result in greater expenditures by the consumer, while a value less than 1 may be used as the spend factor indicating a life event resulting in fewer expenditures by the consumer. For example, assume a consumer voluntarily provides information regarding an increase in wages, or the evaluated spending trends of the consumer show an increase in spending across many different categories of goods and services. In this case, a life event spend factor could be 1.3 corresponding to the perceived amount of increase in wages of the consumer and/or the perceived willingness of the consumer to spend more in many categories. In another example, assume a consumer discloses a hardship in which there is a decrease in earned wages and/or the evaluated spending trends of the consumer show a decrease in spending across many different categories of goods and services. In this case, a life event spend factor could be set at 0.80 corresponding to the perceived amount of decrease in wages of the consumer and/or the perceived unwillingness of the consumer to spend as much as before in many categories. In any event, a factor approach in determining a projected spend provides a more detailed and accurate prediction regarding the projected spend of a particular consumer.

At block 616, the spend score can now be calculated for the evaluated spend category. The spend score in this embodiment is calculated by multiplying the total projected spend by the product of the spend frequency weightage and life event spend factor. Using this calculated spend score, a consumer's spend profile can be updated at block 118.

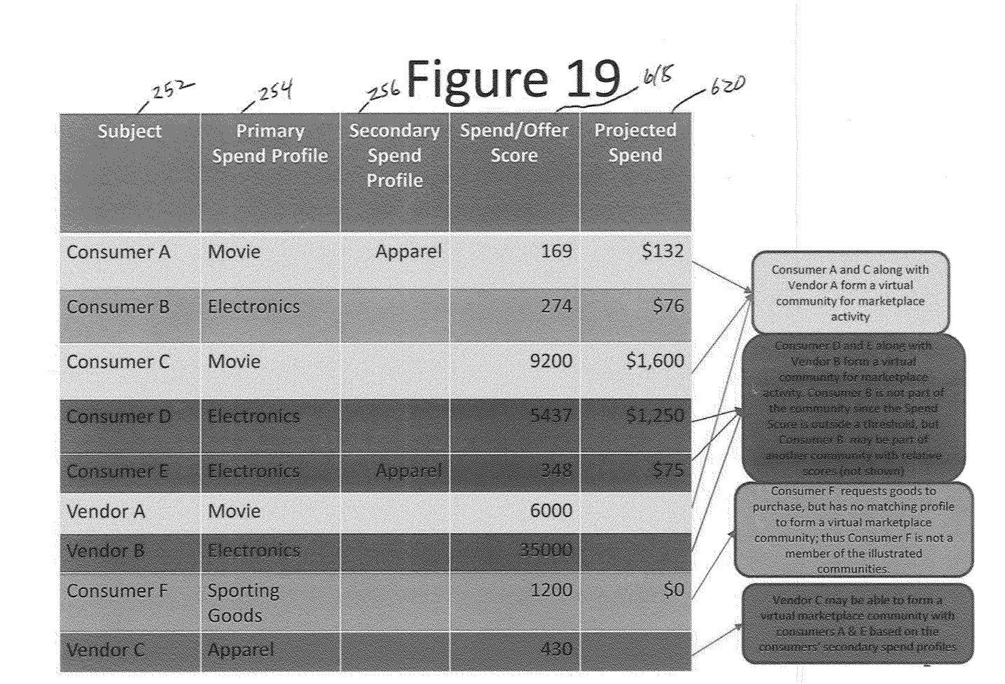

The remaining steps illustrated in FIG. 18 correspond to the same steps identified in FIG. 5, and these remaining steps are used to determine the consumer's spend profile by executing the steps 120-134 as shown and also described above with reference to FIG. 5. FIG. 19 is a table of information illustrating an example group of consumers and vendors, and how the example group may be combined with one another to form virtual marketplace communities according to second embodiment of FIG. 18. FIG. 19 more particularly shows a table with the same example group of consumers and vendors of FIG. 10; however, the table of FIG. 19 is updated with the spend/offer scores 618 calculated in accordance with the revised spend score formula set forth in the embodiment of FIG. 18. Specifically, FIG. 19 illustrates a situation in which the revised spend/offer scores 618 only affected consumer A, and in which the particular spend/offer score for consumer A changed from 359 to 169. FIG. 19 also shows a column for the projected spend 620 for each of the consumers as determined from block 612 in the flowchart of FIG. 18. FIG. 19 also provides additional observations corresponding to the grouping of the listed consumers and vendors, similar to FIG. 10. These observations include: (i) Consumer A and C along with Vendor A form a virtual community for marketplace activity; (ii) Consumer D and E along with Vendor B form a virtual community for marketplace activity; (iii) Consumer B is not part of the community since the spend score is outside a threshold, but Consumer B may be part of another community with relative scores; (iv) Consumer F requests goods to purchase, but has no matching profile to form a virtual marketplace community, thus Consumer F is not a member of the illustrated communities; and (v) Vendor C may be able to form a virtual marketplace community with consumers A and E based on these consumers' secondary spend profiles.

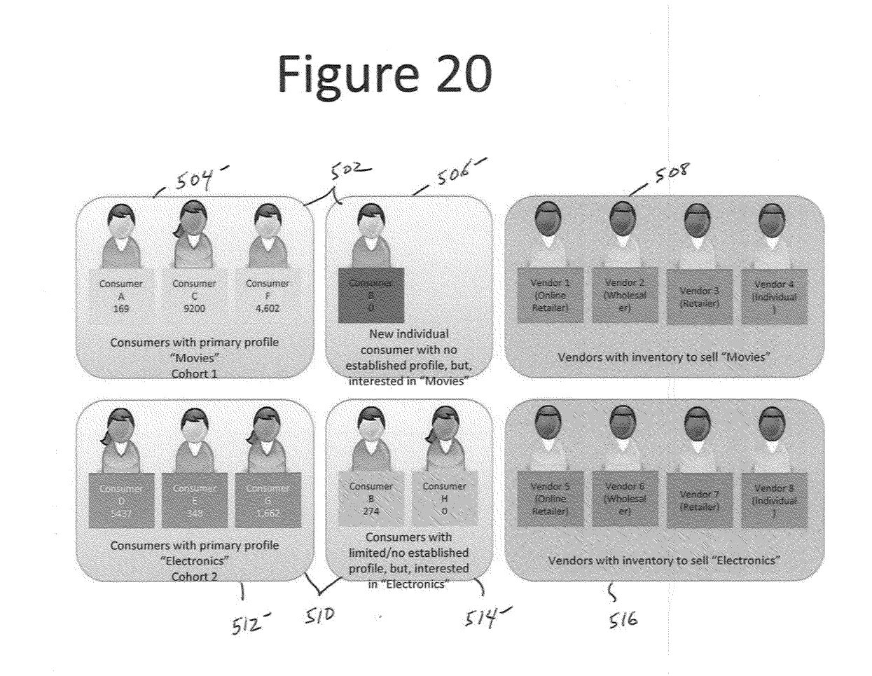

FIG. 20 is a schematic diagram illustrating two example virtual marketplace communities formed including groups of consumers and vendors similar to FIG. 11, but some of the consumer groups are formed as cohorts. More specifically, FIG. 20 shows that the groups of consumers with the established profiles are grouped into cohort groups. The group of consumers 504′ with “Movie” primary profiles are assigned to Cohort 1, and the group of consumers 512′ with “Electronic” primary profiles are assigned to Cohort 2. The other consumers with no established profiles or limited profiles (i.e. those profiles that have some recorded data but do not yet qualify for being assigned a profile) remain as individual consumers who are not placed within a cohort. Group 506′ shows one new individual member without an established profile, but interested in the “Movies” category. Group 514′ shows two consumers without established profiles, but interested in the “Electronics” category. FIG. 20 also shows two groups of vendors: group 508 with vendors with inventory to sell Movies, and group 516 with vendors to sell Electronics.

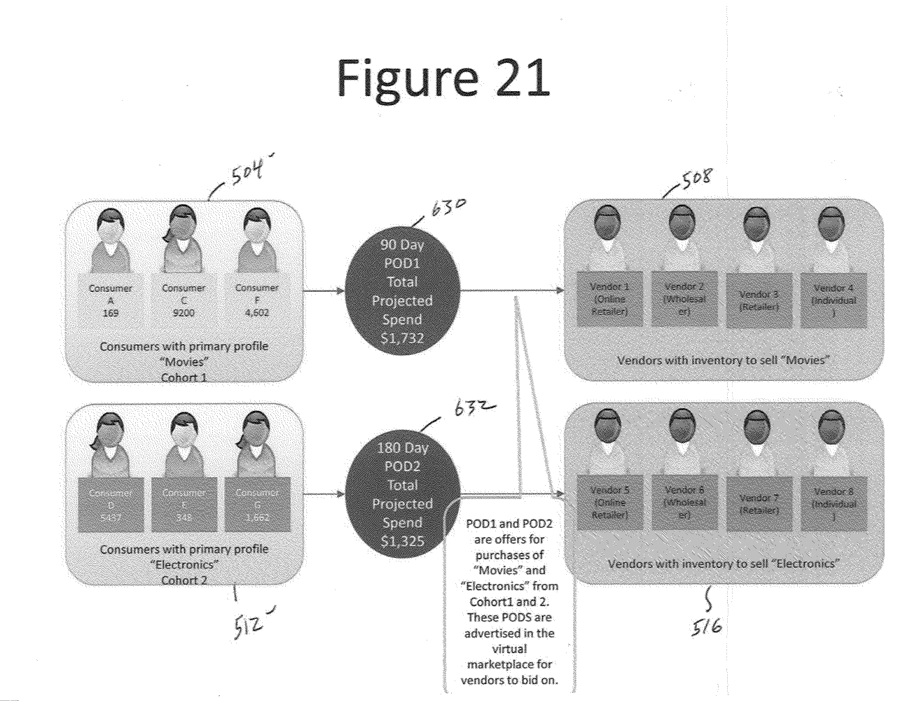

FIG. 21 is another schematic diagram illustrating one of the virtual marketplace communities of FIG. 20, in which the two groups of consumers arranged in Cohorts 1 and 2 have created and offered exchange pods for vendors to bid on within the virtual marketplace community. As shown, the group of consumers 504′ combined to form Cohort 1 with the primary profile of “movies” created the exchange pod 630. This exchange pod 630 is a 90 day duration offer for a total projected spend of $1732. This exchange pod 630 is offered to the group of vendors 508 having the inventory to sell movies to the Cohort 1. The group of consumers 512 combined to form Cohort 2 with the primary profile of “electronics” created the exchange pod 632. This exchange pod 632 is a 180 day duration offer for a total projected spend of $1325. This exchange pod 632 is offered to the group of vendors 516 having the inventory to sell electronics to the Cohort 2. The total projected spend for each exchange pod 630 and 632 correspond to the combined projected spends for each of the consumers making up the corresponding cohort. Accordingly, for the exchange pod 630, the total projected spend is the sum of the projected spend for consumers A, consumer C, and consumer F ($132+$1600+$0). The combination of these three consumers to form the Cohort 1 can be viewed as providing advantages to each of the consumers, albeit because of the predicted differences between the projected spends for each of the consumers, one of the consumers may benefit more than others within the cohort. For example, consumer C has the projected spend of $1600 which comprises the significantly highest percentage of projected spends in evaluating the cohort group as a whole. Consumer C could consider simply offering his/her own individual exchange pod within the virtual marketplace since the other consumers within the cohort do not significantly add to the total projected spend, which presumably will not encourage vendors to significantly distinguish between the exchange pod 630 valued at $1732 as compared to an individual exchange pod for consumer C valued at $1600. However, consumers A and F may provide a more predictable performance in terms of purchasing movies within the 90 day term of the pod 630. That is, although consumer C may have a much higher projected spend than the other consumers within the cohort, consumers A and F may be encouraged to purchase more movies because of the leveraged buying power provided by consumer C with the higher projected spend. In this way, consumers A and F may purchase more movies than they normally would have because of the higher discount offered by one of the vendors. Accordingly, consumers A and F may likely spend more on movies than their projected spend, which inherently reduces buying pressure on consumer C to perform to the projected $1600 spend within the 90 day period. FIG. 21 also illustrates the exchange pod 632 having a 180 day term for the electronics category in which consumers D, E, and G are the consumers making up the Cohort 2. As with Cohort 1, there may be a significant disparity between the projected spends for members of the cohort. In the case of Cohort 2, consumer B has a much higher projected spend than the others within the cohort; however, each of the members may benefit from the cohort arrangement. Referring also to FIG. 19, it is noted with respect to Cohort 2 that consumer B is not a member of this cohort. One reason could be that the spend score for consumer B is lower than the required threshold, although the projected spend for that consumer is actually higher than consumers D and G. Therefore in the case of Cohort 2, the eligibility requirements for this cohort are more a function of a consumer's spend score as opposed to the projected spend of the consumer.

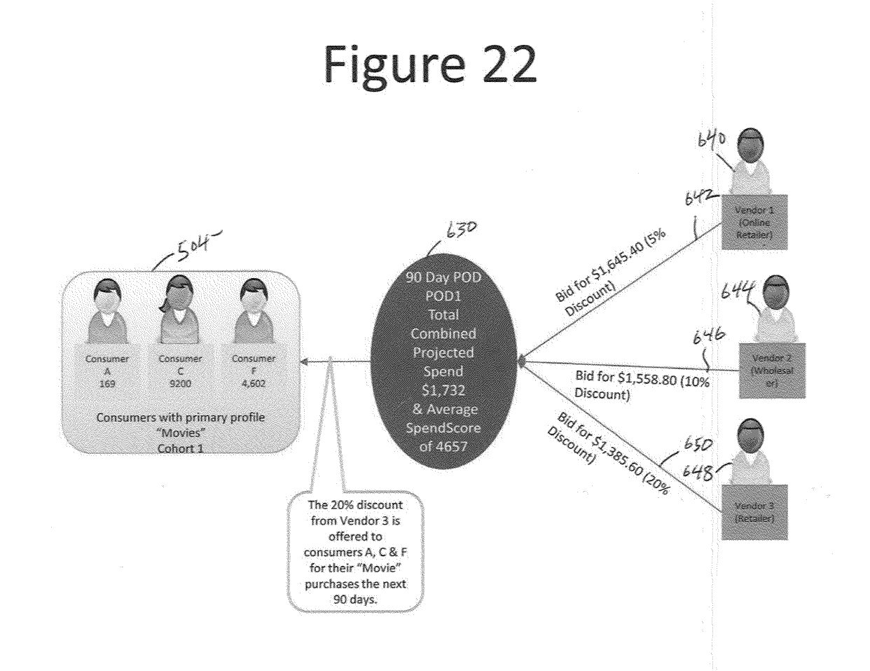

FIG. 22 is another schematic diagram illustrating one of the exchange pods of FIG. 21 offered by the corresponding cohort, and bids being placed on the exchange pod by vendors who are interested in accepting the offered the exchange pod. More particularly, FIG. 22 illustrates the exchange pod 630 in which vendors 640, 644, and 648 (Vendor 1, Vendor 2, and Vendor 3) have each submitted bids for acceptance of the exchange pod 630. Vendor 640 makes a bid 642 for $1645.40 which is a 5% discount, vendor 644 makes a bid 646 for $1558.80 which corresponds to a 10% discount, and vendor 648 makes a bid for $1385.60 which corresponds to a 20% discount. Depending upon the conditions that a cohort may establish for receiving bids from the vendors, or rules set forth by the system administrator, the bids made by the vendors may be posted for viewing by all to create a competitive bidding environment that may result in better discounts offered. In any event, once the bidding is complete, the consumers will presumably accept the bid from the vendor that provides the most favorable discount, which in the case of FIG. 22 is the 20% discount from vendor 648.

With respect to executing commercial transactions in accordance with the agreement between the consumers of Cohort 1 and the vendor 648, there is an expectation that within the 90 day period, the consumers will purchase at least $1732 of movies that are discounted at 20% for each purchase. In the event the combined purchases of the group exceed the $1732 pod value, the vendor is expected to honor a 20% discount for purchases within the 90 day period that exceed the $1732 pod value. In this way, consumers may be further encouraged to spend more within the 90 day period, which presumably benefits both the consumer and vendor. Although the consumers are collectively making a commitment within the cohort to purchase a combined total of $1732 of goods, there are certainly circumstances in which the cohort will not perform to the expected purchasing amount for various reasons. Preferably, consumers are not punished by not performing to the expected standard of the posted exchange pod. That is, the consumers will not suffer penalties or loss of discounts for purchases made. However, a potential effect in the future may be that a vendor who chose to bid on an exchange pod may be less enthusiastic about bidding on future exchange pods if consumers consistently underperform with respect to amounts of actual purchases as compared to projected purchases set forth in the projected total spends of the exchange pods. FIG. 22 also shows the spend score for Cohort 1 (4657) which is simply the average spend score for the group of consumers making up the Cohort 1. In lieu of an average spend score, the pod could be presented with a combined spend score which is simply the numerical sum of the spend scores for all of the members of the cohort.

Therefore, the value of the exchange pod 630 may be alternatively set forth as the spend score for the cohort creating the exchange pod, or a combination of both the projected spend and spend score for the cohort. Vendors may wish to evaluate the value of the exchange pod not just upon the projected spend, but alternatively or in combination with the cohort spend score, and this additional data may provide more predictable measures of how the consumers within the cohort will perform. For example, a vendor may wish to rank order exchange pods in the virtual marketplace considering the cohort spend scores as a more reliable indication of how the consumers will perform, with the rationale that those cohorts with higher spend scores will perform better over time as compared to those cohorts with lower spend scores. In any event, it can be seen that the use of exchange pods within the virtual marketplace provides incentives for both vendors and consumers to increase the level of commerce since the virtual marketplace provides great flexibility for both vendors and consumers to present their proposals.

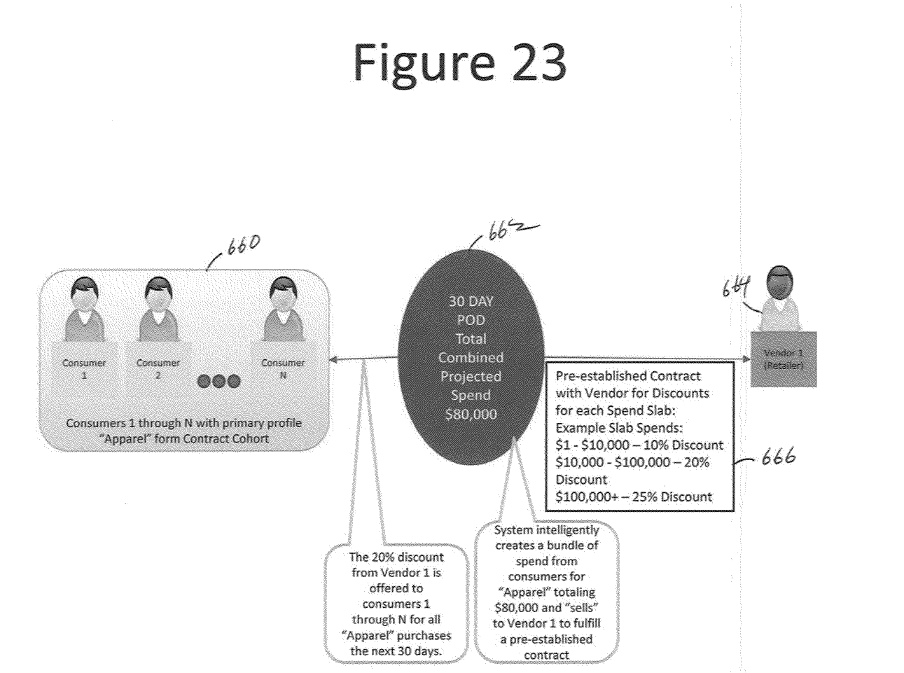

FIG. 23 is another schematic diagram illustrating an exchange pod within a virtual marketplace community; however, the exchange pod is created by a pre-existing contract with one or more vendors in which qualifying consumers are selected to participate within a contract cohort established to enable commerce to be conducted in accordance with the terms of the exchange pod created. In this example, a group of consumers 660 are combined to form a contract cohort in which the consumers have a primary profile of “apparel”. An exchange pod 662 is offered by the contract cohort in which the projected spend for the contract cohort within a 30 day time period/term. Alternatively, the exchange pod 662 could be automatically generated by the system in which the system observes a number of presently participating consumers who could form the contract cohort at the level of the projected spend. In this instance, consumers could be individually contacted by a communication/email from the system administrator in which the consumers are offered the opportunity to participate in the contract cohort. The consumers who accept the offer to participate in the contract cohort are then established as members of the contract cohort for purposes of executing the pre-established contract with the selected vendor(s). The terms of the pre-established contract are shown in block 666 of FIG. 23 in which vendor 664 (Vendor 1) has promised to offer discounts for the 30 day term of the exchange pod 662. As shown, the particular contract illustrated requires the vendor to offer percentage discounts at different levels or “slabs” of spending amounts; a 10% discount for combined purchases up to $10,000, a 20% discount for combined purchases between $10,000-$100,000, and a 25% discount for combined purchases above $100,000. The projected spend for the exchange pod 662 is $80,000; therefore, the vendor 664 is obligated to provide the 20% discount.

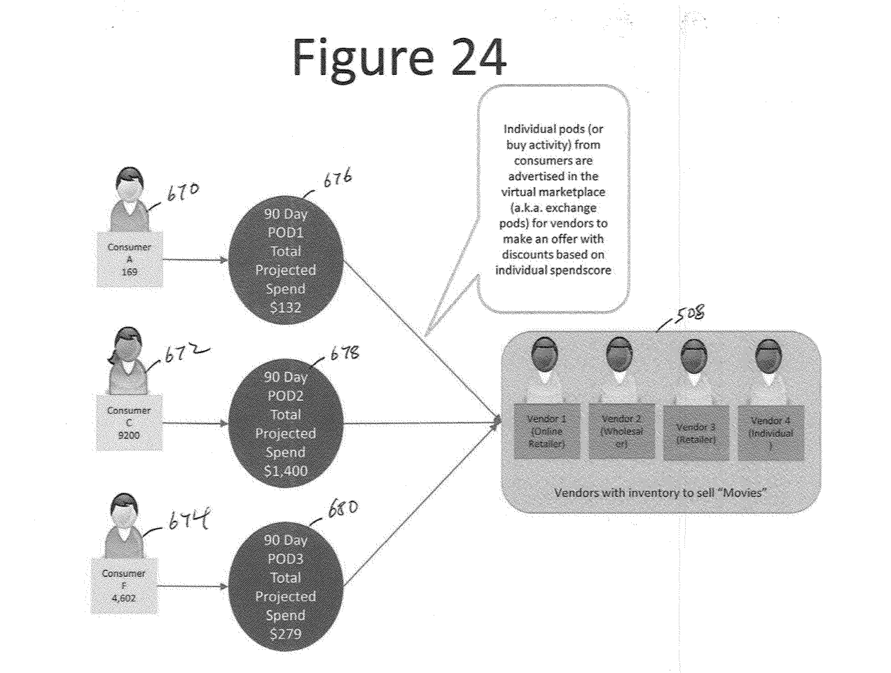

FIG. 24 is another schematic diagram illustrating a virtual marketplace community similar to FIG. 21; however instead of cohorts, individual consumers have created and offered their own respective exchange pods for vendors to bid on within the virtual marketplace community. Consumer 670 (consumer A) creates an exchange pod 676, having a 90 day term and valued at a projected spend of $132. Consumer 672 (consumer C) creates an exchange pod 678, having a 90 day term and valued at a projected spend of $1400. Consumer 674 (consumer F) creates an exchange pod 680, having a 90 day term and valued at a projected spend of $279.

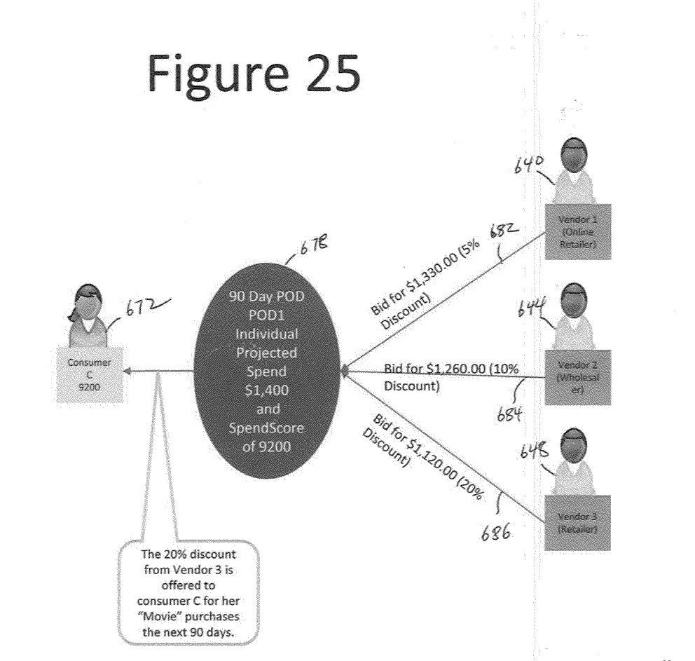

FIG. 25 is another schematic diagram illustrating one of the exchange pods of FIG. 24 offered by the corresponding consumer, and bids being placed on the exchange pod by vendors who are interested in accepting the offered exchange pod. More specifically, consumer 672, because of the highest projected spend of $1400 (as compared to the other consumers), is presumably the best candidate at that time for the vendors to make a bid. As shown, vendor 640 makes a bid 682 for $1330, which is a 5% discount; vendor 644 makes a bid 684 for $1260 which is a 10% discount, and vendor 648 makes a bid for $1120 which is a 20% discount. The bid from vendor 648 is the best bit; therefore, consumer 672 is offered the 20% discount for purchases up to the projected spend of $1400. As with the previously described embodiments, the vendor may also be requested to honor the 20% discount for purchases that may go above the $1400 projected spend. FIG. 25 also shows the spend score of the consumer 672, which also happens be the highest spend score among the group of consumers offering exchange pods in FIG. 24. In addition to or in lieu of exchange pods being offered based upon projected spends, consumers may also generate exchange pods based upon their spend scores, and vendors therefore have the option of evaluating the desirability of entering into commerce based upon an evaluation of the projected spends, the spend scores, or combinations thereof.

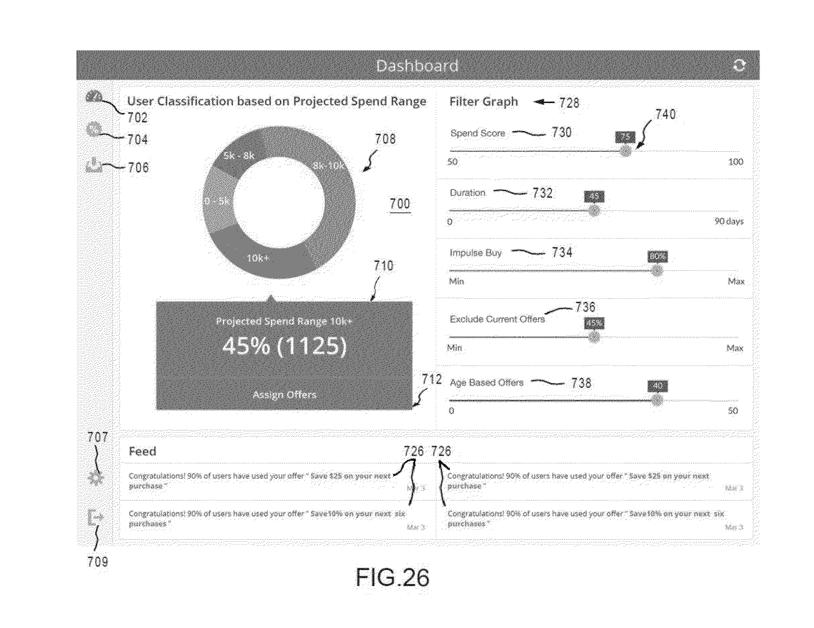

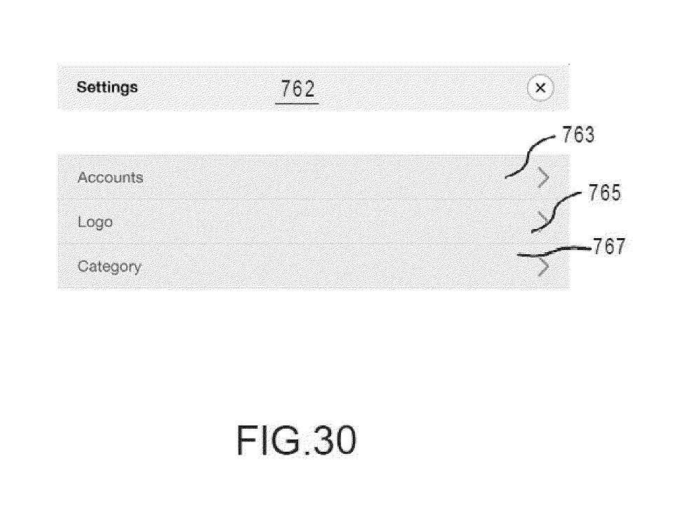

Referring to FIG. 26, a vendor portal or user interface is illustrated showing functionality associated with how a vendor establishes offers to consumers within selected cohort bundles/virtual marketplace communities. A first vendor user interface 700 is shown corresponding to a dashboard function when selected. More specifically, the upper left portion of the user interface shows three navigation links, including a dashboard or control function 702, a percentage status function link 704 for viewing offers generated by the vendor, and an inbox link 706 for viewing electronic communications sent from the system administrator. Additional navigation links are provided at the lower left portion of the user interface, including a settings link 707 and a sign in link 709. The settings link 707 is described below in reference to FIG. 30, which explains particular settings that the vendor may choose from. The sign in link 709 simply provide a link to a sign in screen enabling a vendor to sign into the system with a conventional user/password convention.

The user interface of FIG. 26 provides a classification of users/consumers as measured by projected spending. More specifically, a vendor is provided a display with data concerning those consumers who are matched to the vendor based upon the goods/services the vendor is willing to offer, and a circular graph 708 of the projected spend ranges shows the relative number of consumers and their corresponding projected amounts of spending to take place within the cohort bundle. The vendor may select a group of consumers within the specified ranges shown the graph. In the example of FIG. 26, the vendor selects the group or category of consumers with a projected spend of greater than $10,000, which corresponds to 45% of the total number of consumers within that cohort bundle. Specifically, there are 1125 consumers who fall into that particular category. The percent of consumers and the number of consumers in the greater than $10,000 range are shown in display box 710. After reviewing information associated with this group of consumers, the vendor may wish to generate offers to that group of consumers. Assuming the vendor is satisfied with that classification of consumers and wishes to assign offers, the vendor then selects the assign offers button 712 to assign offers to that selected group of consumers.

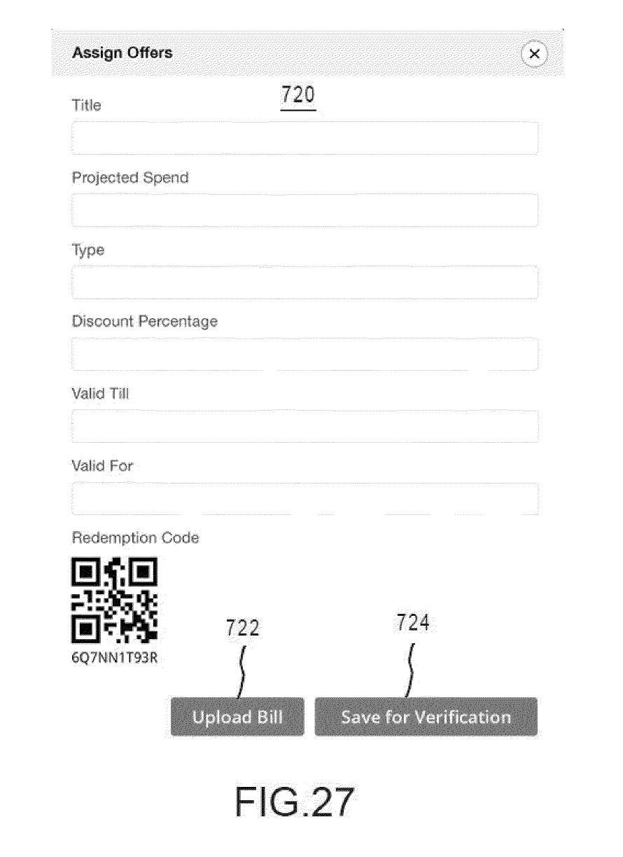

Referring to FIG. 27, selecting this button 712 generates an assign offers screen 720 providing information required to create the offer and have it saved within the system. As shown, the offer may include information such as (i) the title of the offer, (ii) the projected spend category corresponding to the group of consumers associated with a projected spend classification, (iii) the type of offer such as the goods/services to be offered, (iv) the discount percentage associated with the offer, (v) the expiration date of the offer, and (vi) validation information for the specific good/services offered by the vendor which may include certain limitations associated with the offer. A redemption code is automatically generated and assigned to that particular offer so a consumer may use the redemption code to execute a purchase transaction associated with the offer. Two additional functions are illustrated on this interface, namely, a button 722 to upload the offer or “bill” so that the offer/bill can be saved in the system database and offered to the group of consumers within the projected spend category, and a save button 724 to save the offer for later verification/selection. This button 724 may also indicate a validation function in which the offer is first evaluated by the system to confirm that the vendor has the capability to offer the specified goods/services within the projected spend, as qualifying credentials of the vendor may be previously validated by the system.

FIG. 26 shows additional information on this user interface to include a summary for the vendor indicating the number of consumers that have used offers previously created by the vendor. As shown for example, there are four current or active offers 726 listed along with the percentage of users/consumers that used the offer. Each of the active offers 726 is identified by their title as a quick reference for the vendor such as “Save $25 on your next purchase”. A date is also shown as associated with each of the active offers that may indicate the day the offer was first made available.

Yet another feature associated with the user interface of FIG. 26 is a Filter Graph function 728 that allows a vendor to selectively designate filters or parameters for the targeted group of consumers the vendor may wish to make an offer. These parameters or filters include a Spend Score 730, a Duration 732, an Impulse Buy 734, an Exclude Current Offers 736, and an Age-based Offers 738. If the vendor, for example, wishes to evaluate spend scores across a range, the vendor simply moves the slider bar button 740 to the desired spend score range within the depicted range. Information is then calculated to determine the corresponding number and percentage of consumers for that spend score range within the projected spend range of the circular graph 708. The example of FIG. 26 shows a selected spend score range between 50 and 75. This filtered information can be displayed in the display box 710 so that when the vendor selects one of the designated projected spend ranges in the circle graph, the number and percentage is shown that corresponds to the selected spend score range 730. The next parameter or filter shown is Duration 732, which can be a function of the number of days in which the offer is made available to consumers. In the example, a 45 day duration is selected which corresponds to a 45 day time period for the offer. Consumer information is again calculated to estimate the number of consumers who will be available within the 45 day duration of the offer, such as the number of consumers who will maintain active accounts in the system with spend profiles matching the vendor's goods/services. If the vendor wishes to evaluate different offer durations, the vendor simply slides the slider bar button to the desired duration and then reviews the display box 710 to determine the corresponding number/percentages of consumers available for that selected offer duration. The next category shown is Impulse Buy 734. Impulse Buy reflects data recorded in the system in terms of those consumers who periodically make purchases corresponding to some external vendor stimulus, such as the release of a new version or model of a product. For example, the spending history of a consumer may reveal that a consumer has particular brand loyalty for certain groups of products, and the history further shows the consumer will likely make a purchase for one or more goods within the groups within a time period soon after the new version/models are released. This type of spending behavior can be defined as impulse purchases and the data corresponding to this pattern of purchases can be numerically defined and included within the display box 710. The minimum to maximum range indicates a general range within the groups of consumers as to the number of such consumers that may be identified as impulse purchasers. The example shows the vendor selected 80% of such consumers. The next category parameter or filter illustrated is Exclude Current Offers 736. This filter allows a vendor to exclude those consumers who currently have existing and un-used offers from the vendor. A vendor may wish to choose this function, for example, if a vendor believes consumers within a particular cohort may be currently oversaturated with offers from the vendor, and therefore the vendor wishes to find new consumers who have not yet received an offer from the vendor. Again, the vendor may choose to minimize or maximize exclusion of current offers to the particular targeted group of consumers by moving the sliding bar indicator to the approximate position on the scale corresponding to the percentage of offers to be excluded. Maximizing exclusion of current offers would likely reduce the number of consumers available for new offers to be assigned. The next parameter or filter is Aged-based Offers 738. This filter can be used to by the vendor to evaluate potential offers to consumers within a particular age range. The selected age range could correspond, for example, to those consumers who may be more likely to purchase the good/services based upon predetermined ages. Again, the display box 710 would be updated to display information for only those consumers within the selected age range. It should be understood that each of the filters could be selectively disabled or enabled so that the displayed data in display box 710 would reflect only those filters that were selected. For example, the user interface could allow a user to disable or enable each filter by clicking on the corresponding button associated with the slide bar such that a green color indicates enabled and a red color indicates disabled.

As one should appreciate, the filter graph function 728 provides a vendor with great flexibility to specifically target goods/services to be sold by evaluating specific attributes of the targeted consumer groups, and adjusting offers to precisely match a targeted group with numerical data associated with the group. The vendor portal of FIG. 26 provides great functionality for the vendor to generate specifically tailored offers to consumers without the vendor having to conduct separate research or studies normally associated with targeted marketing activities.

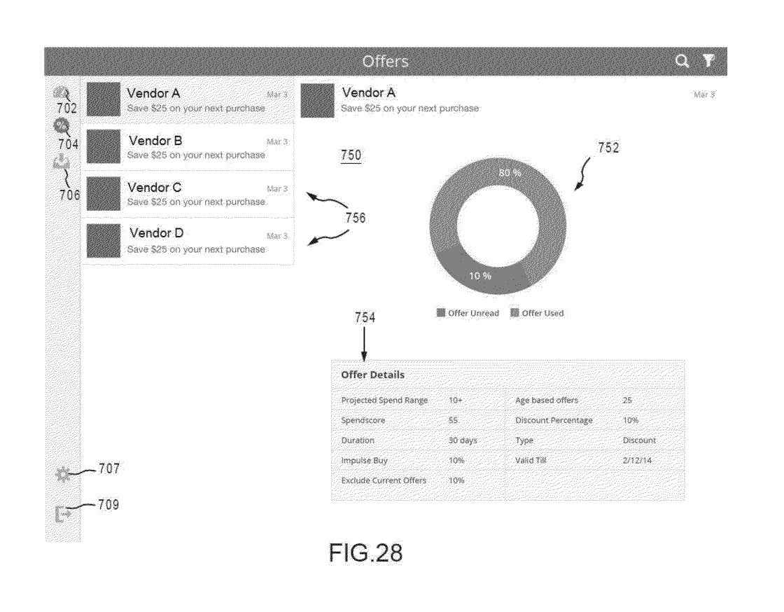

Referring now to FIG. 28, another vendor portal 750 is illustrated that shows the status of offers generated by a vendor. In the example shown, the vendor portal 750 shows a circular graph 752 indicating 80% of the consumers have used the offers from the vendor while 10% of the offers have not been used/read by the consumers. The remaining 10% of the current offers may have no identifiable status at the time, such as consumer transactions taking place that have not yet been recorded by the system or transactions that are pending. Also illustrated below the circular graph is information relating to a specific offer that may be active within the vendor's current catalog of offers, shown as offer details 754. The offer details 754 may include the projected spend range, spend score, duration, and other categories associated with the offer. The vendor portal 750 further illustrates a listing of the offers 756 that may be currently active, or the listing could include a historical listing of all offers that the vendor may have generated. The vendor may select any one of the listed offers 756 in order to show the offer details 754.

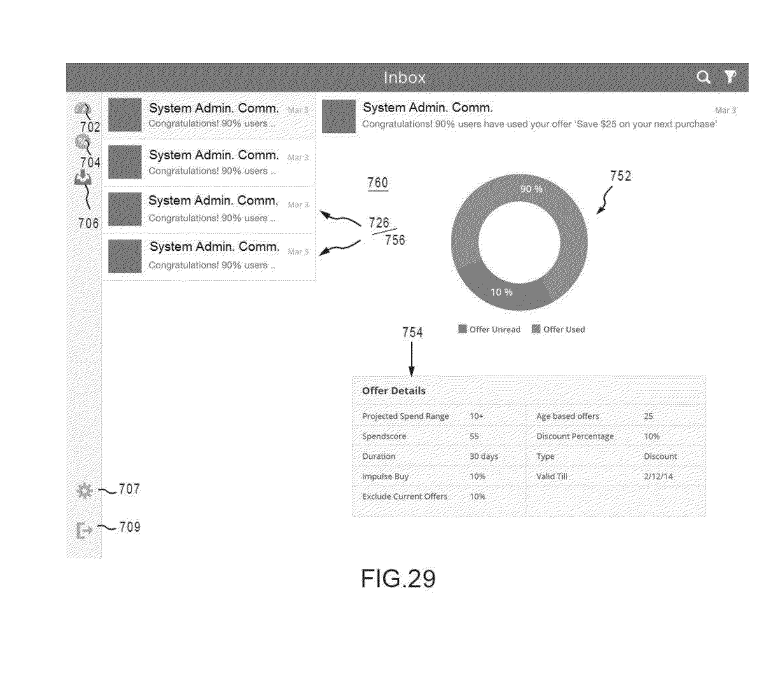

Referring to FIG. 29, another vendor portal 760 is illustrated representing information available for review from the vendor's inbox 706, which can conceptually be viewed as an electronic mail inbox for the vendor to receive various communications from the system administrator regarding status of the vendor's offers, and other administrative information. The particular information shown in FIG. 29 is similar to that illustrated in FIG. 28. Specifically, this inbox shows a circular graph 752 indicating the percentage of users that have used/not used a particular offer, along with offer details 754 that identify specifics of the offer. Also shown is a listing of the offers that the vendor has created over time, and these may be displayed as a complete historical listing of offers 756 and/or the existing/active offers 726. Selecting each provides the status of the offer and offer details 754. The vendor portal 760 of FIG. 29 provides yet another opportunity for the vendor to determine the status of each offer, therefore enabling the vendor to precisely record and track each offer as desired. The inbox 706 can be set up as a distinct user account within the vendor's regular email service so the vendor has convenient email access to the status of the vendor's participation in the system.

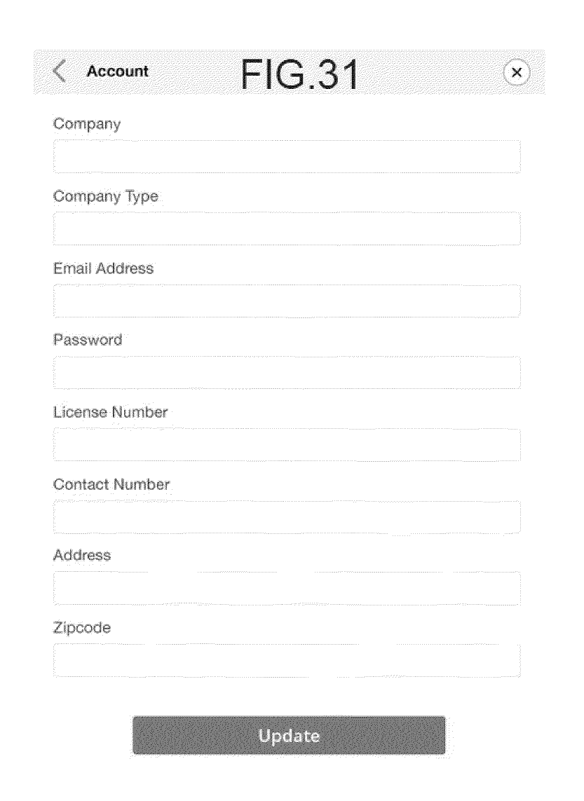

Referring to FIG. 30, a settings function 762 is shown, which can be accessed by selecting/clicking on the settings icon 707 in the lower left corner of the screens of FIGS. 26-29. This settings function represents the ability for the vendor to adjust particular settings within the system in terms of how the vendor wishes to visually present offers to users, as well as to set up and maintain different accounts that the vendor may have established in the system. For example, one vendor may represent a number of different companies cooperating to form a single vendor within the system, and therefore, the vendor may wish to have separate accounts for each company for bookkeeping purposes. There are three functions listed in the user interface of FIG. 30: an accounts function 763, a logo function 765, and a category function 767. These functions are explained below with respect to their separate user interfaces corresponding to the FIGS. 31-33, respectively.

Referring to FIG. 31, an account screen is shown which enables the vendor to establish an account within the system with required identifying information. This information may require a license number if the vendor is dealing in sales of goods or services which require license or other types of professional credentials. Alternately, the license number could indicate an internal control feature within the system in which established vendors may obtain a license number in order to speed validation of the vendors approval for offering goods/services within the system.

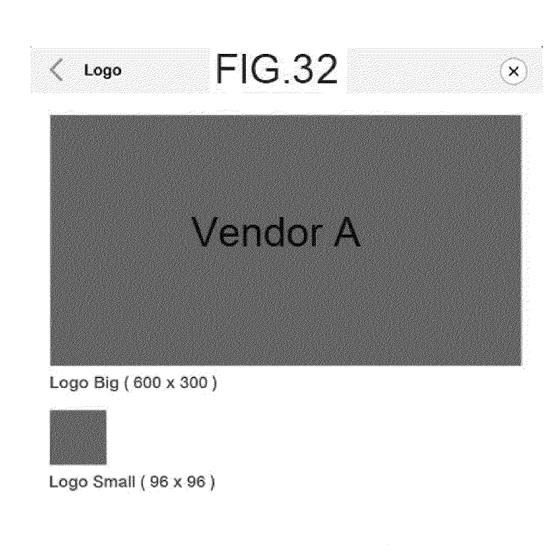

The logo option within the settings interface is shown in FIG. 32. This logo option enables the vendor to set the type of visual presentation for the offer, to include use of the vendor's desired logos, trademarks, and other brand identifying features.

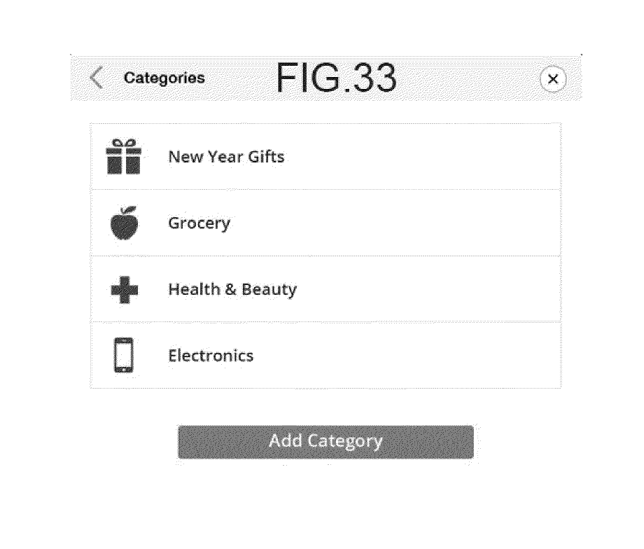

The category option within the settings screen is shown in FIG. 33. This option enables the vendor to establish the specific categories for which each offers to be associated. These categories are previously determined by the system, and each vendor is required to categorize their goods/services with an one of the predefined categories. In the example of FIG. 33, there are four current categories in which the vendor has made offers. If the vendor wishes to add an additional category of goods/services, then the vendor may select the “add category” button to add additional goods/services for new offers within the system. Therefore, it should be understood that this settings function provides a vendor with a wide range of options in terms of specifically tailoring not only the types of goods and services offered, but also the manner in which they are presented to consumers within the electronic setting of the system.

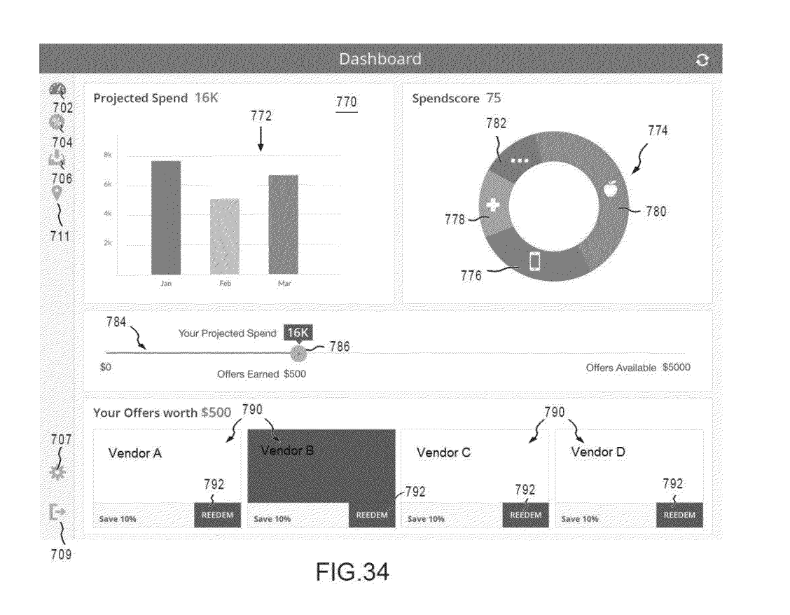

Referring to FIG. 34, another user interface is shown, namely, a first consumer portal or user interface 770. This user interface can be considered the general status or “home” screen that provides general information as to the consumer's projected spend for a designated time period, and the consumers current spend score. In the example of FIG. 34, a bar graph 772 provides information on the consumer for a three month period in which the projected spend for that period is shown as $16,000. The bar graph more specifically shows a projected spend for each month within the three-month period. This bar graph represents a visual display for the consumer to quickly obtain an understanding of the projected spend as calculated for the three-month period. Referring to the circular graph 774, this provides an indication of the categorized goods/services for which the consumer has made purchases within the designated three month time period and the corresponding spend score shown as 75. In the example of this circular graph, the consumer purchased goods in categories identified as electronics 776, health and beauty 778, groceries 780, and purchases in a group of other miscellaneous categories 782.

FIG. 34 also illustrates a sliding indicator 784 for the consumer that provides a quick reference as to the potential amount of savings that the consumer can earn based upon how much the consumer spends. The leftmost position on the slider represents zero dollars in purchases, while the rightmost position is the projected spend for the designated time, which in this example is the $16,000 amount. The consumer simply moves the slider between these positions to determine the amount of savings that the consumer may realize within the range from $0-$16,000. This amount of savings earned may be a linear relationship across the length of the slider indicator, or depending upon the offers provided to the consumer, the sliding indicator could be non-linear. For example, if there were a greater number of discounted offers to the consumer if the consumer spends closer to the $16,000 projected spend, then the amount of savings would increase as the consumer spends closer towards the $16,000 upper range representing the projected spend. In terms of the categories of goods/services in which the consumer may realize the savings, the consumer could view the list of current offers provided to the consumer to more specifically determine which offers provided the greatest savings within the particular categories of goods/services offered by the vendors. The sliding indicator of FIG. 34 also shows a point on the scale where actual savings earned is $500, indicating that the consumer has purchased goods/services at that level. As the consumer slides the dot indicator 786 to the right towards the projected spend and beyond the current amount of money spent, the display would indicate “potential” savings as opposed to actual discounts earned.

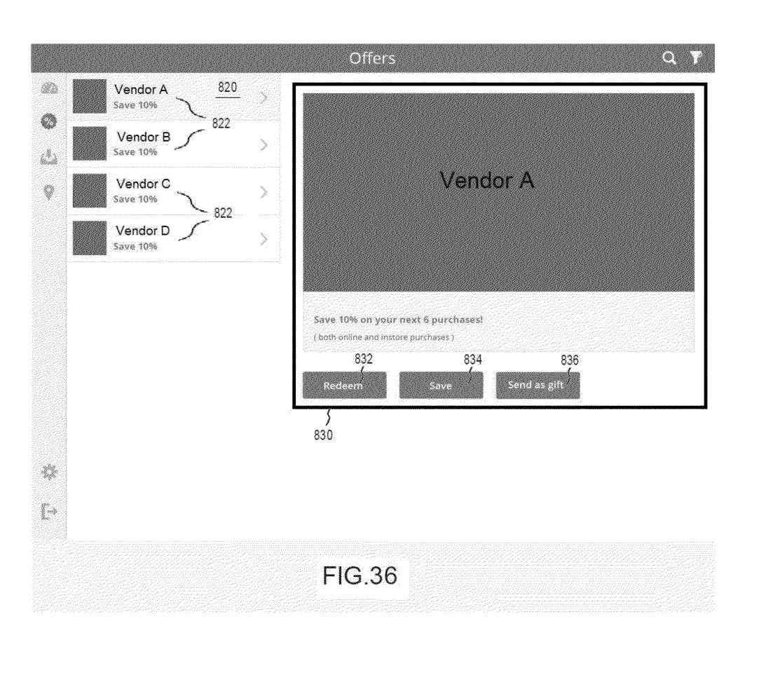

In connection with the consumer determining discounted offers/savings, FIG. 34 also illustrates a group of offers 790 each valued at $500. For each offer, the particular vendor is identified, as well as the offer discount. If the consumer wished to take advantage of the offer, the consumer would simply select the corresponding redeem button 792, which generates another user interface for conducting the purchase, as explained below with respect to FIG. 36. The offers valued at $500 are simply examples of the types of offers available to the consumer, and it is likely a consumer would have offers valued at many different amounts. It should be appreciated that this user interface provides a broad yet comprehensive status for the consumer regarding how the consumer is classified in terms of the projected spend, the spend score, the amount of savings realized or earned, the amount of savings currently available within the projected spend, as well as specific offers that are available to the consumer.

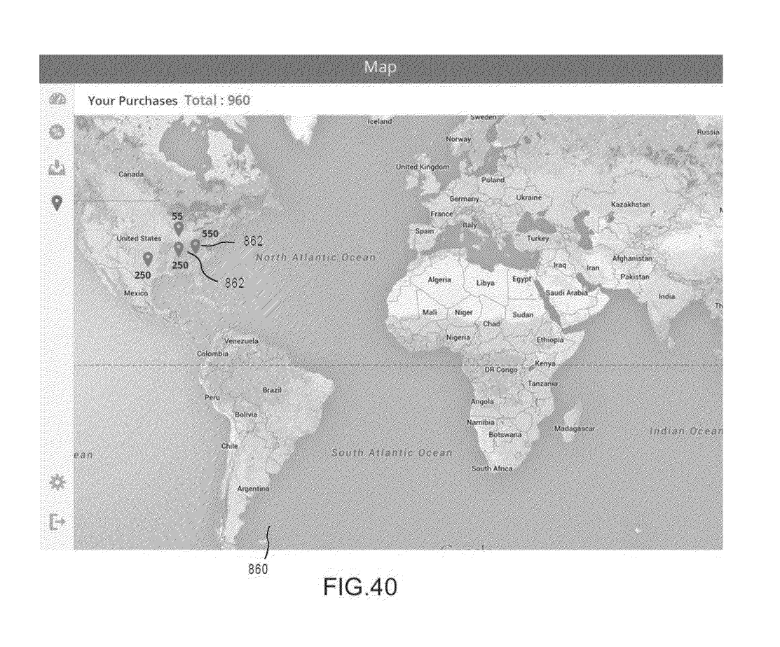

FIG. 34 also provides the consumer with basic navigation capability, similar to the navigation icons within the vendor user interfaces but corresponding to the consumer's account on the system. More specifically, each of the consumer screens/interfaces may include an icon indicating a dashboard or control function 702, an icon indicating a percentage status function 704 in terms of offers purchased by the consumer from the vendors, and an icon indicating an inbox 706 for receiving electronic communications from the system administrator. An additional icon 711 is shown, which corresponds to a link for viewing a map indicating locations where the vendor has made purchases within the system, as discussed further below in FIG. 40.

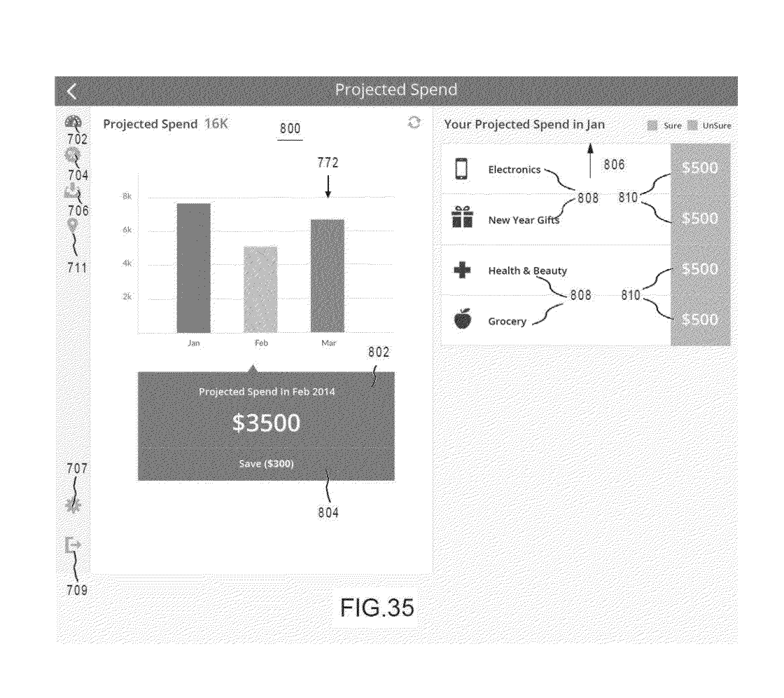

Referring to FIG. 35, another user interface 800 is provided that details additional information on the consumer's projected spend. This interface more specifically shows the bar graph 772 of FIG. 34 along with an indication of the projected spend within each month of the three-month period. As shown, the consumer selects the month of February for additional information, and the projected spend in the month of February 2014 is $3500 as indicated in the display box 802. The display box 802 also indicates the discounts or savings available for the month of February, shown as $300. The user may select the save $300 button 804, which in turn provides the consumer with the listing of offers available to the consumer for the month of February, as also described below with respect to FIG. 36. The consumer may move the pointer 804 to each month in which the consumer wishes to obtain additional information for display in the box 802. The use interface 800 of FIG. 35 also shows a projected spend predictor 806 for a selected month, shown in this example as the projected spend predictor 806 for the month of January. The predictor 806 lists the particular categories of goods/services for which the consumer qualifies for the discounted offers. This listing may comprise only the major categories in which the consumer will execute most purchases, or may be a more exhaustive listing of each category of goods/services in which the consumer is projected to execute a purchase transaction within the system. Adjacent the category 808 of goods/services, a further indication is provided in this predictor function regarding the certainty or prediction in which purchases will be made within that selected month. As shown, this certainty is generally communicated as “sure” or “unsure” within a prediction box 810 that also displays the projected spend in the category for that month. The designation of “sure” or “unsure” can be established by numerous factors, some of which may be set or determined by the consumer's calculated projected spend and spend score. For example, within the category of health and beauty, the consumer's spend score is determined from the consumer's spend profile, and the profile may strongly indicate that the consumer routinely executes purchase transactions in that category for $500 every month in which there is data available regarding the consumer's spend history. Similarly, in the category of New Year's gifts, a designation or prediction of “unsure” may be presented because the consumer's spend profile does not support a high likelihood of the purchase(s) being made, or some other factor recorded by the system concerning the likelihood that the consumer will actually execute purchase(s) within that month for that category of goods. In any event, this visual indication provided to the user as to the likelihood of one or more purchase transactions provides the consumer with additional information as to how a consumer may wish to spend funds for the month in order to potentially maximize discount offers from vendors. It should also be understood that the $500 values shown for each category are simply exemplary values, and it can be expected that different values will appear for different classifications of goods and services.

Referring to FIG. 36, this user interface 820 represents offers that can be viewed by the consumer for each offer within a particular category of goods/services, a particular time, or offers that are sorted according to some other criteria. This list of offers can be provided in numerous consumer user interfaces, such as the electronic inbox of the consumer, a separate offers interface, and others. As shown in the example of FIG. 36, the list of offers 822 are provided in a vertical stack, and each listing is summarized to include the identity of the vendor and the amount of discount/savings available. The consumer may select an offer to view specific details regarding the offer, an example of which is shown in the display box 830. The display box 830 represents such detailed information, such as the vendor, vendor location, amount of discount/savings, limitations on the offer, the particular goods/services covered in the offer, etc. Here, the vendor can tailor the presentation of the offer with the desired images providing an aesthetically pleasing visual. The user has additional options when viewing the display box 830 including a redeem button 832, a save button 834, and a “Send as gift” button 836. The consumer may select the redeem button 832 which results in another user interface for the consumer to execute a purchase transaction. The redeem user interface would include the particular information on the good/service to be purchased, along with a barcode/redemption code if the user wished to use a mobile electronic device to make the purchase in order to identify the particular good/service being purchased. The save button 834 may allow the consumer to the particular offer at a desired location within the consumer's account, or to save the offer to another computing device. Selecting the “Send as gift” button 836 results in another user interface enabling the consumer to purchase the goods/services, and then send the purchased item as a gift. The gift could include a monetized gift card, or could include sending of the actual gift, such as through a courier service to the intended recipient.

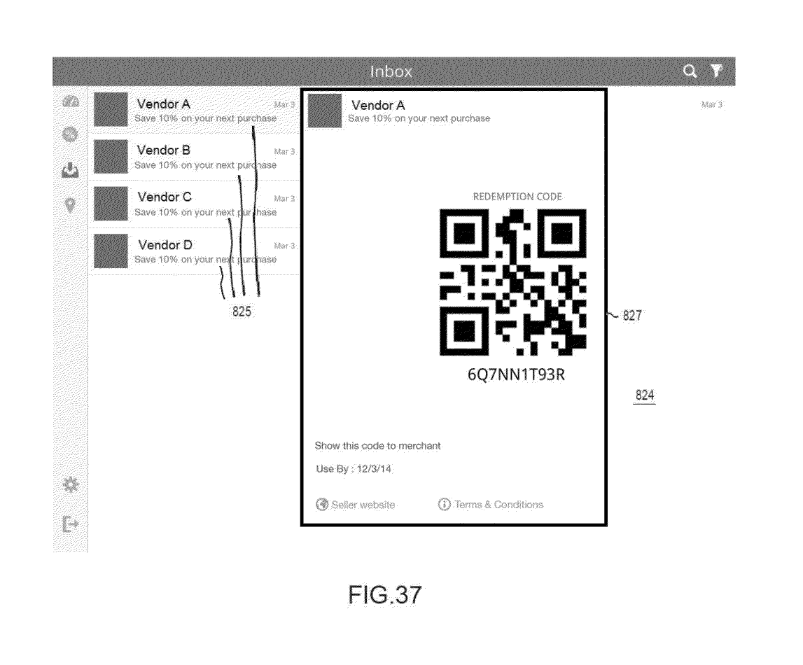

Referring to FIG. 37, another user interface 824 is shown, which is an example inbox for a consumer that lists offers 825 sent to the consumer via the electronic mail/e-mail function of the system. The offers are identified from each vendor including identification of the vendor, the percent discount, and the date on which the offer was made. The vendor may then open each of the offers to determine specifics for the offer, shown within the display box 827. Information provided in the display box 827 includes a link to the vendor/seller website, terms and conditions of the offer, and a redemption/UPC code that can be presented to the merchant when the consumer wishes to execute the purchase transaction. Additional information may be provided within the display box 827 as determined by the seller in order to convey the adequate amount of information for the consumer to make a decision whether the offer should be used.

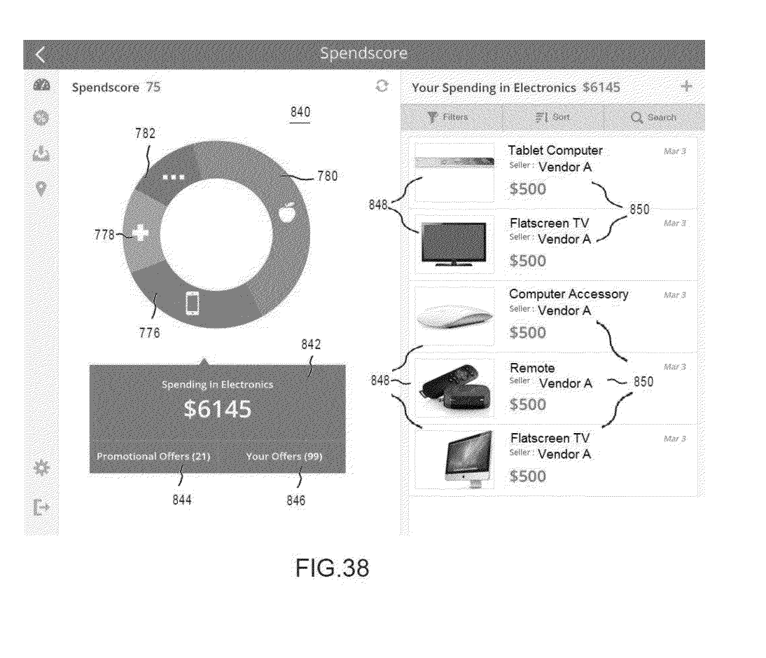

Referring to FIG. 38, another user interface 840 is shown for a consumer, which details additional information concerning the consumer's spend score and the categories of goods/services in which the consumer has executed purchases within the evaluated time period. In the example of FIG. 38, the user selected the electronics category 776, and a display box 842 provides the amount of funds spent in that category, shown as $6145. Below the display box 842, two buttons are provided for the consumer to view further information regarding the electronics category 776. The first button is a “Promotional Offers” button 844, which indicates to the consumer the number of new, promotional offers available to the consumer based upon the consumer's current spending record in that category. More specifically, this Promotional Offers button can illustrate yet additional offers available to the consumer because the consumer has perhaps performed well within the spending category, and vendors wish to reward this spending behavior with additional offers to the consumer. Therefore, in this regard, promotional offers listed here could be differentiated from the existing offers that consumer has received, such as listed in the consumer's electronic inbox. The other button, namely the “Your offers” button 846, is simply another link for the consumer to view the offers available within the electronics category 776. It is therefore apparent that this additional displayed information in FIG. 38 allows a consumer easy access to amounts spent, existing offers, and new promotional offers associated with the selected category. FIG. 38 also illustrates a specific listing of the goods/services purchased within the category according to the amount spent as displayed in the display box 842. This listing is represented in the display 848, and includes an identification of each of the goods/services purchased, with detailed information on each purchase, as reflected in each of the display boxes 850. This further information provided to the consumer on a single screen enables the consumer to quickly gain an overall understanding of purchases, types of goods/services purchased, and how these purchases relate to the consumer's projected spend for the period. Referring also to FIG. 38, functions are also provided to the consumer in order to sort the listed goods/services, to search the purchased goods/services, and to apply predetermined filters. The predetermined filters could include, for example, a designated purchase price ranges, manufacturers, or other limitations in order to filter the display 848.

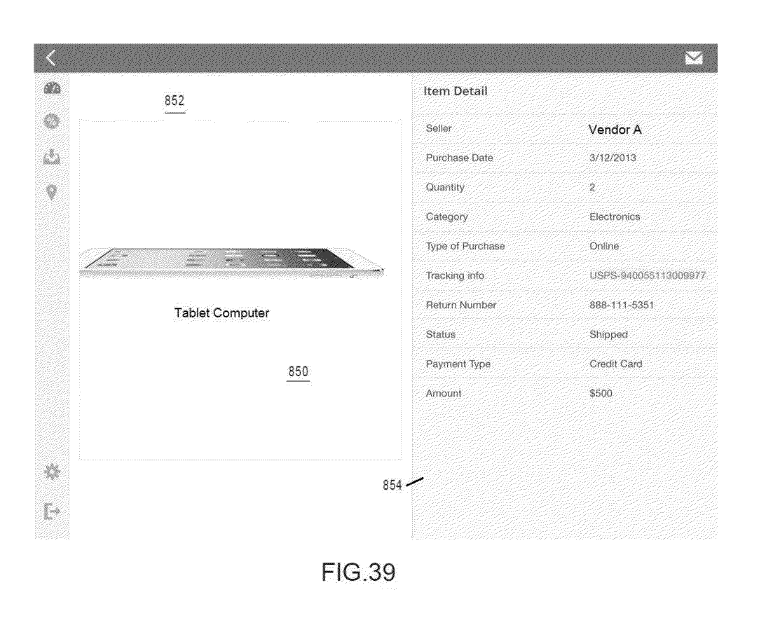

Referring to FIG. 39, this user interface 852 provides a more detailed explanation of the purchase made by the consumer as reflected in the purchased items and display boxes 850. More specifically, shown in this user interface 852, a particular product as selected from one of the display boxes 850 further includes detailed product/service information as listed within the display box 854. As shown, this display box 854 provides information such as the identity of the seller, the purchase date, the quantity, the category of goods/services, the type of purchase, the courier tracking information, the telephone number for making a return, the status of the shipment, the payment type, and the amount of the purchase. As one can appreciate, is further detailed information provided to the consumer through a series of simple window presentations is highly functional, yet efficient for use.

Referring to FIG. 40, this user interface 860 provides a simplified map view for the consumer detailing locations where purchases were made. This map view may be helpful to a consumer in order for the consumer to better understand how and when purchases are made. For example, for consumers who may travel frequently, the consumer may wish to understand when and where purchases are made, which can be facilitated by this map view. As more specifically illustrated in this user interface 860, the pinpointed locations 862 indicate the specific locations where purchases were made, along with the corresponding values of purchases made at those locations. Additional information could be generated for the consumer by the consumer selecting any one of the pinpointed locations which could act as links to other user interfaces within the system, such as the user interface of FIG. 39 detailing information on each product/service purchased. In connection with this map view of FIG. 40, it is also contemplated that a similar map view could be provided for a vendor, in which the vendor could be provided a visual summary of the geographic locations where consumers make purchases. This information could be used to better target consumers at a specific location for selected goods/services, and can also be used to modify the elements associated with determining the spend profiles of consumers within a particular geographic area.

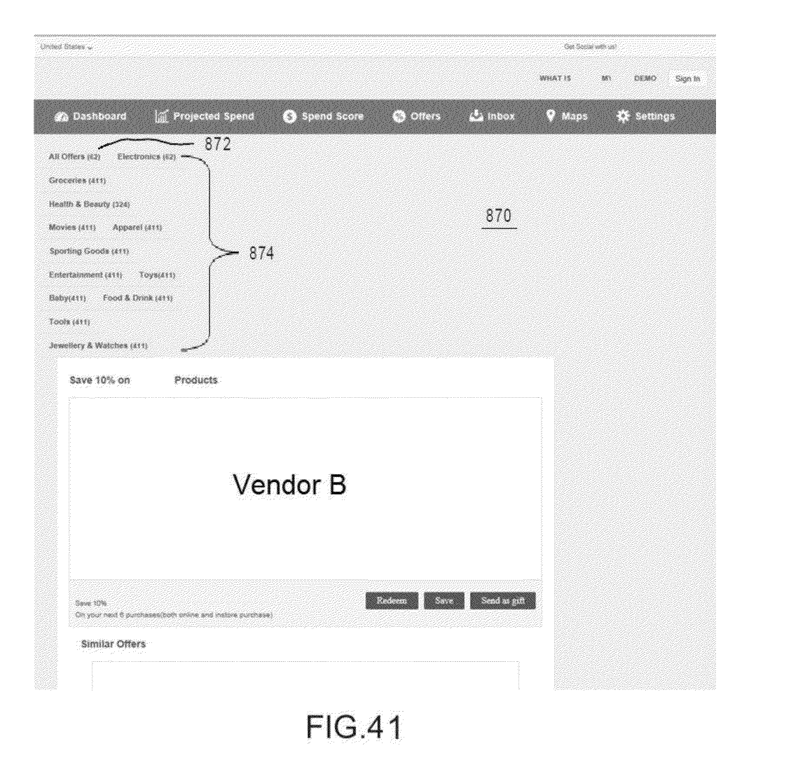

Referring to FIG. 41, another user interface 870 is shown for a consumer that represents an overview of offers made available to the consumer. This user interface 870 includes a listing of the categories of offers available, along with the number of goods/services available in each category. For example, the “all offers” link 872 indicates that there are presently a total of 82 offers available to the consumer. The specific categorized listing of goods/services 874 indicate the number of products available in each of the listed categories. For example, within the “sporting goods” category, there are 411 different types of goods that the consumer could choose from. The user could select on any one of the links associated with the specific goods/services in order to then view a full listing of the particular products/services available within that category.

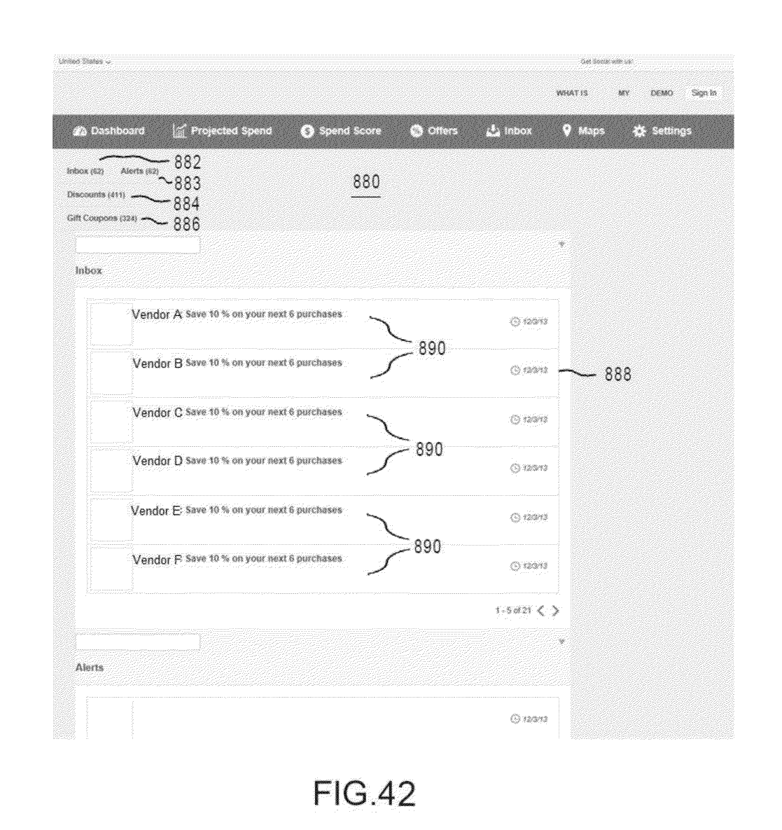

Referring to FIG. 42, yet another user interface 880 is shown for consumer that represents an overview for the consumer for information within the electronic inbox and others. Within this user interface 880, a link 882 is provided for the consumer to go to the consumer's inbox, another link 883 directs the consumer to any alerts, and a further link 884 is provided for the consumer to view all of the current discounts made available to the consumer, and a gift coupons link 886 that represents the number of offers available to the consumer in terms of gift coupons. A portion of the consumer's inbox is shown in field 888, and this field lists each specific offer/discount 890 currently available to the consumer. This listing of offers may be presented in a similar fashion as the list of offers 822 as depicted in FIG. 36.

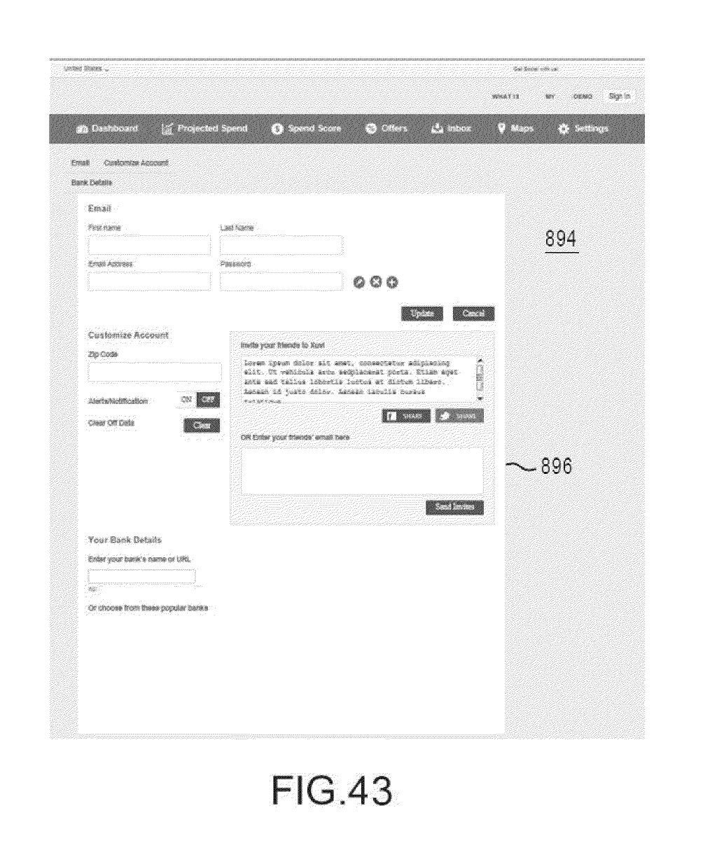

Referring to FIG. 43, yet another consumer user interface 894 is illustrated, namely, a consumer sign-up screen enabling the user to register as a consumer within the system. As shown, basic information is provided by the consumer to include name, address, bank details, etc. Also shown within the sign-up screen is a display box 896 that enables the consumer to invite friends/acquaintances to also sign up through a social networking invitation.

There are number of advantages to the present invention. With respect to electronic commerce, the detailed analysis of a consumer's spending habits results in a very predictable way in which to make goods and services available to the consumers, which could greatly increase sales for certain vendors. This detailed market analysis of consumer spending habits also can make e-commerce much more convenient in that consumers are given discrete and separated options for purchasing different goods and services, with the assurance that the vendors with whom they are dealing with can provide the exact types of goods and services desired, along with the best prices and quality. Therefore, as opposed to traditional e-commerce shopping, the consumer is provided direct matches for goods and services desired to be purchased, and the vendors are made available to the consumers in a convenient manner to facilitate exact needs of the consumers. For the vendors, the system and method of the present invention also provides numerous advantages, such as providing increased predictability in the amount of goods and services that may need to be made available to a known group of consumers over a set period of time. Therefore, these predictive sales can greatly assist in inventory control, and to reduce overall expenses associated with offering goods and services for sale. Because the consumers within a virtual community can be considered as highly targeted and logical prospective purchasers, vendors are more likely to want to be involved in the virtual communities since the background research done on participating consumers greatly exceeds traditional marketing studies. In short, once a virtual community is formed, it is highly unlikely that there would be a low level of sales within the community. Rather, there is a much higher likelihood that predictable and continuous sales would occur over known periods of time.

Consumers within a virtual marketplace community can be further subdivided or grouped into cohorts that have members with specifically defined parameters resulting in a relatively higher likelihood that the group of consumers within a cohort will be able to successfully execute a spending mission. Vendors may therefore be further encouraged to provide even greater discounts to cohort members considering the circumstances in which the cohorts are not just a haphazard collection of consumers who may make purchases at sometime in the future, but rather, a well-defined group of consumers with a high likelihood that the consumers will purchase an amount of goods within a prescribed time period, and will thus successfully execute a spending mission of high value to vendors participating in the virtual marketplace community.

The system and method of the invention can be further described with respect to user interface portals that enable vendors and consumers to electronically execute the desired transactions. The user interface portals are accessible by computing devices that may include personal computers, personal digital assistants, cellular phones, and other known computing devices. The user interface portals may be conceptually divided into consumer portals and vendor portals.

By a review of the foregoing description, the invention can be considered an overall automated system for sales of goods and services within a computer implemented environment. In another aspect, it can be considered a method for sale of goods and services within a computer implemented environment. In another aspect of the invention, it may be considered a subsystem and method for evaluating economic metadata to be used within establishing spend categories. In yet another aspect of the invention, it may be considered a method of determining consumer spend profiles, which could be used for direct sales of products and services, but also within other contexts, such as the likelihood that such consumers may transition into other markets for purchase of similar goods and services. In yet another aspect of the invention, it can be considered a method of creating virtual marketplace communities comprising information obtained from both consumers and vendors with a common goal to purchase and sell distinct groups of goods and services, thereby facilitating discounts for the consumer, and assured sales for the vendors. In yet another aspect of the invention, it could be considered a method of analyzing actual purchases made through an e-commerce environment for related consumers and vendors.

Although the invention has been described with respect to one or more preferred embodiments, it should be understood that various other changes and modifications to the invention can be made, commensurate with the scope of the claims appended hereto.

What is claimed is:

1. A method to profile consumer spend or home economics activity to form a virtual marketplace community for purposes of conducting electronic commerce, said method comprising:
gathering spending data from at least two consumers and storing the data on a first computer;
determining spend categories for purchases made by the consumers;
calculating a spend score for each consumer and storing the calculated spend scores on the first computer;
determining a spend profile for each consumer and storing the spend profiles on the first computer;
connecting at least one vendor with the consumers, wherein the vendor and consumers are matched to one another based upon consideration of the consumers spend profiles, and the vendor offers goods or services to the consumers, said connection being made over a communications network, wherein the at least one vendor and the at least one consumer have their own respective second computers connected to one another over the communications network; and
conducting electronic commerce between the consumers and vendor wherein a plurality of user displays are provided to the vendor and consumers for display of goods and/or services offered to the consumers from the vendor, and wherein said conducting step includes at least one purchase transaction in which a purchase is made by one of the consumers.

2. A method, as claimed in claim 1, wherein:
said spending data includes metadata electronically retrieved from the consumer.

3. A method, as claimed in claim 1, wherein:
said consumers are grouped for similarities in spend profiles for creating the community.

4. A method, as claimed in claim 1, wherein:
said consumers are grouped for similarities in spend scores for creating the community.

5. A method, as claimed in claim 2, wherein:
said metadata includes at least one of financial transactions, commercial transactions, cash, cash equivalents, and non-commercial transactions.

6. A method, as claimed in claim 2, wherein:
said metadata is transferred electronically from a computer of said consumer to a processing computer.

7. A method, as claimed in claim 2, wherein:
a consumer initiates and reports metadata to a processing computer from the consumer's computer.

8. A method, as claimed in claim 2, wherein:
said metadata is validated, formatted, analyze, classified, and categorized to create the spend score of the consumer.

9. A method, as claimed in claim 8, wherein:
the spend score is analyzed to generate the spend profile.

10. A method, as claimed in claim 1, wherein:
conducting electronic commerce is facilitated by programming instructions associated with a plurality of software implementations residing with said first and second computers, and wherein said user displays are provided as a function from said programming instructions.

11. A system to profile consumer activity to form a virtual marketplace community, said system comprising:
a first consumer computer including a corresponding processor, data storage, and a software implementation for achieving functionality associated with the system according to consumer functions;
a second vendor computer including a corresponding processor, data storage, and a software implementation for achieving functionality associated with the system according to vendor functions;
an administrator computer server including a corresponding processor, data storage, and a software implementation for achieving functionality associated with the system according to administrator functions;
a database including (i) spending data from at least two consumers and storing the data on the database, (ii) spend category data corresponding to purchases made by the consumers; (iii) calculated spend score data for each consumer; (iv) spend profile data for each consumer; and
wherein access is provided to a communications network for electronically connecting at least one vendor with the consumers, wherein the vendor and consumers are matched to one another based upon consideration of the consumers spend profiles, and the vendor offers goods or services to the consumers, and wherein electronic commerce is conducted between the consumers and vendor; and
a plurality of user displays to the vendor and consumers for display of goods and/or services offered to the consumers from the vendor.

12. A system, as claimed in claim 11, wherein:
said spending data includes metadata electronically retrieved from the consumer.

13. A system, as claimed in claim 11, wherein:
said consumers are grouped for similarities in spend profiles for creating the community.

14. A system, as claimed in claim 11, wherein:
said consumers are grouped for similarities in spend scores for creating the community.

15. A system, as claimed in claim 12, wherein:
said spending metadata includes at least one of financial transactions, commercial transactions, cash, cash equivalents, and non-commercial transactions.

16. A system, as claimed in claim 12, wherein:
said spending metadata is transferred electronically from a computer of said consumer to a processing computer.

17. A system, as claimed in claim 12, wherein:
a consumer initiates and reports spending metadata to a processing computer from the consumer's computer.

18. A system, as claimed in claim 12, wherein:
said spending metadata is validated, formatted, analyze, classified, and categorized to create the spend score of the consumer.

19. A system, as claimed in claim 12, wherein:
the spend score is analyzed to generate the spend profile.

20. A system, as claimed in claim 12, wherein:
conducting electronic commerce is facilitated by programming instructions associated with a plurality of software implementations residing with said first and second computers, and wherein said plurality of user displays are provided as a function from said programming instructions.

21. A computer readable medium having stored thereon computer executable instructions, the computer executable instructions causing a processor to execute a method for profiling consumer activity to form a virtual marketplace community, the computer executable instructions comprising:
instructions to display data gathered from at least two consumers corresponding to data for purchases of goods or services;
instructions to display spend categories determined from the data;
instructions to calculate a spend score for each consumer and displaying the spend scores;
instructions to display a spend profile for each consumer based upon selected spend scores;
instructions to display a connection between at least one vendor, and the two consumers, the connection being made over a communications network, wherein the vendor and consumers are matched to one another based upon consideration of the consumer spend profiles;
instructions to display at least one user interface showing offers for goods or services to the consumers from the vendor; and
wherein in response to the instructions to display the at least one user interface, conducting electronic commerce, wherein at least one consumer purchases a good or service from the vendor.

22. A method to profile consumer spend or home economics activity to form a virtual marketplace community for purposes of conducting electronic commerce, said method comprising:
determining a spend profile for at least two consumers by (i) gathering spending data from at least two consumers and storing the data on a first computer; (ii) determining spend categories for purchases made by the consumers; (iii) calculating a spend score for each consumer and storing the calculated spend scores on the first computer; (iv) determining a spend profile for each consumer and storing the spend profiles on the first computer;
determining a vendor profile for at least one vendor to provide goods or services to the two consumers by (i) gathering vendor data from the at least one vendor and storing the data on a second computer; (ii) determining vendor categories for sales to be made by the at least one vendor corresponding to purchases to be made by the consumers; (iii) calculating a vendor score for the at least one vendor and storing the calculated vendor score on the second computer; and (iv) determining a vendor profile for the at least one vendor and storing the vendor profile on the second computer;
connecting the at least one vendor with the at least two consumers, wherein the vendor and consumers are matched to one another based upon consideration of the consumers' spend profiles and the vendor's profile, and the vendor offering goods or services to the consumers, said connection being made over a communications network, wherein the at least one vendor and the consumers have their respective computers connected to one another over the communications network; and
conducting electronic commerce between the consumers and the at least one vendor wherein a plurality of user displays are provided to the at least one vendor and consumers for display of goods and/or services offered to the consumers from the at least one vendor, and wherein said conducting step includes at least one purchase transaction in which a purchase is made by one of the consumers.

23. A method, as claimed in claim 22, wherein:
said spending data includes metadata electronically retrieved from the consumer.

24. A method, as claimed in claim 22, wherein:
said consumers are grouped for similarities in spend profiles for creating the community.

25. A method, as claimed in claim 22, wherein:
said consumers are grouped for similarities in spend scores for creating the community.

26. A method, as claimed in claim 22, wherein:
said metadata includes at least one of financial transactions, commercial transactions, cash, cash equivalents, and non-commercial transactions.

27. A method, as claimed in claim 22, wherein:
said metadata is transferred electronically from a computer of said consumer to a processing computer.

28. A method, as claimed in claim 23, wherein:
a consumer initiates and reports metadata to a processing computer from the consumer's computer.

29. A method, as claimed in claim 23, wherein:
said metadata is validated, formatted, analyze, classified, and categorized to create the spend score of the consumer.

30. A method, as claimed in claim 29, wherein:
the spend score is analyzed to generate the spend profile.

31. A method, as claimed in claim 22, wherein:
conducting electronic commerce is facilitated by programming instructions associated with a plurality of software implementations residing with said first and second computers, and wherein said user displays are provided as a function from said programming instructions.

32. A system to profile consumer activity to form a virtual marketplace community, said system comprising:
a first consumer computer including a corresponding processor, data storage, and a software implementation for achieving functionality associated with the system according to consumer functions;
a second vendor computer including a corresponding processor, data storage, and a software implementation for achieving functionality associated with the system according to vendor functions;
an administrator computer server including a corresponding processor, data storage, and a software implementation for achieving functionality associated with the system according to administrator functions;
a database including (a) spend related data comprising (i) spending data from at least two consumers and storing the data on the database, (ii) spend category data corresponding to purchases made by the consumers; (iii) calculated spend score data for each consumer; and (iv) spend profile data for each consumer; and (b) vendor related data comprising (i) vending data from the vendor and storing the data on the database, (ii) vendor category data corresponding to sales made by the vendor within selected spend categories; (iii) a calculated vendor score data for the vendor; and (iv) vendor profile data for the vendor;
wherein access is provided to a communications network for electronically connecting at least one vendor with the consumers, wherein the vendor and consumers are matched to one another based upon consideration of the consumers spend profiles and the vendor profile, and the vendor offers goods or services to the consumers, and wherein electronic commerce is conducted between the consumers and vendor; and
a plurality of user displays to the vendor and consumers for display of goods and/or services offered to the consumers from the vendor.

33. A system, as claimed in claim 32, wherein:
said spending data includes metadata electronically retrieved from the consumer.

34. A system, as claimed in claim 32, wherein:
said consumers are grouped for similarities in spend profiles for creating the community.

35. A system, as claimed in claim 32, wherein:
said consumers are grouped for similarities in spend scores for creating the community.

36. A system, as claimed in claim 33, wherein:
said spending metadata includes at least one of financial transactions, commercial transactions, cash, cash equivalents, and non-commercial transactions.

37. A system, as claimed in claim 33, wherein:
said spending metadata is transferred electronically from a computer of said consumer to a processing computer.

38. A system, as claimed in claim 33, wherein:
a consumer initiates and reports spending metadata to a processing computer from the consumer's computer.

39. A system, as claimed in claim 33, wherein:
said spending metadata is validated, formatted, analyze, classified, and categorized to create the spend score of the consumer.

40. A system, as claimed in claim 33, wherein:
the spend score is analyzed to generate the spend profile.

41. A system, as claimed in claim 33, wherein:
conducting electronic commerce is facilitated by programming instructions associated with a plurality of software implementations residing with said first and second computers, and wherein said plurality of user displays are provided as a function from said programming instructions.

42. A computer readable medium having stored thereon computer executable instructions, the computer executable instructions causing a processor to execute a method for profiling consumer activity to form a virtual marketplace community, the computer executable instructions comprising:
instructions to display data gathered from at least two consumers corresponding to data for purchases of goods or services;
instructions to display data gathered from at least one vendor corresponding to data for sale of goods or services;
instructions to display spend categories determined from the data;
instructions to calculate a spend score for each consumer and displaying the spend scores;
instructions to display a spend profile for each consumer based upon selected spend scores;
instructions to display vendor goods or services corresponding to said spend categories determined from the data;
instructions to calculate a vendor score for each vendor and displaying the vendor scores;
instructions to display a vendor profile for each vendor based upon selected spend scores;
instructions to display a connection between at least one vendor, and the two consumers, the connection being made over a communications network, wherein the vendor and consumers are matched to one another based upon consideration of the consumer spend profiles and the vendor profile;
instructions to display at least one user interface showing offers for goods or services to the consumers from the vendor; and
wherein in response to the instructions to display the at least one user interface, conducting electronic commerce, wherein at least one consumer purchases a good or service from the vendor.

43. A method to profile consumer spend or home economics activity to form a virtual marketplace community for purposes of conducting electronic commerce, said method comprising:
gathering spending data from at least two consumers and storing the data on a first computer;
determining spend categories for purchases made by the consumers;
calculating a spend score for each consumer and storing the calculated spend scores on the first computer;
determining a spend profile for each consumer and storing the spend profiles on the first computer;
connecting at least one vendor with the consumers, wherein the vendor and consumers are matched to one another based upon consideration of the consumers spend profiles, and the vendor offers goods or services to the consumers, said connection being made over a communications network, wherein the at least one vendor and the at least one consumer have their own respective second computers connected to one another over the communications network; and
conducting electronic commerce between the consumers and vendor wherein a plurality of user displays are provided to the vendor and consumers for display of goods and/or services offered to the consumers from the vendor, and wherein said conducting step includes at least one purchase transaction in which a purchase is made by one of the consumers;
said conducting step further includes a spend score that is calculated for each consumer including: (i) a sum of a total amount spent within a designated category for at least one categorized item and a projected amount to be spent within a designated time period (ii) a percentage that the designated category comprises as compared to a total amount spent by the consumer in the designated time period (iii) a weighted spend frequency variable corresponding to a number of times the consumer spends funds toward the categorized item and (iv) a numeric life event multiplier.

44. A method to profile consumer spend or home economics activity to form a virtual marketplace community for purposes of conducting electronic commerce, said method comprising:
gathering spending data from at least two consumers and storing the data on a first computer;
determining spend categories for purchases made by the consumers;
calculating a spend score for each consumer and storing the calculated spend scores on the first computer;
determining a spend profile for each consumer and storing the spend profiles on the first computer;
determining a cohort corresponding to a group of consumers, the cohort defining an combined entity to conduct commerce within the virtual marketplace community and representing consumers in the group, the cohort formed by selected consumers with pre-selected traits for commerce in a pre-selected category of goods or services offered in the virtual marketplace
connecting at least one vendor with the cohort, wherein the vendor and cohort are matched to one another based upon consideration of the cohort spend profile, and the vendor offers goods or services to the cohort, said connection being made over a communications network, wherein the at least one vendor and the cohort have their own respective second computers connected to one another over the communications network; and
conducting electronic commerce between the consumers and cohort wherein a plurality of user displays are provided to the vendor and cohort for display of goods and/or services offered to the cohort from the vendor, and wherein said conducting step includes at least one purchase transaction in which a purchase is made by one of the consumers of the cohort.

45. A method, as claimed in claim 44, wherein:
said pre-selected traits include at least one of consumer spend scores and consumer projected spends.

46. A method to profile consumer spend or home economics activity to form a virtual marketplace community for purposes of conducting electronic commerce, said method comprising:
gathering spending data from at least two consumers and storing the data on a first computer;
determining spend categories for purchases made by the consumers;
calculating a spend score for each consumer and storing the calculated spend scores on the first computer;
determining a spend profile for each consumer and storing the spend profiles on the first computer;
electronically connecting at least one vendor with the consumers, wherein the vendor and consumers are matched to one another based upon consideration of the consumers spend profiles, and the vendor offers goods or services to the consumers, said connection being made over a communications network, wherein the at least one vendor and the at least one consumer have their own respective second computers connected to one another over the communications network;
creating an exchange pod owned by a selected consumer in which the exchange pod represents a spend score of the exchange pod owner and a discount associated with the spend score;
generating a bid in the system for a vendor to accept an offer by the exchange pod owner for accepting terms associated with the exchange pod including the discount;
generating an acceptance of the offer in the system signifying a vendor will honor the discount associated with future purchases of goods and/or services within a pre-determined category; and
conducting electronic commerce between the consumers and vendor wherein a plurality of user displays are provided to the vendor and consumers for display of goods and/or services offered to the consumers from the vendor, wherein said conducting step includes at least one purchase transaction in which a purchase is made by at least one of the consumers including the exchange pod owner, and terms of the exchange pod are honored in the form of the discount provided to the exchange pod owner.

47. A method to profile consumer spend or home economics activity to form a virtual marketplace community for purposes of conducting electronic commerce, said method comprising:
gathering spending data from at least two consumers and storing the data on a first computer;
determining spend categories for purchases made by the consumers;
calculating a spend score for each consumer and storing the calculated spend scores on the first computer;
determining a spend profile for each consumer and storing the spend profiles on the first computer;
connecting at least one vendor with the consumers, wherein the vendor and consumers are matched to one another based upon consideration of the consumers spend profiles, and the vendor offers goods or services to the consumers, said connection being made over a communications network, wherein the at least one vendor and the at least one consumer have their own respective second computers connected to one another over the communications network; and
conducting electronic commerce between the consumers and vendor wherein a plurality of user displays are provided to the vendor and consumers for display of goods and/or services offered to the consumers from the vendor, and wherein said conducting step includes at least one purchase transaction in which a purchase is made by one of the consumers;
said conducting step further includes a spend score that is calculated for each consumer including a total projected spend multiplied by the product of a spend frequency weightage and a life factor.

48. A method, as claimed in claim 47, wherein:
said total projected spend includes a consideration of the number of spend instances occurring within an actual frequency of spend instances, and determining a value for the projected spend that indicates the number of spend instances remaining within a time period used to determine actual frequency.

49. A system to profile consumer activity to form a virtual marketplace community, said system comprising:
a first consumer computer including a corresponding processor, data storage, and a software implementation for achieving functionality associated with the system according to consumer functions;
a second vendor computer including a corresponding processor, data storage, and a software implementation for achieving functionality associated with the system according to vendor functions;
an administrator computer server including a corresponding processor, data storage, and a software implementation for achieving functionality associated with the system according to administrator functions;
a database including (i) spending data from at least two consumers and storing the data on the database, (ii) spend category data corresponding to purchases made by the consumers; (iii) calculated spend score data for each consumer; (iv) spend profile data for each consumer; and
wherein access is provided to a communications network for electronically connecting at least one vendor with the consumers to conduct electronic commerce, wherein the vendor and consumers are matched to one another based upon consideration of the consumers' spend profiles, and the vendor offers goods or services to the consumers; and
a plurality of user displays to the vendor and consumers for display of goods and/or services offered to the consumers from the vendor, the user displays including:
(i) a plurality of vendor displays enabling a vendor to generate purchase offers to selected consumers, said plurality of vendor displays including a graphical representation of a user classification based on a projected spend range, and a plurality of selectable filters associated with the graphical representation to filter data corresponding to an attribute of a consumer's spend profile or spend score; and
(ii) a plurality of consumer displays enabling a consumer to evaluate offers from vendors in order to purchase goods or services offered by the vendor, said plurality of consumer displays including a graphical representation of a consumer projected spend and a graphical representation of a consumer spend score.

50. A system, as claimed in claim 49, wherein:
said plurality of vendor displays further include an offer display detailing information regarding each offer generated by the vendor including an indication of a percentage of those consumers who have used an offer from the vendor.

51. A system, as claimed in claim 49, wherein:
said plurality of consumer displays further include a display showing a projected spend within a designated time period, and offers available to the consumer within the time period including discounts associated with the offers.

52. A system, as claimed in claim 49, wherein:
said plurality of consumer displays further include a display showing categories of goods or services associated with the consumer's projected spend, a value of the projected spend within each category, and a likelihood that the consumer will spend funds in each category.

53. A system, as claimed in claim 49, wherein:
said plurality of consumer displays further include an offer display detailing information regarding each offer generated by the vendor to the consumer including a redeem function with an associated redemption code enabling the consumer to execute a purchase transaction with a merchant incorporating a discount associated with the offer from the vendor.

54. A computer readable medium having stored thereon computer executable instructions, the computer executable instructions causing a processor to execute a method for profiling consumer activity to form a virtual marketplace community, the computer executable instructions comprising:
instructions to display data gathered from at least two consumers corresponding to data for purchases of goods or services;
instructions to display spend categories determined from the data;
instructions to calculate a spend score for each consumer and displaying the spend scores;
instructions to display a spend profile for each consumer based upon selected spend scores;
instructions to display a connection between at least one vendor, and the two consumers, the connection being made over a communications network, wherein the vendor and consumers are matched to one another based upon consideration of the consumer spend profiles;
instructions to display a plurality of vendor interfaces showing a vendor offers for goods or services to the consumers from the vendor;
instructions to display a plurality of consumer interfaces showing a consumer those offers for goods or services to the consumers from the vendor; and
wherein in response to the instructions to display the vendor and consumer interfaces, conducting electronic commerce, wherein at least one consumer purchases a good or service from the vendor.

55. A computer readable medium, as claimed in claim 54, wherein:
said plurality of vendor interfaces further include an offer display detailing information regarding each offer generated by the vendor including an indication of a percentage of those consumers who have used an offer from the vendor.

56. A computer readable medium, as claimed in claim 54, wherein:
said plurality of consumer interfaces further include a display showing a projected spend within a designated time period, and offers available to the consumer within the time period including discounts associated with the offers.

57. A computer readable medium, as claimed in claim 54, wherein:
said plurality of consumer interfaces further include a display showing categories of goods or services associated with the consumer's projected spend, a value of the projected spend within each category, and a likelihood that the consumer will spend funds in each category.

58. A computer readable medium, as claimed in claim 54, wherein:
said plurality of consumer interfaces further include an offer display detailing information regarding each offer generated by the vendor to the consumer including a redeem function with an associated redemption code enabling the consumer to execute a purchase transaction with a merchant incorporating a discount associated with the offer from the vendor.
